(19) United States
(12) Patent Application Publication
(10) Pub. No.: US 2015/0302374 A1
(43) Pub. Date: Oct. 22, 2015

(54) System And Method For Performing A Purchase Transaction With A Mobile Electronic Device

(71) Applicant: Andrea Sartor, Montebelluna (IT)

(72) Inventor: Andrea Sartor, Montebelluna (IT)

(21) Appl. No.: 14/418,640

(22) PCT Filed: Aug. 2, 2012
(86) PCT No.: PCT/IT2012/000244

§ 371 Date: Feb. 18, 2015

(51) Int. Cl. G06Q 20/14; G06Q 20/06; G06Q 20/26; G06Q 20/20; G06Q 20/40

(52) U.S. Cl. CPC G06Q 20/14; G06Q 20/20; G06Q 20/40; G06Q 20/26; G06Q 20/065

(57) ABSTRACT

An electronic system (1) is described to perform a purchase transaction of goods or services. The system includes a mobile electronic device (2) configured to receive (t₃) a second message (MSG2) carrying an authorization data field (AUT_D) dicating a valid or invalid authorization to use an electronic money for performing the purchase transaction, configured to store the content of the authorization data field into a non-volatile memory (160) inside the mobile electronic device and configured to transmit (t₅; t₇′) a third message (MSG3; MSG4′) carrying an electronic money identification data field (EM_ID) for indicating data identifying the electronic money used for performing the purchase transaction and carrying the authorization data field (AUT_D; AUT_D′). The system further includes a transaction server (4) configured to transmit (t₂) the second message (MSG2) carrying the authorization data field (AUT_D) and configured to receive (t₁₀) a fifth message (MSG5) carrying the electronic money identification data field (EM_ID) and carrying a bill amount field (BL_AM) indicating a bill amount to be paid for the selected goods or services and transmit (t₁₁) therefrom a sixth message (MSG6) carrying a settlement result field (RES_STL) for indicating if the value of the bill amount has been debited on the electronic money. The system further includes a Point-of-Sale device (6) configured to receive (t₆; t₈′) from the mobile electronic device the third message (MSG3; MSG4′) carrying the electronic money identification data field (EM_ID) and the authorization data field (AUT_D; AUT_D′) and transmit (t₉) therefrom the fifth message (MSG5) carrying the electronic money identification data field and the bill amount field (BL_AM), in case of a valid value of the content of the authorization data field.

### TECHNICAL FIELD OF THE INVENTION

The present invention relates to an electronic system and a method for performing a purchase transaction using a mobile electronic device.

### BACKGROUND OF THE INVENTION

Many purchase transactions of goods or services involve payment using “electronic money”, such as credit cards and debit cards.

A known method for performing a purchase transaction of goods from a store (for example, a supermarket) using a credit or a debit card is the following one. The customer enters the supermarket, picks up the goods from the shelves and puts them in a trolley. Afterwards, the customer reaches a Point-of-Sale (POS) including a counter and a POS terminal and moves the goods on a belt. The cashier scans the goods and the counter generates the bill. If the customer owns both credit cards and debit cards, he selects (for example) a specific debit card, grabs the selected debit card and hands it on to the cashier, who swipes the debit card through the card reader of the POS terminal. The cashier selects “debit card” as chosen payment method, types in the purchase price, hands the keypad of the POS terminal (or the integrated POS terminal) on to the customer, who types in a security code (PIN). The POS terminal transmits, by means of a telecommunications network, an authorization request message to the server of the issuing bank across a transaction network (usually composed of an acquiring bank, a card association and an issuing bank); the POS terminal waits for receiving an acknowledge message from the server of the issuing bank. As soon as the POS terminal receives the acknowledge message, a payment receipt is handed on to the customer, who may pick up the purchased goods and reach the exit of the store.

This known method has the disadvantage that the customer has to wait for quite a long time at the Point-of-Sale before he may leave with the purchased goods; in fact, about 20 seconds are required for completing all the necessary operations, including typing in the purchase price and the security code, sending the authorization request message from the POS terminal to the server of the issuing bank and waiting for receiving back the acknowledge message.

### SUMMARY OF THE INVENTION

The present invention relates to an electronic system to perform a purchase transaction of goods or services using a mobile electronic device as defined in the enclosed claim 1 and its preferred embodiments described in the dependent claims from 2 to 12.

The Applicant has recognized that the electronic system according to the present invention allows to reduce the time that the customer has to wait at the Point-of-Sale before he may leave with the purchased goods; for example, the customer has to wait for only 2-3 seconds.

According to a first aspect, the present invention provides a method for performing a purchase transaction of goods or services using a mobile electronic device as defined in the enclosed claims from 13 to 19.

According to a second aspect, the present invention provides a mobile electronic device to perform a purchase transaction of goods or services as defined in the enclosed claims from 20 to 25.

According to a third aspect, the present invention provides a Point-of-Sale device to perform a purchase transaction of goods or services as defined in the enclosed claim 26.

According to a fourth aspect, the present invention provides a transaction network to perform a purchase transaction of goods or services as defined in the enclosed claims from 27 to 29.

According to a fifth aspect, the present invention provides a computer program for performing at least part of the steps of the method according to the first aspect of the invention, as defined in the enclosed claims 30, 31 and 32.

### BRIEF DESCRIPTION OF THE DRAWINGS

FIGS. 1A, 1B, 1C schematically show an electronic system to perform a purchase transaction according to a first or a second embodiment of the invention.

FIGS. 2A and 2B schematically show a method for performing the purchase transaction according to the first and second embodiments of the invention respectively.

FIG. 2C schematically show a method for performing a purchase transaction according to a variant of the first or second embodiment of the invention.

FIG. 3 schematically shows a Point-of-Sale device included in the electronic system according to the first or second embodiment of the invention.

FIG. 4 schematically shows a mobile electronic device included in the electronic system according to the first or second embodiment of the invention.

FIG. 5A-5M schematically show the screens generated on the display of the mobile electronic device by a purchase transaction application according to the invention using a debit card with a limited spending ceiling as electronic money.

FIGS. 6A-6L schematically show the screens generated on the display of the mobile electronic device by a purchase transaction application according to the invention using a credit card with a limited spending ceiling as electronic money.

FIGS. 7A-7L schematically show the screens generated on the display of the mobile electronic device by a purchase transaction application according to the invention using a credit card with an unlimited spending ceiling as electronic money.

FIGS. 8A-8L schematically show the screens generated on the display of the mobile electronic device by a “Better Shop” application associated to one or more purchase transaction applications according to the invention.

FIGS. 9A-9E schematically show the screens generated on the display of the mobile electronic device by a “Flash Pay” feature of a purchase transaction application according to the invention.

FIGS. 10A-10D schematically show the screens generated on the display of the mobile electronic device by an “Internet” feature of a purchase transaction application according to the invention.

FIGS. 11A-11B schematically show the screens generated on the display of the mobile electronic device by a purchase transaction application according to the invention when coupled to a value added service related to the direct advertising/marketing information.

### DETAILED DESCRIPTION OF THE INVENTION

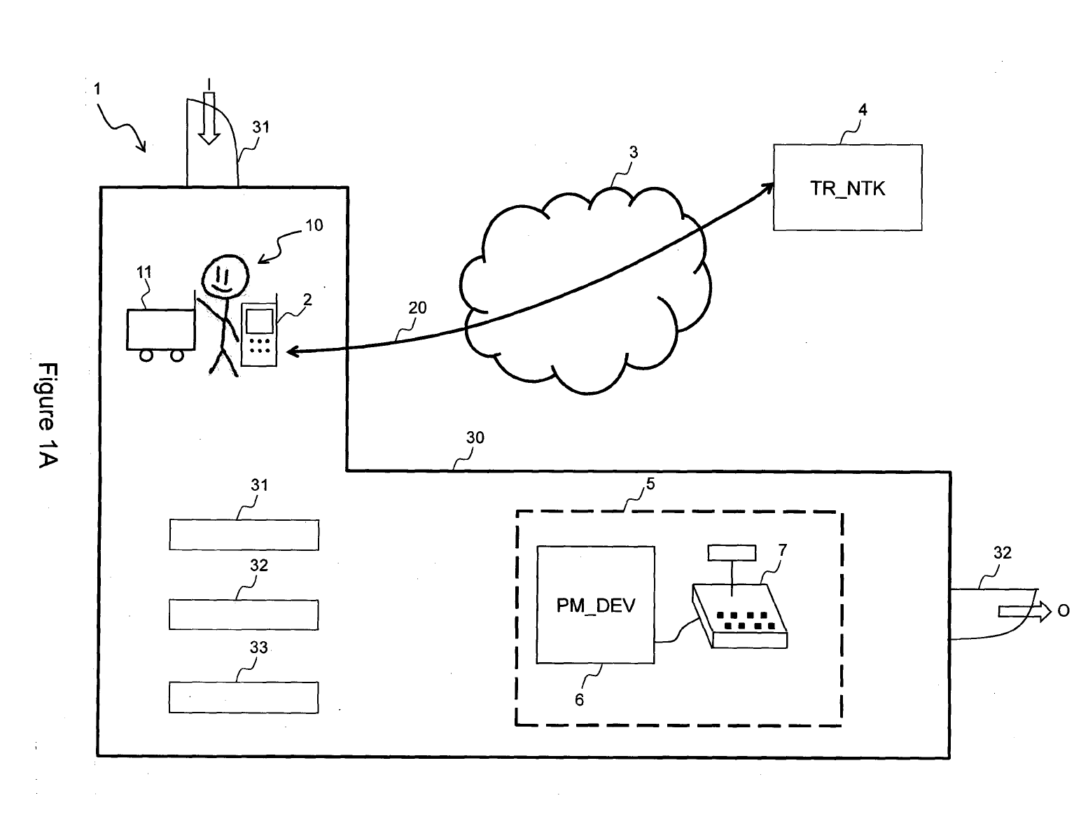

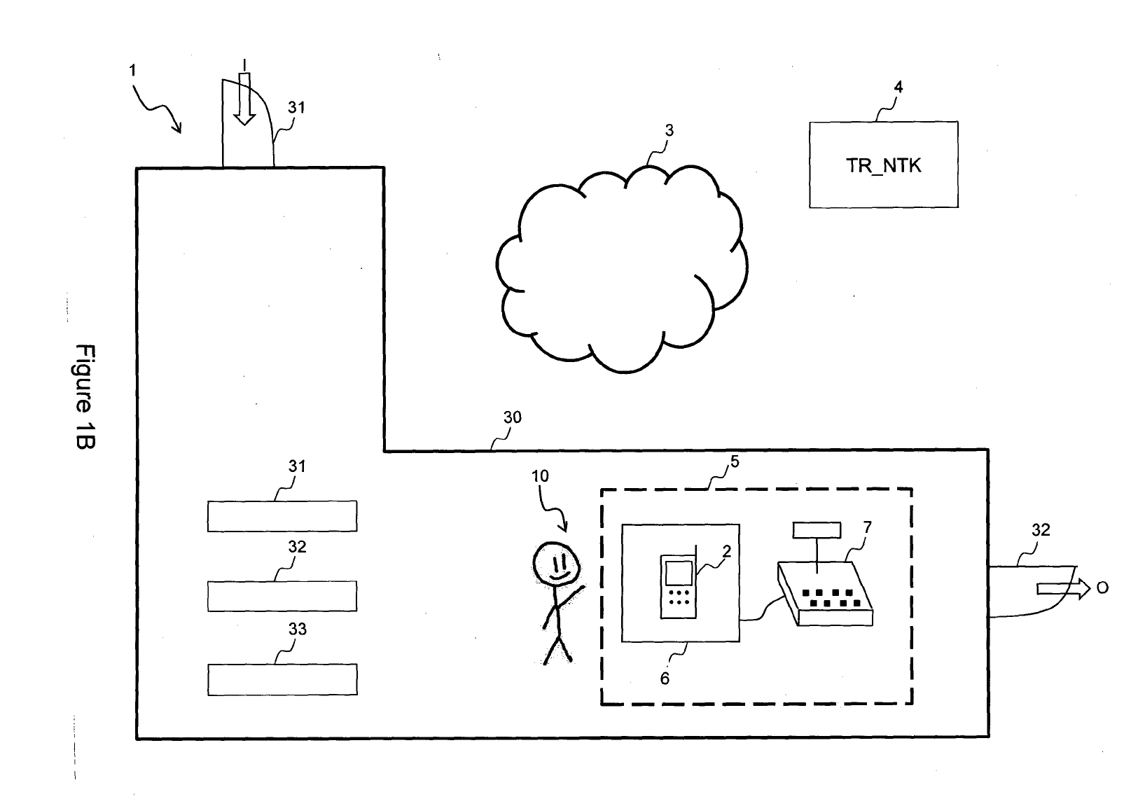

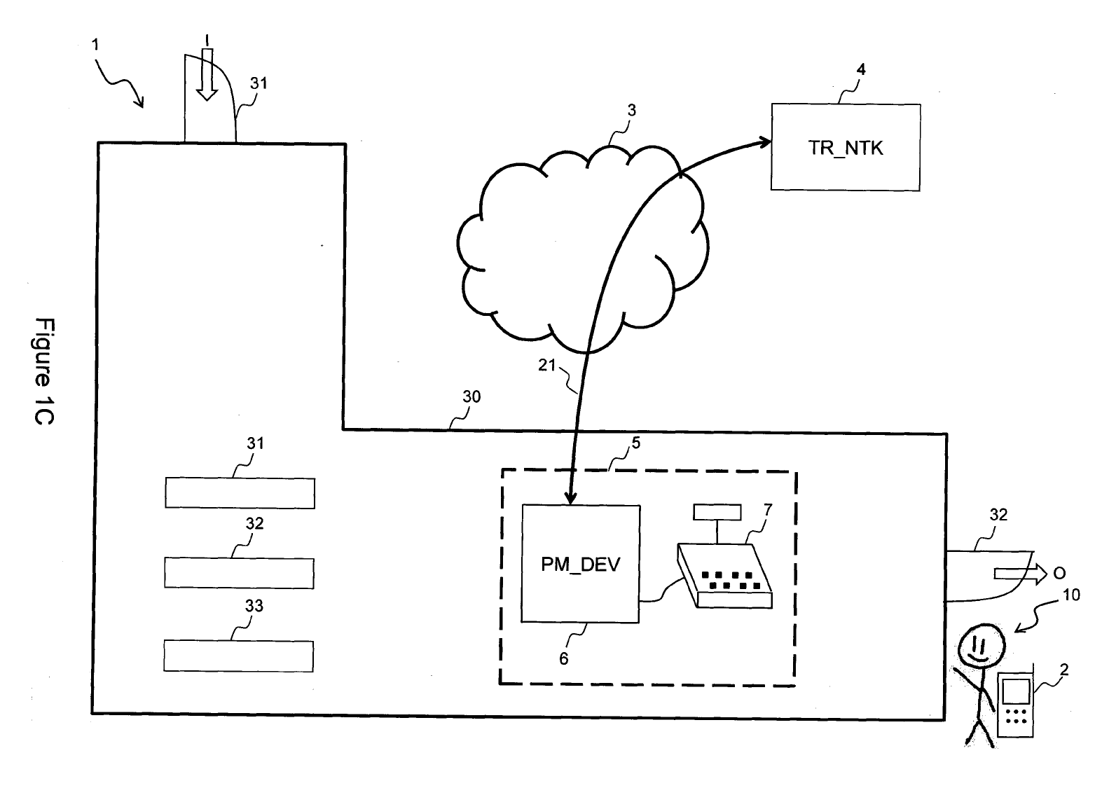

Referring to FIGS. 1A, 1B, 1C, they show an electronic system 1 to perform a purchase transaction of goods and services according to a first embodiment of the invention at subsequent time instants.

The purchase transaction includes the following phases:
verification phase;
shopping phase;
payment phase;
settlement phase.

In particular, FIG. 1A shows the operation of the electronic system 1 in a verification phase, FIG. 1B shows the operation of the electronic system 1 in a payment phase and FIG. 1C shows the operation of the electronic system 1 in a settlement phase.

The electronic system 1 comprises a mobile electronic device 2, a telecommunications network 3, a transaction network 4, a Point-of-Sale device 6 and a counter 7; the physical place wherein the Point-of-Sale device 6 and the counter 7 are located is referred to as “Point-of-Sale” (POS) 5, which is the place wherein a purchase transaction occurs. The Point-of-Sale device 6 can be a physical device composed of one or more sub-devices or it can be a virtual device, such as a computer program (i.e., software application) running on a processor of a web server of an on-line store and including the functionalities required to perform the payment and settlement phase of the purchase transaction.

FIGS. 1A-C also show a user 10 who is holding the mobile electronic device 2 inside a store 30 (for example, a supermarket) wherein the user 10 is picking up goods from the shelves, putting them in a trolley 11 and performing payment at the Point-of-Sale 5 by means of “electronic money”.

In the present document “electronic money” means that the user 10 may perform a purchase transaction (in the example, a purchase of goods from a supermarket 30) without making use of “cash money”, and in particular the user 10 is making use of one of the following payment methods:
a credit card (Visa, MasterCard) with a limited spending ceiling;
a credit card (American Express, Diners) with an unlimited spending ceiling;
a debit card, usually with a limited spending ceiling;
a bank transfer.

The supermarket 30 includes three shelves 31, 32, 33 for placing the goods and includes one Point-of-Sale 5.

The mobile electronic device 2 has the function to perform the verification phase of the purchase transaction and to perform the payment phase of the purchase transaction by means of a purchase transaction application running on a processor 163 of the mobile electronic device 2, as it will be described more in detail below in the description of the operation of the electronic system 1. Preferably, the mobile electronic device 2 is such to activate the verification phase, as it will be described more in detail below in the description of the operation of the first embodiment; alternatively, the verification phase is activated by the transaction network, as it will be described more in detail below in the description of the “push” messages.

The mobile electronic device 2 is, for example, a mobile phone, such as a smartphone (for example, an Apple iPhone®) or a tablet (for example, an Apple iPad®) or a tablet PC or a laptop.

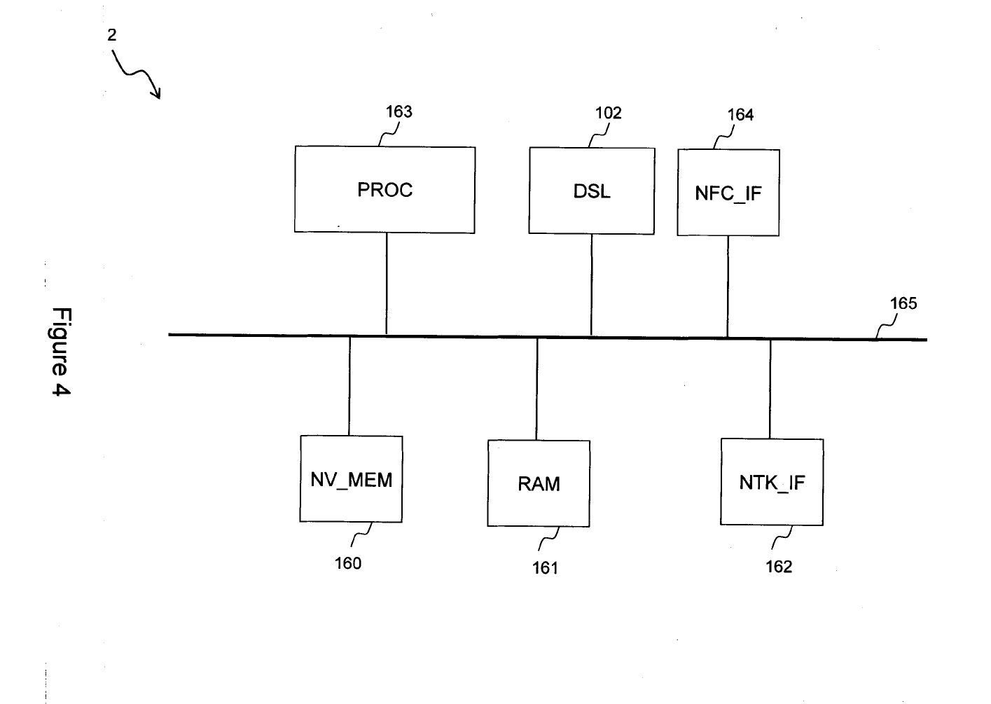

Referring to FIG. 4, the mobile electronic device 2 includes hardware and software modules, in particular:
a RAM memory 161 for storing a computer program:
a processor 163 for running the computer program, including the purchase transaction application for performing the verification phase and the payment phase, as it will be described more in detail below in the description of the operation of the electronic system 1;
a non-volatile memory 160 for storing data identifying the electronic money used for performing the purchase transaction, storing data indicating a valid or invalid authorization to use the electronic money for performing the purchase transaction, storing a value for indicating a successful or unsuccessful payment and, preferably, for storing an amount of funds available on the electronic money and the value of a bill amount to be paid for the goods or services purchased by the user 10;
a transmitting/receiving network interface 162 for communicating with the telecommunications network 3;
a transmitting/receiving near field communication (NFC) interface 164 for communicating with the Point-of-Sale device 6 located at the Point-of-Sale 5;
a display 102 (which can be touch-screen) to show images, icons, text, etc.

For example:
the telecommunications network 3 is a mobile network compliant with protocols such as GSM, UMTS, HSDPA, HSUPA, LTE, WiMax;
the mobile electronic device 2 is a smartphone and the network interface of the smartphone 2 is a transmitter/receiver for transmitting/receiving radio signals to/from the mobile network 3 according to GSM, UMTS, HSDPA, HSUPA, LTE, WiMax protocols;
the NFC interface 164 is a transmitter/receiver for transmitting/receiving radio signals to/from the NFC interface 64 of the Point-of-Sale device 6 according to short range protocols, such as Bluetooth® or IEEE 802.11 standard (also known as Wi-Fi) or ISO/IEC or ISO 13157 standard;
the display 102 is touch-screen, so that the user can touch (i.e., “tap on”) an icon on the display 102 in order to activate the computer program (i.e., the application) associated with said icon.

The transaction network 4 has the function to perform the verification phase of the purchase transaction and the settlement phase of the purchase transaction, as it will be described more in detail below in the description of the operation of the electronic system 1. The transaction network 4 may be a single party; for example, the transaction network 4 is (the server of) a bank wherein the user 10 owns a bank account wherein an amount of the electronic money is debited in order to perform the purchase transaction. More in general, the transaction network 4 includes a plurality of parties—usually, (the server(s) of) an acquiring bank, a card association and an issuing bank—that are connected to the mobile electronic device 2 and to the Point-of-Sale device 6 by means of the telecommunications network 3 and that provide transaction support services and/or are directly involved in the purchase transaction, wherein the data relevant for performing a purchase transaction are stored into a local (or remote) non-volatile memory of the server(s) of the transaction network 4 and are (across the parties of the transaction network 4) sent to/received from, as the case may be, the mobile electronic device 2 and the Point-of-Sale device 6.

The transaction network 4 includes a transmitting/receiving network interface to communicate with the telecommunications network 3 and exchange messages/data with the mobile electronic device 2 and the Point-of-Sale device 6.

According to the first and second embodiments of the invention, during the verification phase of the purchase transaction the mobile electronic device 2 is such to transmit to the transaction network 4, by means of the telecommunications network 3, a first message MSG1 carrying an electronic money identification data field EM_ID for indicating data identifying the electronic money used to perform the purchase transaction; preferably, the mobile electronic device 2 communicates with the transaction network 4 by means of a secure web connection. The telecommunications network 3 is such to route the first message MSG1 from the mobile electronic device 2 to the transaction network 4. The transaction network 4 is such to receive from the telecommunications network 3 the first message MSG1 (or a modified first message) carrying the electronic money identification data field EM_ID and is such to transmit to the mobile electronic device 2 a second message MSG2 carrying an authorization data field AUT_D indicating a valid or invalid authorization to use the electronic money for performing the purchase transaction and carrying, in case of an electronic money with a limited spending ceiling, an available balance field AV_BL indicating an amount of funds available on the electronic money. The mobile electronic device 2 is such to receive the authorization data field AUT_D (and, in case of an electronic money with a limited spending ceiling, also the available data field AV_BL) and is such to store into the non-volatile memory 160 the content of the authorization data field AUT_D (and, in case of an electronic money with a limited spending ceiling, it is such to store also the content of the available data field AV_BL).

In case of electronic money with a limited spending ceiling, a valid value of the content of the authorization data field AUT_D indicates a valid authorization for the mobile electronic device 2 to use the electronic money for trying to perform a purchase transaction with a limited expenditure amount. In this case the second message MSG2 carries the available balance field AV_BL and the content of the available balance field AV_BL indicates the amount of funds available on the electronic money, meaning that the electronic money is authorized to perform (and thus it can actually perform only) a purchase transaction for an expenditure up to the amount of available funds.

In case of electronic money with an unlimited spending ceiling, a valid value of the content of the authorization data field AUT_D indicates a valid authorization for the mobile electronic device 2 to use the electronic money for performing a purchase transaction with an unlimited expenditure amount. In this case the following alternative solutions are possible:
the second message MSG2 does not carry the available balance field AV_BL;
the second message MSG2 carries the available balance field AV_BL and the available balance field AV_BL is not meaningful, that is it's not taken into account by the purchase transaction application running of the mobile electronic device 2;
the second message MSG2 carries the available balance field AV_BL which is taken into account by the purchase transaction application: in particular, the value of the content of the available balance field AV_BL is equal to an indefinitely high (i.e., unlimited) value (for example, 50.000,00 USD);
the second message MSG2 carries the available balance field AV_BL which is taken into account by the purchase transaction application: in particular, the value of the content of the available balance field AV_BL is equal a security spending ceiling (for example, 10.000,00 USD), that may be configured by the user 10 and/or by the card association/issuing bank.

In one example, the electronic money is a credit (or debit) card belonging to the user 10 and having a limited monthly spending ceiling equal to 2.500,00 USD, wherein:
the electronic money identification data field EM_ID indicates the serial number of the credit (or debit) card, the expiration date, the name of the issuing bank, the name of the card association, the security code and the name and surname of the owner of the credit (or debit) card;
the authorization data field AUT_D indicates a valid (or invalid) authorization for the credit (or debit) card;
the available balance field AV_BL indicates (in case of a valid authorization for the credit or debit card) the amount of funds available on the credit (or debit) card.

In another example, the electronic money is a credit (or debit) card belonging to the user 10 and having an unlimited monthly spending ceiling, wherein:
the electronic money identification data field EM_ID indicates the serial number of the credit (or debit) card, the expiration date, the name of the issuing bank, the name of the card association, the security code and the name and surname of the owner of the credit (or debit) card;
the authorization data field AUT_D indicates a valid (or invalid) authorization for the credit (or debit) card;
the available balance field AV_BL indicates (in case of a valid authorization for the credit or debit card) a defined number (for example, an high value such as 50.000,00 USD, or a security spending ceiling such as 10.000,00 USD).

The telecommunications network 3 can be a mobile network, a fixed network (LAN or WAN) or a combination of mobile and fixed networks.

The Point-of-Sale device 6 has the function to perform the payment phase of the purchase transaction and to activate and perform the settlement phase, as it is described more in detail below in the description of the operation of the electronic system 1.

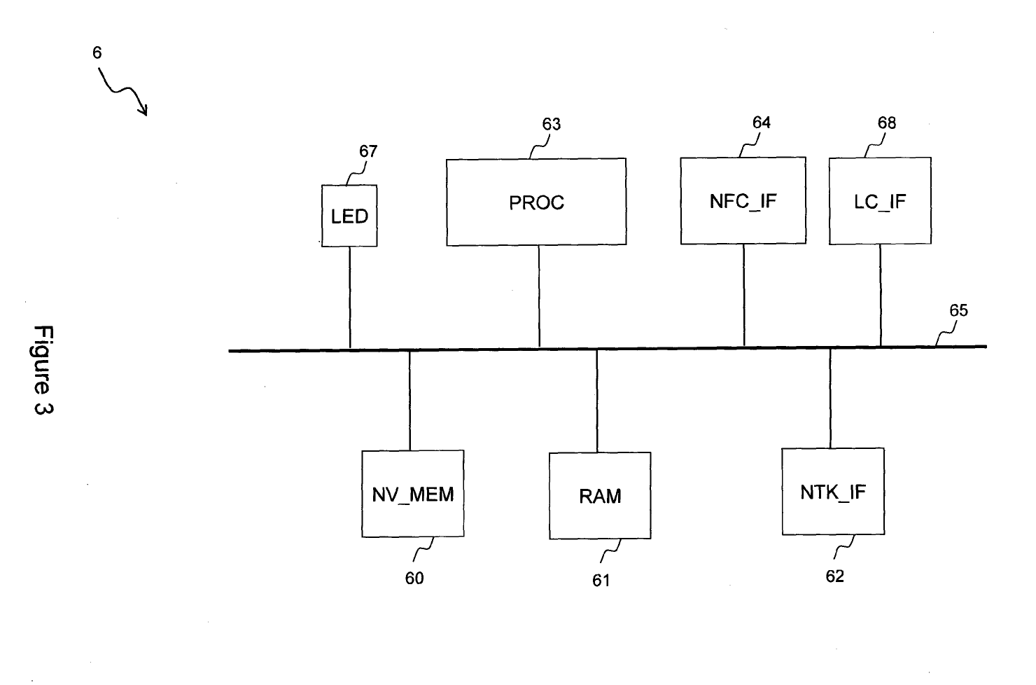

Referring to FIG. 3, the Point-of-Sale device 6 includes hardware and software modules, which are in particular:
a RAM memory 61 for storing a computer program;
a processor 63 for running the computer program performing the payment phase and the settlement phase of the purchase transaction;
a non-volatile memory 60 for storing the content of the electronic money identification data field EM_ID, storing a bill amount value generated by the counter 7 to be paid for the purchased goods or services and storing the content of the available balance field AV_BL;
a transmitting/receiving near field communication (NFC) interface 64 for communicating with the mobile electronic device 2; for example, the NFC interface 64 is a transmitter/receiver for transmitting/receiving radio signals to/from the NFC interface 164 of the mobile electronic device 2 according to short range protocols such as Bluetooth®, IEEE 802.11 standard, ISO/IEC or ISO 13157 standard;
a transmitting/receiving network interface 62 for communicating with the telecommunications network 3;
a pad for holding the mobile electronic device 2;
a local interface 68 for communicating with the counter 7;
one or more visual indicators 67 such as LED, or acoustic indicators.

Preferably, the counter 7 (that includes also a bar code scanner) can be integrated into the Point-of-Sale device 6 thus performing also the scanning of the goods and the calculation of the bill amount.

Alternatively, the main functionalities of the counter 7 may be performed by the mobile electronic device 2. For example, RFID (Radio-Frequency Identifier) tags may be attached to the goods to be purchased in order to store prices (and other details, such as, for example, product descriptions and code numbers) of the goods; the mobile electronic device 2 (or, alternatively, the integrated Point-of-Sale device 6) may include a RFID tag reader device and a related computer program that are such to read the prices (and the other details) of the purchased goods from the RFID tags in order to generate a bill amount and other data (for example, a detailed list of the purchased goods).

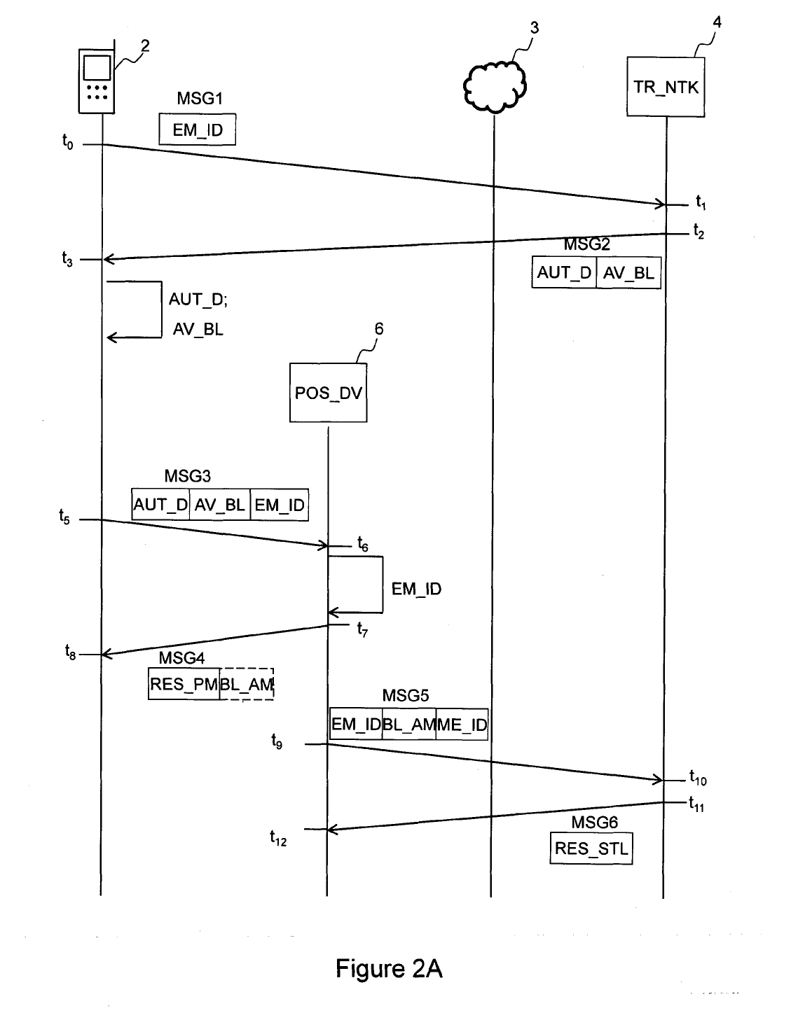

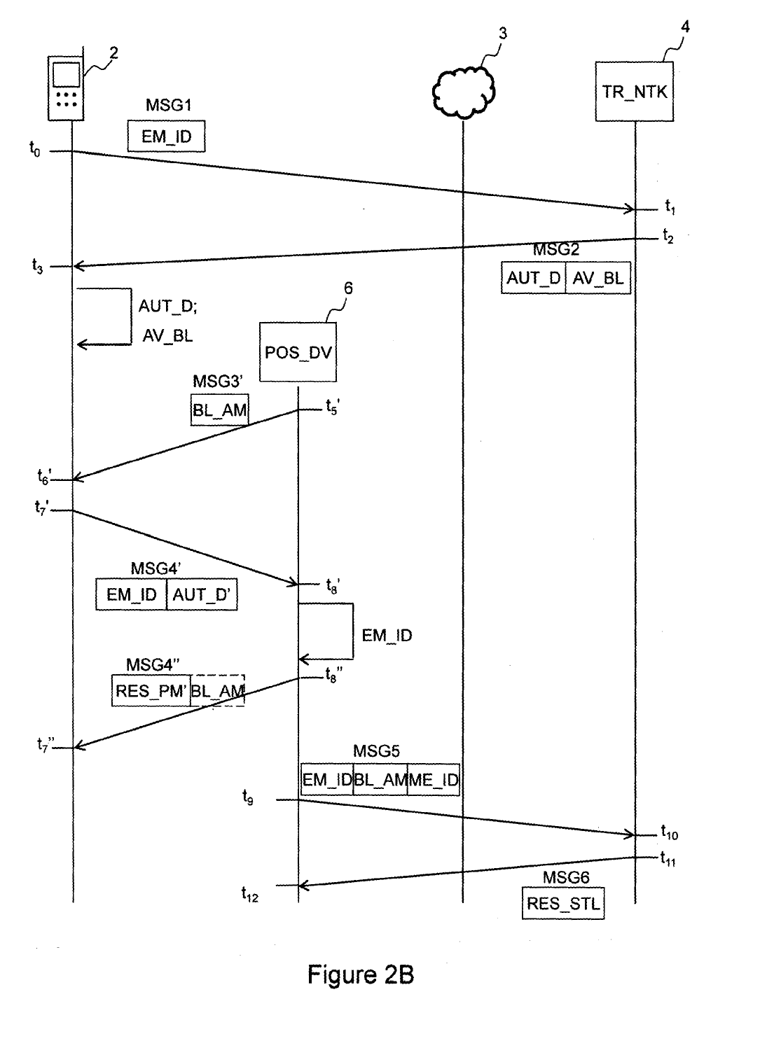

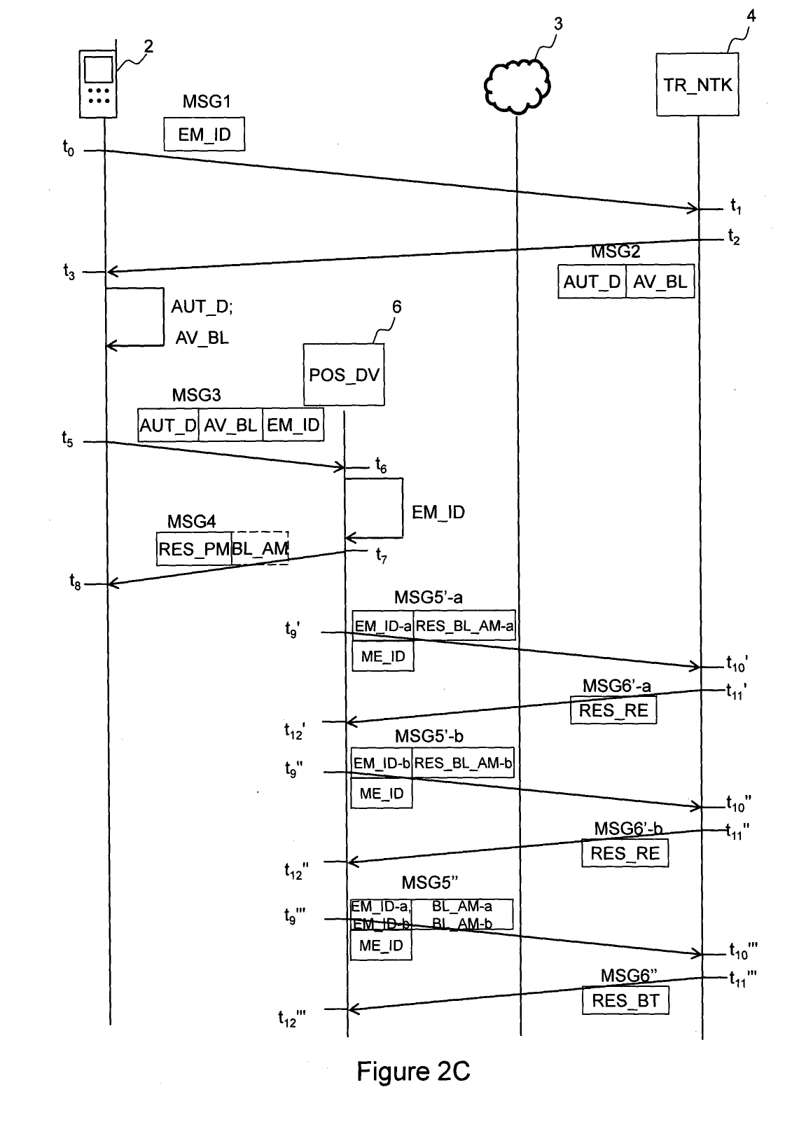

According to the first embodiment of the invention (see FIG. 2A), during the payment phase of the purchase transaction the mobile electronic device 2 is such to transmit to the Point-of-Sale device 6 a third message MSG3 carrying the electronic money identification data field EM_ID, carrying the authorization data field AUT_D and (in case of a valid value of the authorization data field AUT_D) carrying the available balance field AV_BL. The Point-of-Sale device 6 is such to receive the electronic money identification data field EM_ID, the authorization data field AUT_D and (in case of a valid value of the authorization data field AUT_D) the available balance field AV_BL. The Point-of-Sale device 6 is such to store the content of the electronic money identification data field EM_ID into the non-volatile memory 60, is such to compare the value of the content of the available balance field AV_BL with respect to the value of a bill amount value generated by the counter 7 and is such to transmit to the mobile electronic device 2 a fourth message MSG4 carrying a payment result field RES_PM having a first value (for example, an high logic value) to indicate a successful payment (meaning that the bill amount value will be debited on the electronic money) in case the value of the content of the available balance field AV_BL is greater than or equal to the value of the bill amount, or having a second value (for example, a low logic value) to indicate an unsuccessful payment (meaning that the bill amount value won't be debited on the electronic money) in case the value of the available balance field AV_BL is smaller than the value of the bill amount.

According to the second embodiment of the invention (see FIG. 2B), during the payment phase of the purchase transaction the Point-of-Sale device 6 is such to transmit to the mobile electronic device 2 a message MSG3′ carrying a bill amount field BL_AM equal to the value of a bill amount generated by the counter 7 for the goods purchased by the user 10. The mobile electronic device 2 is such to receive the bill amount field BL_AM, is such to compare the value of the content of the available balance field AVBL stored into the memory 160 with respect to the (received) value of the bill amount field BL_AM and is such to transmit to the Point-of-Sale device 6 a message MSG4′ carrying the electronic money identification data field EM_ID and an authorization data field AUT_D′ having a valid or invalid value for indicating a valid or invalid authorization respectively to use the electronic money. The Point-of-Sale device 6 is such to receive the electronic money identification data field EM_ID and the authorization data field AUT_D′ indicating a valid or invalid authorization for the electronic money and is such to store the content of the electronic money identification data field EM_ID into the non-volatile memory 60. The Point-of-Sale device 6 is such to transmit to the mobile electronic device 2 a message MSG4″ carrying a payment result field RES_PM′ having a first value (for example, an high logic value) to indicate a successful payment in case of a valid value of the content of the authorization data field AUT_D′, or having a second value (for example, a low logic value) to indicate an unsuccessful payment in case of an invalid value of the content of the authorization data field AUT_D′.

According to a variant of the second embodiment of the invention, RFID tags are attached to the goods to be purchased and such RFID tags store the prices (and other details) of the goods; moreover, the mobile electronic device 2 includes a RFID tag reader and a related computer program configured to read the prices (and the other details) of the goods from the RFID tags. In this case, during the shopping phase, the mobile electronic device 2 is such to read the prices (and the other details) of the purchased goods from the RFID tags by means of the RFID tag reader and the related computer program and is such to store the prices (and the other details) into the non-volatile memory 160. During the payment phase of the purchase transaction the mobile electronic device 2 does not receive the message MSG3′ carrying a bill amount field BL_AM, because the mobile electronic device 2 is such to calculate the value of the bill amount as the algebraic sum of the stored values of the prices of the purchased goods, is such to compare the value of the content of the available balance field AV_BL with respect to the value of the (calculated) bill amount and is such to transmit to the Point-of-Sale device 6 the message MSG4′ carrying the electronic money identification data field EM_ID and the authorization data field AUT_D′ including a valid or invalid authorization for the electronic money, carrying a bill amount field BL_AM′ equal to the value of a bill amount generated by the mobile electronic device 2 and carrying an items data field ITM_CO indicating the codes of the purchased goods read by the mobile electronic device 2. The Point-of-Sale device 6 is such to receive the electronic money identification data field EM_ID, the authorization data field AUT_D′ having a valid or invalid authorization for the electronic money, the bill amount field BL_AM′ and the items data field ITM_CO and is such to store the content of the electronic money identification data field EM_ID, the content of the bill amount field BL_AM′ and the content of the ITM_CO field into the non-volatile memory 60. The Point-of-Sale device 6 is such to transmit to the mobile electronic device 2 the message MSG4″ carrying a payment result field RES_PM′ having a first value (for example, an high logic value) to indicate a successful payment in case of a valid value of the authorization data field AUT_D′ or having a second value (for example, a low logic value) to indicate an unsuccessful payment in case of an invalid value of the authorization data field AUT_D′.

During the settlement phase of the purchase transaction the Point-of-Sale device 6 is such to transmit to the transaction network 4, by means of the telecommunications network 3, a fifth message MSG5 carrying the electronic money identification data field EM_ID, a bill amount field BL_AM and a merchant identification data field ME_ID identifying the merchant of the store 30; preferably, the Point-of-Sale device 6 communicates with the transaction network 4 by means of a secure web connection. For example, the content of the merchant identification data field ME_ID indicates the business name of the merchant, the store address and the IBAN (International Bank Account Number) of the bank account of the merchant (for example, the bank account at the acquiring bank). The telecommunications network 3 is such to route the fifth message MSG5 from the mobile electronic device 2 to the transaction network 4. The transaction network 4 is such to receive from the telecommunications network 3 the fifth message MSG5 (or a modified fifth message) carrying the electronic money identification data field EM_ID, the bill amount field BL_AM and the merchant identification data field ME_ID and is such to transmit to the Point-of-Sale device 6 a sixth message MSG6 carrying a settlement result field RES_STL having a first value (for example, an high logic value) to indicate a successful settlement or having a second value (for example, a low logic value) to indicate an unsuccessful settlement, meaning that the value of the bill amount field BL_AM has been or has not been debited on the electronic money of the user 10 respectively and that the value of the bill amount field BL_AM has been or has not been credited on the bank account of the merchant respectively.

It is described hereinafter the operation of the electronic system 1 when performing a purchase transaction according to the first embodiment of the invention, referring also to FIGS. 1A, 1B, 1C, 2A and 5A-5M.

For the sake of simplicity it is supposed that:
the electronic money is a debit card with a limited monthly spending ceiling equal to 2.500,00 USD;
the user 10 owns only one debit card;
the user 10 purchases goods from the supermarket 30;
the mobile electronic device 2 is a smartphone with touch-screen control;
the telecommunications network 3 is a mobile network;
the transaction network 4 is the server of the bank wherein the user 10 owns a bank account associated with the debit card and said server will be indicated below with bank server 4.

It is also supposed that data related to the debit card have already been configured in the smartphone 2 by means of a set-up procedure of the purchase transaction application (previously completed), so that the smartphone 2 has stored into the non-volatile memory 160 the following data identifying the debit card:
serial number;
expiration date;
name of the issuing bank;
name of the card association;
security code;

name and surname of the debit card owner.

The verification phase is comprised between t₀ and t₃, the shopping phase is comprised between t₃ and t₅, the payment phase is comprised between t₄ and t₈ and the settlement phase is comprised between t₉ and t₁₂.

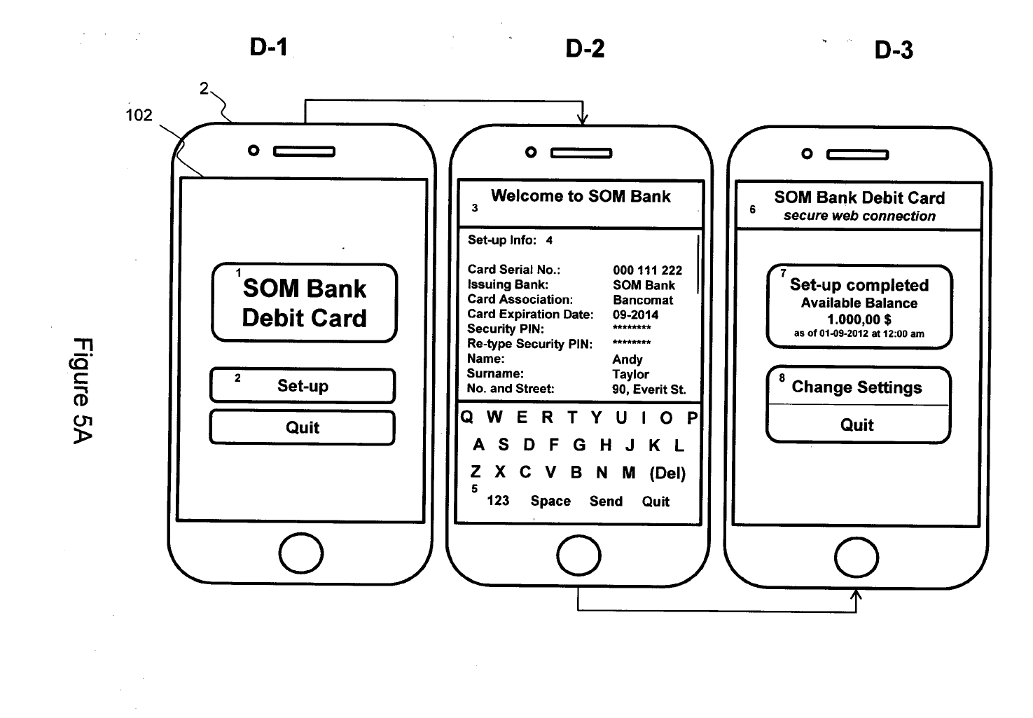

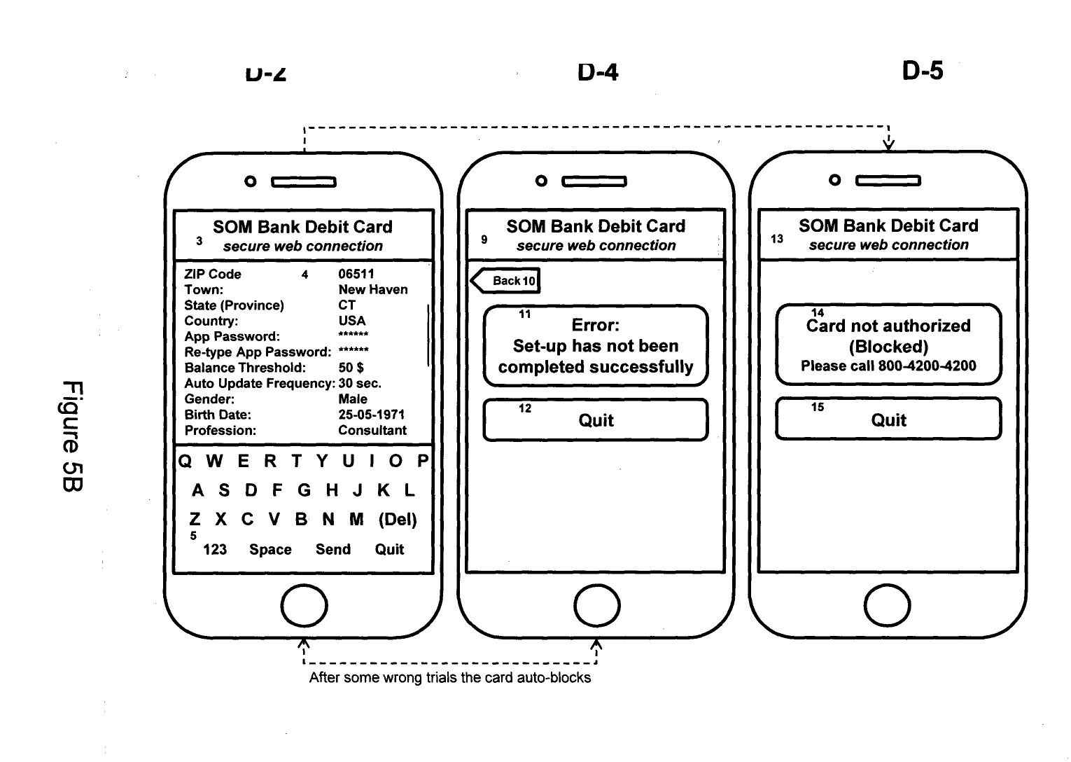

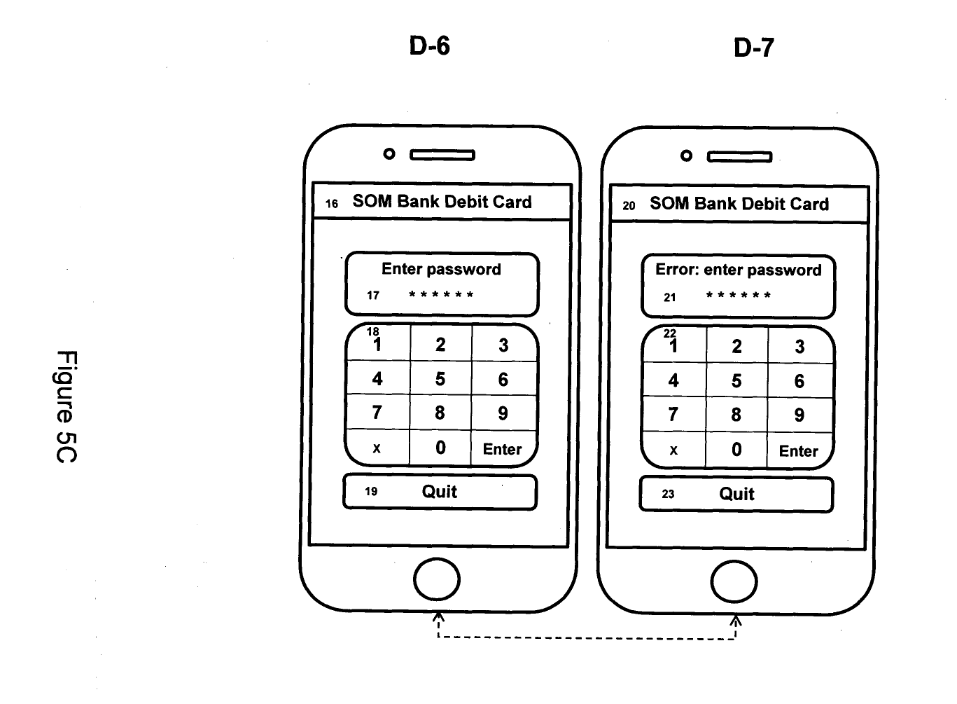

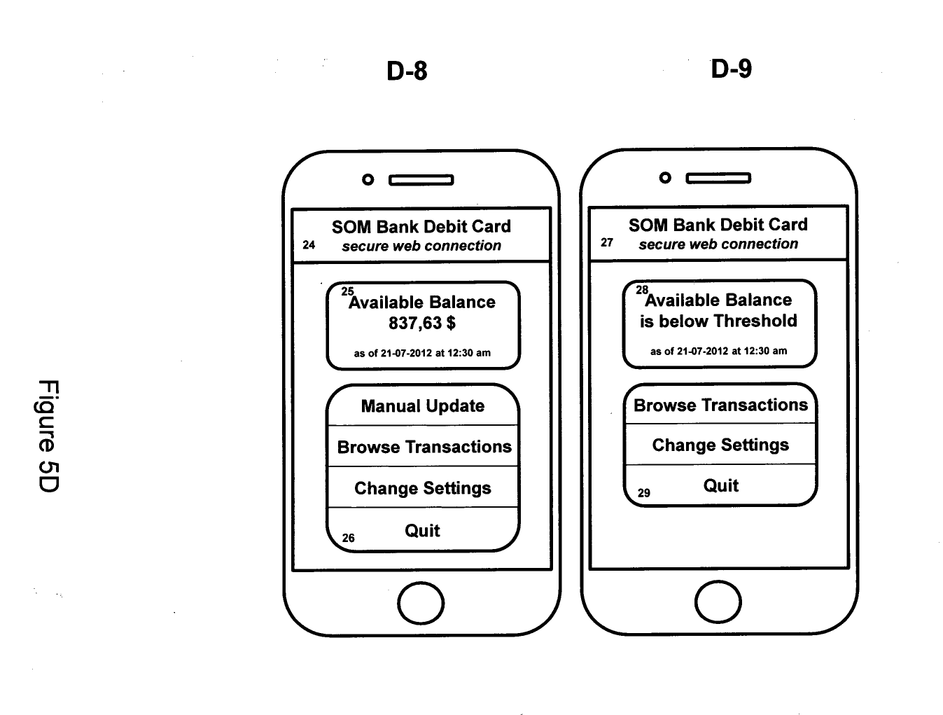

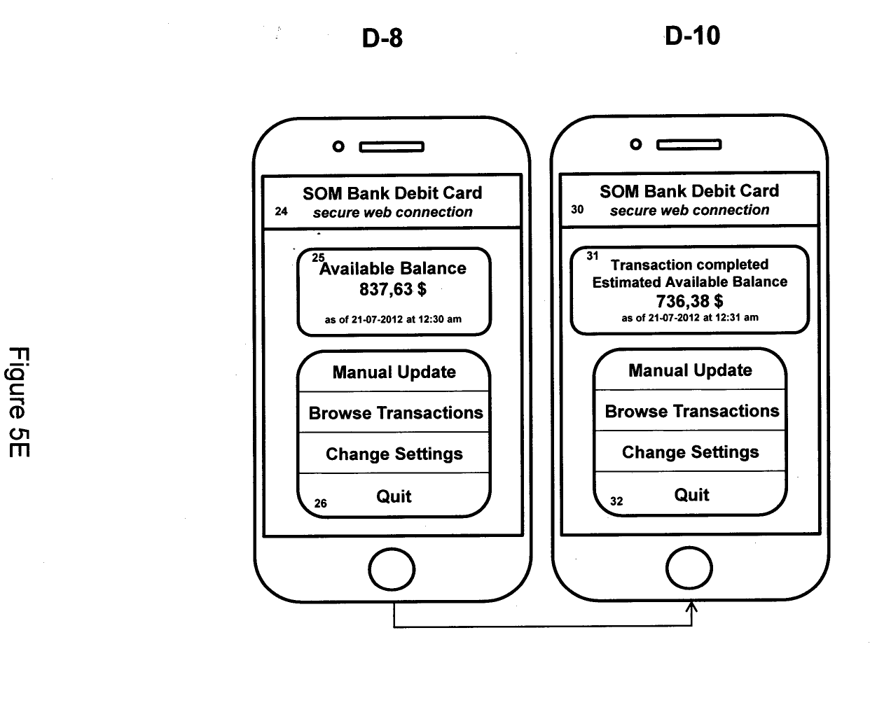

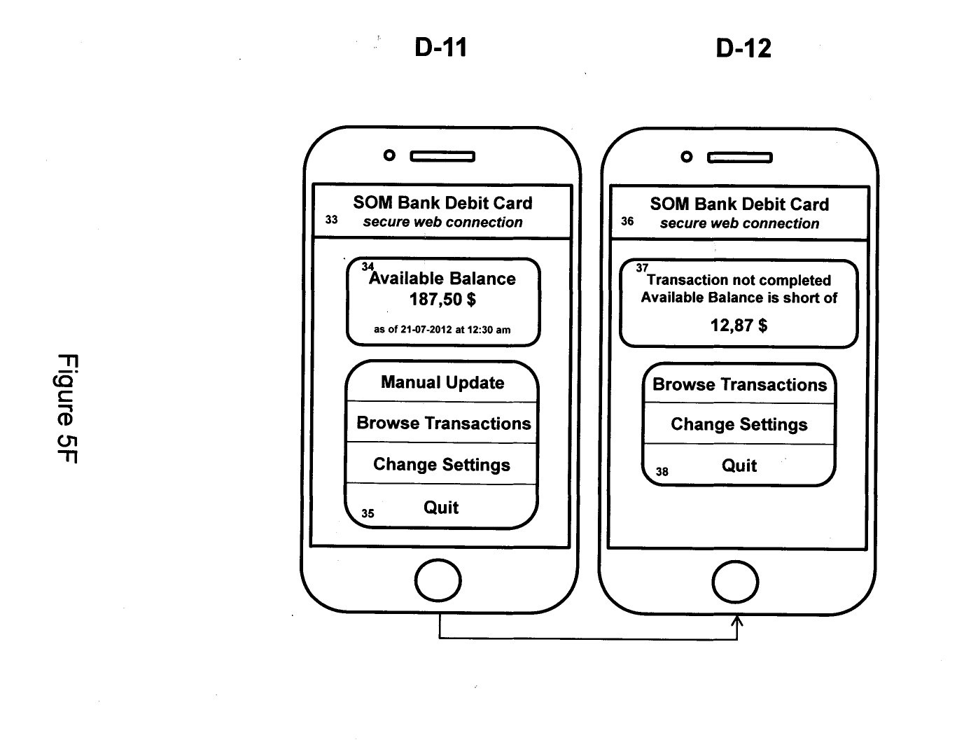

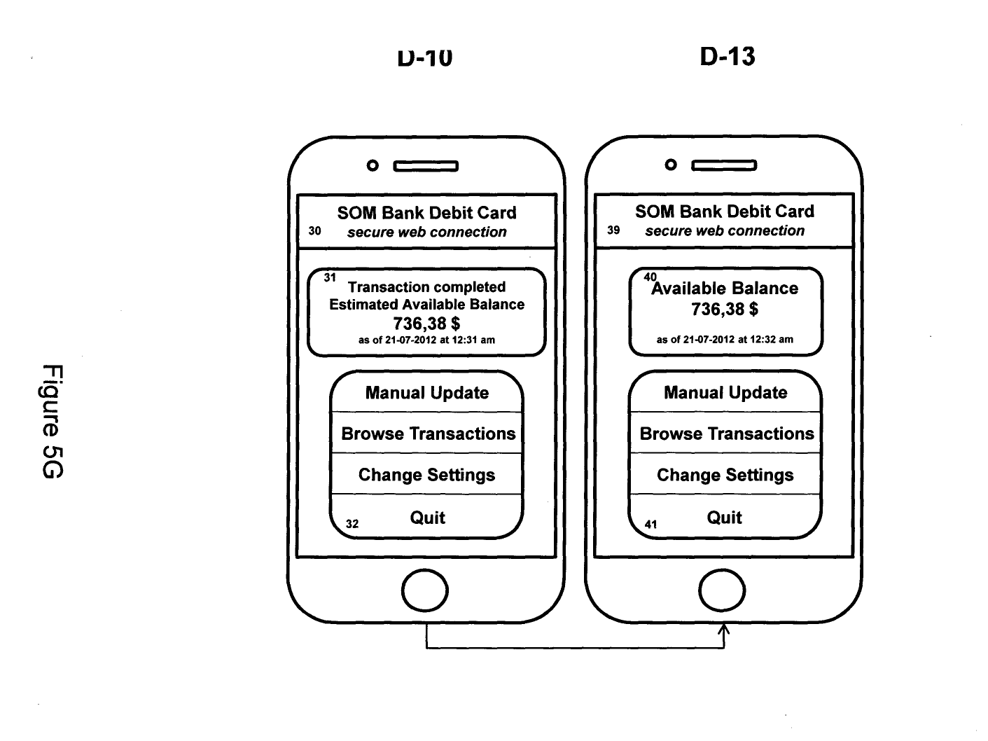

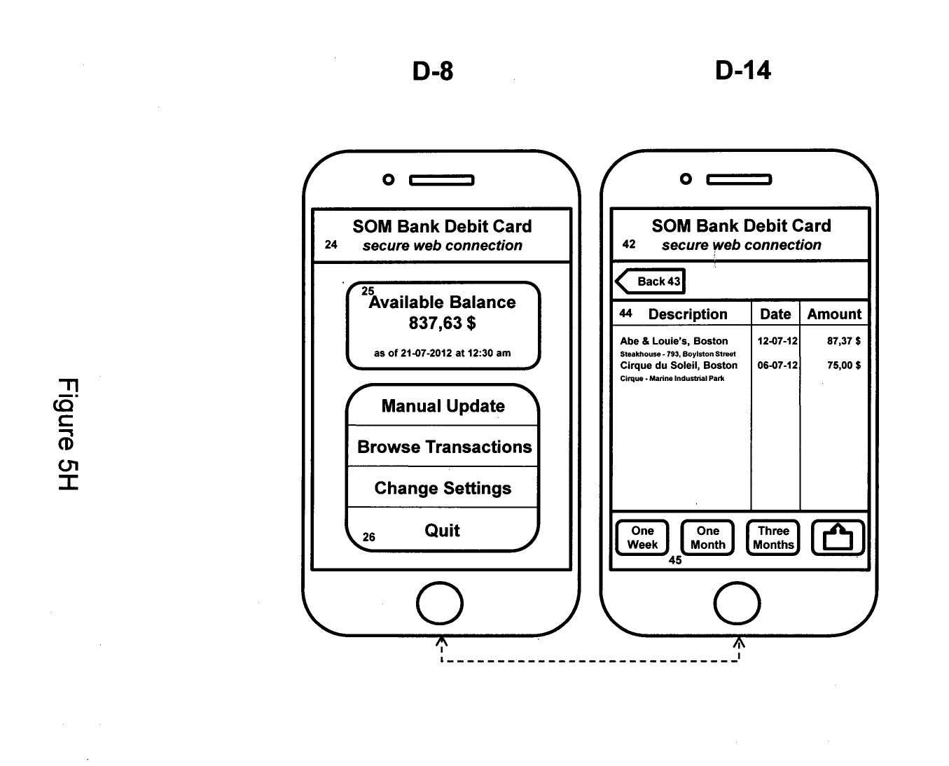

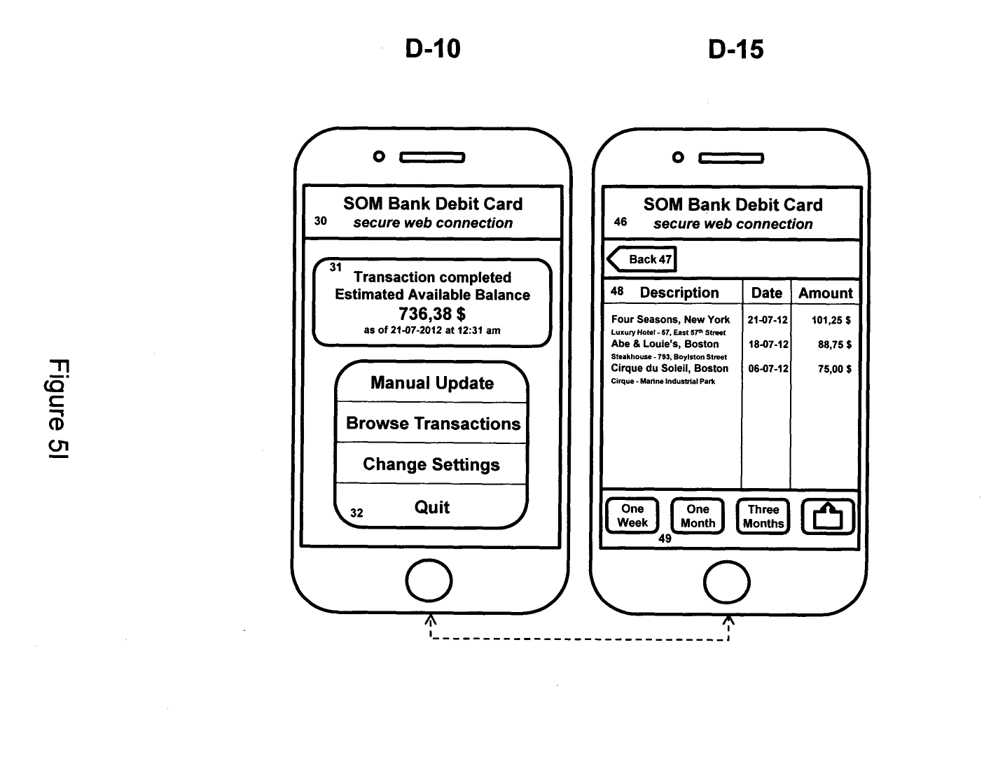

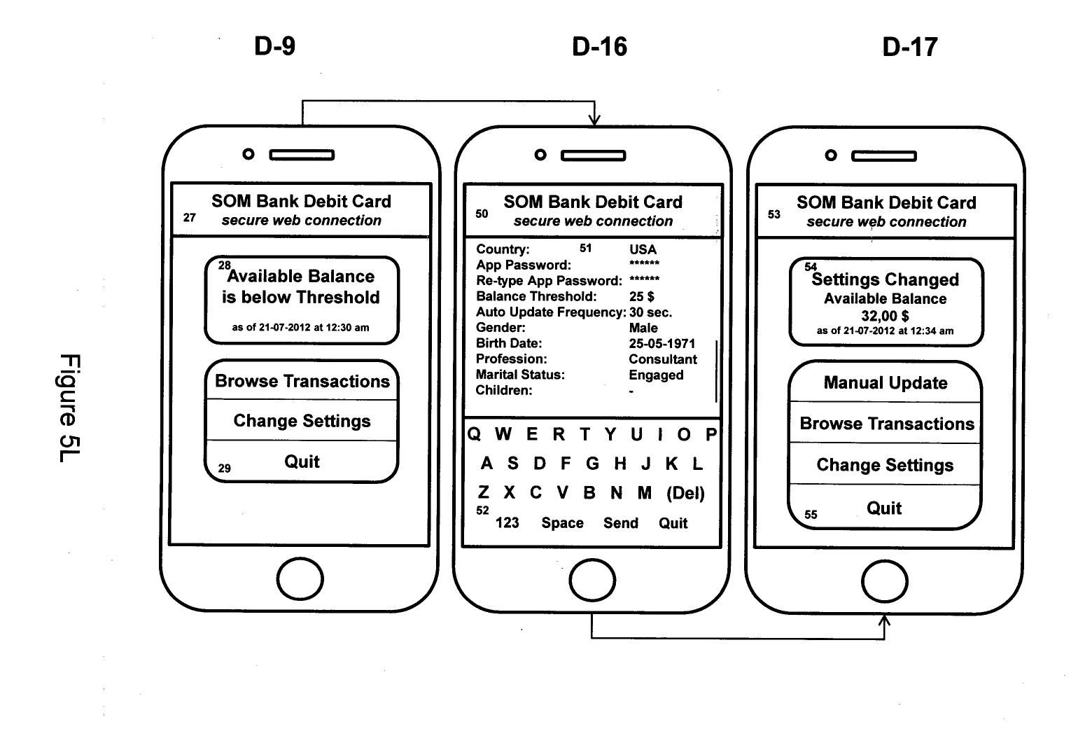

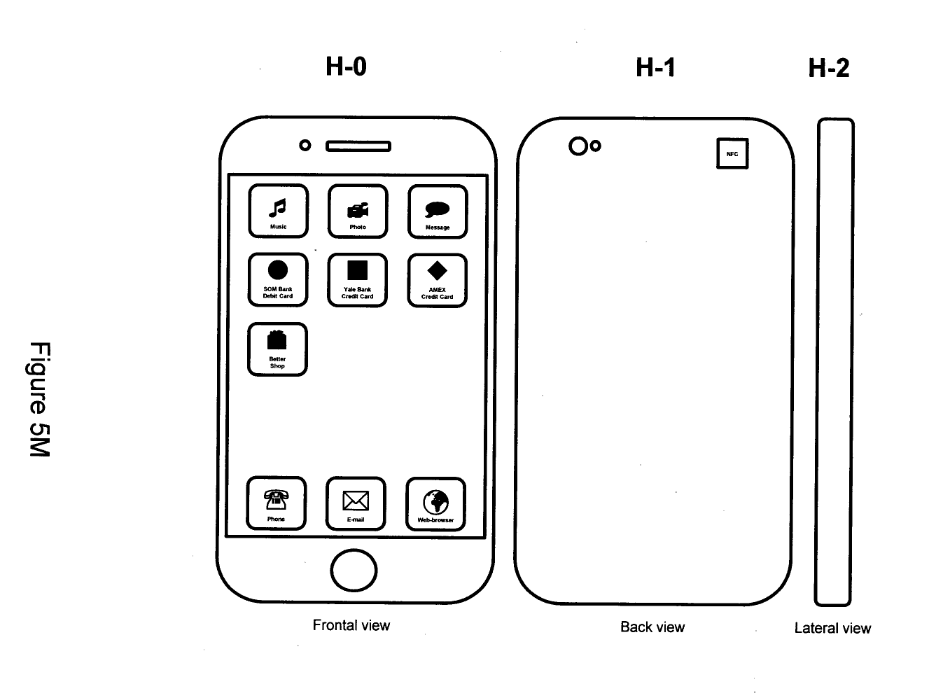

At time t₀ the user 10 enters the supermarket 30 from the main door 31. The user 10 holds the smartphone 2 and runs on the smartphone 2 the purchase transaction application for performing the verification phase. For example, starting from the Home screen (see FIG. 5M, H-0) on the display 102 of the smartphone 2, the user 10 touches on the display 102 an icon (representing a symbol, for example, a coin) identified by a text string (such as “SOM Bank Debit Card”, see area 1 in FIG. 5A, D-1) to run the purchase transaction application.

The purchase transaction application running on the smartphone 2 reads from the non-volatile memory 160 the serial number of the debit card, the expiration date, the name of the issuing bank, the name of the card association, the security code and the name and surname of the debit card owner. Afterwards, the smartphone 2 transmits to the bank server 4, by means of the mobile network 3, a first message MSG1 carrying an electronic money identification data field EM_ID indicating the serial number of the debit card, the expiration date, the name of the issuing bank, the name of the card association, the security code and the name and surname of the debit card owner.

The mobile network 3 routes the first message MSG1 from the smartphone 2 to the bank server 4 (see the arrow 20 in FIG. 1A). For the sake of simplicity it is supposed that the mobile network 3 routes the first message MSG1 unchanged, but similar considerations are applicable in case the mobile network 3 modifies the first message MSG1, provided that the modified first message received by the bank server 4 includes the electronic money identification data field EM_ID.

At time t₁ (subsequent to t₀) the bank server 4 receives from the mobile network 3 the first message MSG1 and extracts therefrom the content of the electronic money identification data field EM_ID.

The bank server 4 reads from a local (or remote) non-volatile memory the identification data of the debit card (the expiration date, the name of the issuing bank, the name of the card association, the security code and the name and surname of the debit card owner) corresponding to the serial number extracted from the electronic money identification data field EM_ID.

The bank server 4 processes the content of the electronic money identification data field EM_ID received from the first message MSG1 and compares it with respect to the debit card identification data stored into the local (or remote) non-volatile memory. In particular, the bank server 4 checks that the name and surname of the debit card owner of the received electronic money identification data field EM_ID correspond to the name and surname of the debit card owner stored into the local (or remote) non-volatile memory, checks that the expiration date of the received electronic money identification data field EM_ID corresponds to the expiration date stored into the local (or remote) non-volatile memory, checks that the expiration date is subsequent to the current date and checks that the security code of the received electronic money identification data field EM_ID corresponds to the security code stored into the local (or remote) non-volatile memory.

It is supposed that all the above checks are positive.

At time t₂ (subsequent to t₁) the bank server 4 reads from the local (or remote) non-volatile memory the amount of funds available on the debit card having the serial number corresponding to the serial number extracted from the electronic money identification data field EM_ID and transmits the second message MSG2 carrying an authorization data field AUT_D indicating a valid authorization for the debit card and carrying an available balance field AV_BL indicating the amount of funds available on the debit card (in the example, 837,63 USD).

The mobile network 3 routes the second message MSG2 from the bank server 4 to the smartphone 2 (see the arrow 20 in FIG. 1A). For the sake of simplicity it is supposed that the mobile network 3 routes the second message MSG2 unchanged, but similar considerations are applicable in case the mobile network 3 modifies the second message MSG2, provided that the modified second message received by the smartphone 2 includes the authorization data field AUT_D and the available balance field AVBL.

At time t₃ (subsequent to t₂) the smartphone 2 receives from the mobile network 3 the second message MSG2, extracts therefrom the content of the authorization data field AUT_D and the content of the available balance field AV_BL and stores into the non-volatile memory 160 the content of the authorization data field AUT_D indicating the valid authorization for the debit card and the content of the available balance field AV_BL indicating the amount (837,63 USD) of funds available on the debit card. Moreover, the display 102 of the smartphone 2 shows a message (see area 25 in FIG. 5E, D-8) which indicates the value (837,63 USD) of the amount of available funds.

Therefore at time t₃ the user 10 holds the smartphone 2 that is running the purchase transaction application and is storing (or has just stored) into the non-volatile memory 160 the information that the user 10 is authorized to use the debit card and that an amount of 837,63 USD is available on the debit card; this allows to significantly reduce the time the user 10 has to wait at the Point-of-Sale 5 before he may exit from the supermarket 30 with the purchased goods, as it is described below.

During the time interval comprised between t₃ and t₄ the user 10 continues to purchase the goods from the supermarket 30, picking up the goods from the shelves 31, 32, 33 and putting them in the trolley 11.

It is worth noting that the verification phase and the shopping phase can overlap. For example, the verification phase can be comprised between t₀ and t₃ and the shopping phase between t₁ and t₃, which means that the smartphone 2 requires to receive the authorization data field AUT_D and the available balance field AV_BL before the user 10 reaches the Point-of-Sale 5 at time t₄.

At time t₄ (subsequent to t₃) the user 10 reaches the Point-of-Sale 5 and starts the payment phase.

The user 10 moves the goods from the trolley 11 to the belt. The cashier scans the goods reading therefrom the prices (for example, reading the bar codes typed on the packaging of the goods by means of a bar code scanner) and the counter 7 generates a bill amount (to be paid for the scanned goods) equal to the algebraic sum of the prices of the purchased goods (in the example, the value of the bill amount is equal to 101,25 USD).

At time t₅ the user 10 leans the smartphone 2 on the pad of the Point-of-Sale device 6, as it is shown in FIG. 1B. The smartphone 2 communicates with the Point-of-Sale device 6 using a near field communication protocol, such as Bluetooth®. In particular, the purchase transaction application running on the smartphone 2 reads from the non-volatile memory 160 the stored value of the content of the authorization data field AUT_D (in the example, an high logic value) indicating a valid authorization for the debit card and the stored value of the content of the available balance field AV_BL indicating the amount (837,63 USD) of the funds available on the debit card. Afterwards, the smartphone 2 transmits to the Point-of-Sale device 6 a third message MSG3 according to the near field communication protocol (Bluetooth®), wherein the third message MSG3 carries the electronic money identification data field EM_ID indicating the serial number of the debit card, the expiration date, the name of the issuing bank, the name of the card association, the security code and the name and surname of the debit card owner, carries the authorization data field AUT_D having a first value equal to an high logic value which indicates a valid authorization for the debit card and carries the available balance field AV_BL indicating the amount of funds available on the debit card (in the example, 837,63 USD).

At time t₆ (subsequent to t₅) the NFC interface 64 of the Point-of-Sale device 6 receives the third message MSG3 and extracts therefrom the content of the electronic money identification data field EM_ID, the content of the authorization data field AUT_D and the content of the available balance field AV_BL. The computer program running on the processor 63 of the Point-of-Sale device 6 processes the content of the electronic money identification data field EM_ID, the content of the authorization data field AUT_D and the content of the available balance field AV_BL received from the third message MSG3. In particular, the Point-of-Sale device 6 detects that the content of the authorization data field AUT_D indicates a valid authorization to use the debit card, stores into the non-volatile memory 60 the content of the electronic money identification data field EM_ID indicating the serial number of the debit card, the expiration date, the name of the issuing bank, the name of the card association, the security code and the name and surname of the debit card owner and reads the content of the available balance field AV_BL indicating the amount (837,63 USD) of funds available on the debit card.

At time t₇ (subsequent to t₆) the local interface 68 of the Point-of-Sale device 6 receives from the counter 7 the value of the bill amount (101,25 USD) generated by the counter 7 for the goods purchased by the user 10 and stores the value of the bill amount into the non-volatile memory 60. The computer program (running on the processor 63) compares the value of the content of the available balance field AV_BL with respect to the value of the received bill amount; in particular, the computer program compares the value (837,63 USD) of the amount of available funds with respect to the value (101,25 USD) of the bill amount generated by the counter 7 and detects that the value of the amount of available funds is greater than or equal to the value of the bill amount. Afterwards, the NFC interface 64 of the Point-of-Sale device 6 transmits to the smartphone 2 a fourth message MSG4 carrying a payment result field RES_PM having a first value equal to an high logic value to indicate a successful payment, meaning that a value equal to the bill amount will be debited on the debit card.

At time t₈ (subsequent to t₇) the smartphone 2 receives the fourth message MSG4, extracts therefrom the content of the payment result field RES_PM having a first value equal to an high logic value to indicate the successful payment and stores the content of the payment result field RES_PM into the non-volatile memory 160. Moreover, the display 102 of the smartphone 2 shows a message (see the text string in area 31 in FIG. 5E, D-10) that indicates the successful payment.

Afterwards, the user 10 may pick up the purchased goods and exit from the supermarket 30, as it is shown in FIG. 1C.

Therefore the user 10 waits at the Point-of-Sale 5 for a short time interval, because it is necessary neither to send any data to the bank server 4 nor to wait for receiving any acknowledge from the bank server 4. In fact, it is sufficient to wait for receiving a local acknowledge (i.e., the payment result field RES_PM) from the Point-of-Sale device 6 at the Point-of-Sale 5, because the bank server 4 has previously authorized the possibility to use the debit card to perform a purchase transaction during the verification phase (time interval between t₀ and t₃) and because the Point-of-Sale device 6 has subsequently authorized the purchase transaction during the payment phase (time interval between t₄ and t₈) (in particular, by receiving a valid value for the authorization data field AUT_D and comparing the value of the content of the available balance field AV_BL with respect to the value of the bill amount) storing all the data (in particular, the electronic money identification data field EM_ID and the value of the bill amount) necessary to settle the purchase transaction in the (subsequent) settlement phase.

Preferably, the fourth message MSG4 further carries a bill amount field BL_AM (indicated with a dashed line in FIG. 2A) equal to the value of the bill amount generated by the counter 7. The smartphone 2 receives the fourth message MSG4, extracts therefrom also the content of the bill amount field BL_AM and stores into the non-volatile memory 160 the content of the bill amount field BL_AM. The purchase transaction application running on the smartphone 2 reads from the non-volatile memory 160 also the content of the bill amount field BL_AM and calculates an estimation of the value of the updated available balance (i.e., amount of available funds) by subtracting the value of the bill amount field BL_AM from the value of the amount of available funds included in the content of the available balance field AV_BL, stored (at time t₃) into the non-volatile memory 160 (in the example, 837,63 USD-101,25 USD=736,38 USD). In this case, at time t₈ the display 102 of the smartphone 2 further shows a message (see area 31 in FIG. 5E, D-10) that indicates both the successful payment and the estimation of the value of the updated available balance (in the example, the estimation of the value of the updated available balance shown in the area 31 is 736,38 USD).

At time t₉ (subsequent to t₃) the settlement phase starts. The computer program running on the processor 63 of the Point-of-Sale device 6 reads from the non-volatile memory 60 the stored values of the serial number of the debit card, the expiration date, the name of the issuing bank, the name of the card association, the security code and the name and surname of the debit card owner, the value of the bill amount and the merchant identification data (as detailed below). The network interface 62 of the Point-of-Sale device 6 transmits to the bank server 4, by means of the mobile network 3, a fifth message MSG5 carrying the electronic money identification data field EM_ID indicating the serial number of the debit card, the expiration date, the name of the issuing bank, the name of the card association, the security code and the name and surname of the debit card owner stored into the non-volatile memory 60, carrying a bill amount field BL_AM equal to the value of the bill amount stored into the non-volatile memory 60 and carrying a merchant identification data field ME_ID indicating the business name and store address of the merchant (i.e., the supermarket 30) and the IBAN of the bank account of the merchant (for example, the bank account at the acquiring bank) stored into the non-volatile memory 60.

The mobile network 3 routes the fifth message MSG5 from the Point-of-Sale device 6 to the bank server 4 (see the arrow 21 in FIG. 1C). For the sake of simplicity it is supposed that the mobile network 3 routes the fifth message MSG5 unchanged, but similar considerations are applicable in case the mobile network 3 modifies the fifth message MSG5, provided that the modified fifth message received by the bank server 4 includes the electronic money identification data field EM_ID, the bill amount field BL_AM and the merchant identification data field ME_ID.

At time t₁₀ (subsequent to t₉) the bank server 4 receives from the mobile network 3 the fifth message MSG5 and extracts therefrom the content of the electronic money identification data field EM_ID, the content of the bill amount field BL_AM and the content of the merchant identification data field ME_ID.

The bank server 4 processes the content of the electronic money identification data field EM_ID, the content of the bill amount field BL_AM and the content of the merchant identification data field ME_ID received from the fifth message MSG5 and compares the content of the electronic money identification data field EM_ID with respect to the debit card identification data stored into the local (or remote) non-volatile memory of the bank server 4. In particular, the bank server 4 checks that the name and surname of the debit card owner of the received electronic money identification data field EM_ID is equal to the name and surname of the debit card owner stored into the local (or remote) non-volatile memory, checks that the expiration date of the received electronic money identification data field EM_ID is equal to the expiration date stored into the local (or remote) non-volatile memory, checks that the expiration date is subsequent to the actual date and checks that the security code of the received electronic money identification data field EM_ID is equal to the security code stored into the local (or remote) non-volatile memory.

It is supposed that all the above checks are positive.

Afterwards, the bank server 4 performs the debit of the value of the bill amount field BL_AM on the debit card identified by the content of the electronic money identification data field EM_ID received from the fifth message MSG5 and performs the credit of the value of the bill amount on the bank account identified by the content of the merchant identification data field ME_ID received from the fifth message MSG5.

At time t₁₁ (subsequent to t₁₀)) the bank server 4 transmits a sixth message MSG6 carrying a settlement result field RES_STL having an high logic value to indicate a successful settlement, meaning that the value of the bill amount field BL_AM has been debited on the debit card and has been credited on the bank account of the merchant.

The mobile network 3 routes the sixth message MSG6 from the bank server 4 to the Point-of-Sale device 6 (see the arrow 21 in FIG. 1C). For the sake of simplicity it is supposed that the mobile network 3 routes the sixth message MSG6 unchanged, but similar considerations are applicable in case the mobile network 3 modifies the sixth message MSG6, provided that the modified sixth message received by the Point-of-Sale device 6 includes the settlement result field RES_STL.

At time t₁₂ (subsequent to t₁₁) the network interface 62 of the Point-of-Sale device 6 receives from the mobile network 3 the sixth message MSG6 and the purchase transaction is settled.

Preferably, according to a variant of the first or second embodiment of the invention, at time t₂ the bank server 4 (or, more in general, the server(s) of the transaction network 4) automatically generates a random number (or an alphanumeric code), stores the random number into a local (or remote) non-volatile memory and transmits the second message MSG2 carrying a random number field RDN_NB equal to the generated random number. The generated random number is different every time the bank server 4 (or the server(s) of the transaction network 4) transmits to the smartphone 2 the second message MSG2. According to this variant of the invention, at time t₃ the smartphone 2 receives from the mobile network 3 the second message MSG2 (or a modified second message), extracts therefrom also the random number field RDN_NB and further stores into the non-volatile memory 160 a random number equal to the content of the random number field RDN_NB. Afterwards, at time t₅ the purchase transaction application running on the smartphone 2 reads from the non-volatile memory 160 also the stored value of the random number and transmits to the Point-of-Sale device 6 the third message MSG3 carrying also a random number field RDN_NB equal to the value of the random number stored into the non-volatile memory 160. At time t₆ the NFC interface 64 of the Point-of-Sale device 6 receives the third message MSG3 and extracts therefrom also the content of the random number field RDN_NB. The processor 63 of the Point-of-Sale device 6 stores into the non-volatile memory 60 also the content of the fourth field RDN_NB. At time t₉ the processor 63 of the Point-of-Sale device 6 reads from the non-volatile memory 60 the stored value of the random number and the network interface 62 of the Point-of-Sale device 6 transmits to the bank server 4, by means of the mobile network 3, the fifth message MSG5 further carrying the random number field RDN_NB equal to the random number stored into the non-volatile memory 60. The mobile network 3 routes the fifth message MSG5 from the Point-of-Sale device 6 to the bank server 4. At time t₀ the bank server 4 receives from the mobile network 3 the fifth message MSG5 (or a modified fifth message) and extracts therefrom also the content of the random number field RDN_NB indicating the random number. The bank server 4 reads the value of the random number stored (at time t₂) into the local (or remote) non-volatile memory of the bank server 4 and compares it with respect to the value of the received random number field RDN_NB of the fifth message MSG5. In case the value of the content of the received random number field RDN_NB is equal to the value of the stored random number, the operation of the electronic system 1 continues as previously described (time instants t₁₁, t₁₂) and the purchase transaction (during the payment phase) is completed successfully. In case the value of the content of the received random number field RDN_NB is different from the value of the stored random number, the debit card is immediately blocked and at time t₁₁ the bank server 4 transmits the sixth message MSG6 including the settlement result field RES_STL having a second value equal to a low logic value to indicate an unsuccessful settlement, meaning that it is not possible to debit the value of the bill amount field BL_AM on the debit card and that it is not possible to credit the value of the bill amount field BL_AM on the bank account of the merchant. Alternatively, in order to safeguard the merchant, the value of the bill amount field BL_AM is credited on the bank account of the merchant and it is up to the bank 4 to take all the actions necessary to retrieve the money from the user 10.

Therefore the generation of a random number (or alphanumeric code) and its inclusion in the messages as an additional data field have the advantage of increasing the security of the electronic system 1, because it is possible to quickly detect a deceitful use (such as, for example, a jailbreak) of the purchase transaction application running on the smartphone 2.

The operation of the electronic system 1 when performing a purchase transaction according to the second embodiment (see FIG. 2B) is equal to the one described for the first embodiment during the verification phase (from time t₀ to t₃), the shopping phase (from time t₃ to t₄) and the settlement phase (from time t₉ to t₁₂), whereas it differs during the payment phase comprised between time t₅′ and t₈′.

In particular, at time t₅′ the user 10 leans the smartphone 2 on the pad of the Point-of-Sale device 6, as it is shown in FIG. 1B. The local interface 68 of the Point-of-Sale device 6 receives from the counter 7 the value of a bill amount generated by the counter 7 for the goods purchased by the user 10 and stores the value of the generated bill amount into the non-volatile memory 60. As soon as the Point-of-Sale device 6 detects that the smartphone 2 is leaned on the pad, the NFC interface 64 of the Point-of-Sale device 6 transmits to the smartphone 2 a message MSG3′ according to a near field communication protocol (such as Bluetooth®), wherein the message MSG3′ carries a bill amount field BL_AM equal to the value of the bill amount generated by the counter 7 for the goods purchased by the user 10.

At time t₆′ (subsequent to t₅′) the NFC interface 164 of the smartphone 2 receives the message MSG3′ and extracts therefrom the content of the bill amount field BL_AM. The purchase transaction application running on the processor 163 of the smartphone 2 compares the value of the content of the available balance field AV_BL stored into the memory 160 with respect to the received value of the bill amount field BL_AM and detects (as it is assumed) that the value of the content of the available balance field AV_BL is greater than or equal to the value of the bill amount field BL_AM.

At time t₇′ (subsequent to t₆′) the smartphone 2 transmits to the Point-of-Sale device 6 a message MSG4′ according to the near field communication protocol (Bluetooth®), wherein the message MSG4′ carries an electronic money identification data field EM_ID indicating the serial number of the debit card, the expiration date, the name of the issuing bank, the name of the card association, the security code and the name and surname of the debit card owner and wherein the message MSG4′ carries an authorization data field AUT_D′ having a first value equal to an high logic number indicating a valid authorization for the debit card, meaning that the amount of the funds available on the debit card is greater than or equal to the bill amount generated by the counter 7.

Therefore in the second embodiment the comparison between the bill amount generated by the counter 7 and the amount of available funds (included in the available balance field AV_BL) is performed by the purchase transaction application running on the processor 163 of the smartphone 2, whereas in the first embodiment the comparison is performed by the computer program running on the processor 63 of the Point-of-Sale device 6. Accordingly, in the second embodiment the purchase transaction application running on the smartphone 2 does not transmit to the Point-of-Sale device 6 an available balance field AV_BL for the debit card, but it only transmits an authorization data field AUT_D′ indicating that the amount of the funds available on the debit card is greater than or equal to the bill amount generated by the counter 7.

At time t₈′ (subsequent to t₇′) the NFC interface 64 of the Point-of-Sale device 6 receives the message MSG4′ and extracts therefrom the content of the electronic money identification data field EM_ID and the content of the authorization data field AUT_D′. The computer program running on the processor 63 of the Point-of-Sale device 6 processes the content of the electronic money identification data field EM_ID and processes the content of the authorization data field AUT_D′ received from the message MSG4′. In particular, the Point-of-Sale device 6 detects that the authorization data field AUT_D′ indicates a valid authorization for the debit card and stores into the non-volatile memory 60 the content of the electronic money identification data field EM_ID indicating the serial number of the debit card, the expiration date, the name of the issuing bank, the name of the card association, the security code and the name and surname of the debit card owner.

Afterwards, at time t₈″ the NFC interface 64 of the Point-of-Sale device 6 transmits to the smartphone 2 a message MSG4″ carrying a payment result field RES_PM having a first value equal to an high logic number to indicate the successful payment, meaning that a value equal to the value of the content of the bill amount field BL_AM will be debited on the debit card.

The operation from time t₉ onward of the second embodiment continues as indicated above from time t₉ onward of the first embodiment.

According to another variant of the first or the second embodiment (see FIG. 2C), the verification, shopping and payment phase are equal to the ones in the first and the second embodiments, whereas the settlement phase is different due to the fact that the Point-of-Sale device 6 operates in batch mode. In particular, at time t₉′ the Point-of-Sale device 6 transmits to the bank server 4, by means of the mobile network 3, a message MSG5′-a carrying the electronic money identification data field EM_ID-a, the merchant identification data field ME_ID and a reservation amount field RES_BL_AM-a indicating a request to reserve on the debit card of the user 10 an amount of funds equal to the value of the bill amount stored into the non-volatile memory 60 (and generated by the counter 7). At time t₁₀′ (subsequent to t₉′) the bank server 4 receives from the mobile network 3 the message MSG5′-a (or a modified version) and extracts therefrom the content of the electronic money identification data field EM_ID-a, the content of the merchant identification data field ME_ID and the content of the reservation amount field RES_BL_AM-a. The bank server 4 processes the content of the received message MSG5′ and, in particular, it reserves the value of the bill amount on the debit card identified by content of the electronic money identification data field EM_ID-a. At time t₁₁′ (subsequent to t₁₀′) the bank server 4 transmits to the Point-of-Sale device 6, by means of the mobile network 3, a message MSG6′-a carrying a reservation result field RES_RE having a first value (for example, an high logic value) to indicate a successful reservation of the value of the bill amount value, or having a second value (for example, a low logic value) to indicate an unsuccessful reservation of the value of the bill amount value.

Afterwards, a plurality of users, holding a plurality of smartphones (such as the smartphone 2), shops for goods from the supermarket 30, reaches the Point-of-Sale 5 and performs the payment phase as described above for the user 10. Accordingly, the Point-of-Sale device 6 transmits, by means of the mobile network 3, a plurality of messages MSG5′-b, MSG5′-c, . . . similar to the message MSG5′-a, each one carrying a reservation amount field (RES_BL_AM-b, RES_BL_AM-c, . . . ) indicating a request to reserve from the debit (or credit) card of the corresponding user (among the plurality of users) an amount of funds equal to the value of the bill amount value generated by the counter 7 for the goods purchased by the corresponding user (among the plurality of users); the bank server 4, in turn, transmits to the Point-of-Sale device 6, by means of the mobile network 3, a plurality of messages MSG6′-b, MSG6′-c, . . . similar to the message MSG6′-a, each one carrying a reservation result field RES_RE (in particular, each one having a first value, for example, equal to an high logic number to indicate a successful reservation of the value of the bill amount value) (for the sake of simplicity, FIG. 2C shows only two messages, a MSG5′-a and a MSG5′-b from the Point-of-Sale device 6 to the bank server 4 and two corresponding messages, a MSG6′-a and a MSG6′-b from the bank server 4 to the Point-of-Sale device 6).

According to a specific criterion (for example, after a defined number of users, or after a defined period of time, for example, at the end of a working day), at time t₉′″ the Point-of-Sale device 6 transmits to the bank server 4, by means of the mobile network 3, a message MSG5″ carrying a plurality of electronic money identification data fields EM_ID-a, EM_ID-b, . . . each one identifying the debit (or credit) card of the corresponding user (among the plurality of users), carrying a plurality of values of the bill amounts fields BL_AM-a, BL_AM-b, . . . each one equal to the value generated by the counter 7 for the goods purchased by the corresponding user (among the plurality of users) and carrying the merchant identification data ME_ID. At time t₁₁″ the bank server 4 transmits to the Point-of-Sale device 6 a message MSG6″ carrying a batch settlement result field RES_BT having a plurality of first values (for example, high logic values) to indicate a successful settlement for each user (among the plurality of users), meaning that the values of the bill amounts fields BL_AM-a, BL_AM-b, . . . have been debited on the debit (or credit) card of the corresponding user (among the plurality of users) respectively and that the algebraic sum of the values of the bill amounts fields BL_AM-a+BL_AM-b+ . . . has been credited on the bank account of the merchant.

Therefore, in the variant of the first or second embodiment described above, the Point-of-Sale device 6, instead of transmitting to the bank server 4 (or, more in general, to the server(s) of the transaction network 4) a message carrying a bill amount field BL_AM, it transmits to the bank server 4 (or, more in general, to the server(s) of the transaction network 4) a message carrying a reservation amount field RES_BL_AM-a and then waits for completing, for example, a set of purchase transactions (i.e., successful confirmations during the payment phase) before transmitting to the bank server 4 (or, more in general, to the server(s) of the transaction server 4) only one message (i.e., MSG5″) to complete the settlement phase and thus to actually debit the value of each bill amount field BL_AM-a, BL_AM-b, . . . on the debit (or credit) card of the corresponding user (among the plurality of users) and to actually credit the algebraic sum of the values of the bill amount fields (BL_AM-a, BL_AM-b, . . . ) on the bank account of the merchant.

Preferably, the second message MSG2 further includes another field (or the available balance field AV_BL includes, in addition to the amount of available funds) a time and date of reference for that amount of available funds indicating that a specific amount of funds is available at a specific time and date (for example, 1.000,00 USD at 12:00 AM on 21 Jul. 2012), as it happens whenever a customer enquires for a balance statement of the bank account.

The time and date could be meaningful data for security reasons because the Point-of-Sale device 6 may require to have the amount of available funds updated at a time and date of reference that does not differ from the current time and date (i.e. the time and date when the purchase transaction is performed during the payment phase) by more than a pre-set timing (for example, 2 minutes, according to a market practice) in order to allow the smartphone 2 to (try to) perform a purchase transaction. Hence, in the first embodiment the computer program running on the processor 63 of the Point-of-Sale device 6 (or in the second embodiment the purchase transaction running on the processor 163 of the smartphone 2) not only compares the amount of the available funds with the bill amount, but also checks that the time and date of reference for the amount of available funds does not differ from the current time and date by more than the pre-set timing.

The operation of the electronic system 1 when performing a purchase transaction according, for example, to the first embodiment (see FIG. 2A) is equal to the one described above during the shopping phase (from time t₃ to t₄) and the settlement phase (from time t₉ to t₁₂) and it has some differences during the verification phase (from time t₀ to t₃) and the payment phase (from time t₅ to t₉).

At to and t₁ (subsequent to t₀) the operation is as described above.

At time t₂ (subsequent to t₁) the bank server 4 reads from the local (or remote) non-volatile memory the amount of funds available at the current time and date on the debit card having the serial number corresponding to the serial number extracted from the electronic money identification data field EM_ID and transmits the second message MSG2 carrying an authorization data field AUT_D indicating a valid authorization for the debit card and carrying an available balance field AV_BL indicating the amount of funds available on the debit card at the current time and date (in the example, 837,63 USD, 12:30 AM, 21 Jul. 2012).

At time t₃ (subsequent to t₂) the smartphone 2 receives from the mobile network 3 the second message MSG2, it extracts therefrom the content of the authorization data field AUT_D and the content of the available balance field AV_BL and it stores into the non-volatile memory 160 the content of the authorization data field AUT_D indicating the valid authorization for the debit card and the content of the available balance field AV_BL indicating the amount (837,63 USD) of funds available on the debit card at a specific time and date (21 Jul. 2012, 12:30 AM) (that should not differ from the current time (and date) since the response time is almost immediate).

At t₄ (subsequent to t₃) the operation is as described above.

At time t₅ the user 10 leans the smartphone 2 on the pad of the Point-of-Sale device 6, as it is shown in FIG. 1B. The smartphone 2 communicates with the Point-of-Sale device 6 using a near field communication protocol, such as Bluetooth®. In particular, the purchase transaction application running on the smartphone 2 reads from the non-volatile memory 160 the stored content of the authorization data field AUT_D (in the example, an high logic value) indicating a valid authorization for the debit card and the stored content of the available balance field AV_BL (in the example, a value and a time and date) indicating the amount (837,63 USD) of the funds available on the debit card at a specific time and date (12:30 AM, 21 Jul. 2012) (that likely differs from the current time (and date), because, for example, the shopping phase takes some time). Afterwards, the smartphone 2 transmits to the Point-of-Sale device 6 a third message MSG3 according to the near field communication protocol (Bluetooth®), wherein the third message MSG3 carries the electronic money identification data field EM_ID indicating the serial number of the debit card, the expiration date, the name of the issuing bank, the name of the card association, the security code and the name and surname of the debit card owner, carries the authorization data field AUT_D including the first value with an high logic value indicating a valid authorization for the debit card and carries the available balance field AV_BL including the amount of funds available on the debit card and the specific time and date of reference (in the example, 837,63 USD, 12:30 AM, 21 Jul. 2012).

At time t₆ (subsequent to t₅) the NFC interface 64 of the Point-of-Sale device 6 receives the third message MSG3 and extracts therefrom the content of the electronic money identification data field EM_ID, the content of the authorization data field AUT_D and the content of the available balance field AV_BL. The computer program running on (the processor 63 of) the Point-of-Sale device 6 processes the content of the electronic money identification data field EM_ID, the content of the authorization data field AUT_D and the content of the available balance field AV_BL received from the third message MSG3. In particular, the Point-of-Sale device 6 detects that the content of the authorization data field AUT_D indicates a valid authorization for the debit card, it stores into the non-volatile memory 60 the content of the electronic money identification data field EM_ID indicating the serial number of the debit card, the expiration date, the name of the issuing bank, the name of the card association, the security code and the name and surname of the debit card owner and it reads the content of the available balance field AV_BL indicating the amount (837,63 USD) of funds available on the debit card at a specific time and date (12:30 AM, 21 Jul. 2012).

At time t₇ (subsequent to t₆) the local interface 68 of the Point-of-Sale device 6 receives from the counter 7 the value of a bill amount (101,25 USD) generated by the counter 7 for the goods purchased by the user 10 and stores the value of the bill amount into the non-volatile memory 60. The computer program running on (the processor 63) compares the content of the available balance field AV_BL with respect to the value of the (received) bill amount and the current time and date; in particular, the computer program compares the value (837,63 USD) of the amount of available funds with respect to the value (101,25 USD) of the bill amount generated by the counter 7, compares the current time and date (12:31 AM, 21 Jul. 2012) with the time and date of reference for the amount of available funds (12:30 AM, 21 Jul. 2012) and detects that the value of the amount of available funds is greater than or equal to the value of the bill amount and that the time and date of reference for the amount of available funds and the current time and date does not differ by more than a pre-set timing (for example, 2 minutes). Afterwards, the NFC interface 64 of the Point-of-Sale device 6 transmits to the smartphone 2 a fourth message MSG4 carrying a payment result field RES_PM including a first value with an high logic value (to indicate that the value of the amount of available funds is greater than or equal to the value of the bill amount) and a second value with an high logic value (to indicate that time and date of reference for the amount of available funds and the current time and date do not differ by more than a pre-set timing) that indicate the successful payment, meaning that a value equal to the bill amount will be debited on the debit card.

At time t₈ (subsequent to t₇) the smartphone 2 receives the fourth message MSG4, it extracts therefrom the content of the payment result field RES_PM including a first value with an high logic value and a second value with an high logic value to indicate the successful payment and it stores into the non-volatile memory 160 the content of the payment result field RES_PM.

From time t₉ onward the operation continues as described above.

Preferably—and in particular in case the second message MSG2 includes both the amount of available funds and the time and date of reference for that amount of available funds—the purchase transaction application running on the mobile electronic device 2, once the verification phase has been completed at least one time since the user 10 has run the purchase application (i.e., the mobile electronic device 2 has sent the first message MSG1 and the transaction network has sent back the second message MSG2), automatically transmits to the transaction network 4, at defined time instants (for example, periodically, such as every 1 minute), a message MSG1′ (MSG1″, MSG1′″, . . . ); the mobile electronic device 2 automatically receives from the transaction network 4 a corresponding message MSG2′ (MSG2″, MSG2′″, . . . ) carrying the same value of the authorization data field AUT_D included in the previous second message MSG2 and an available balance field AV_BL indicating the amount of funds available on the electronic money at the updated current time and date, so that the amount of available funds and the time and date of reference are automatically updated at defined time instants. The value of the defined time instants can be configured by the user 10 of the mobile electronic device 2.

Preferably—and in particular in case the second message MSG2 includes both the amount of available funds and the time and date of reference for that amount of available funds—the purchase transaction application running on the mobile electronic device 2, once the verification phase has been completed at least one time since the user 10 has run the purchase application (i.e., the mobile electronic device 2 has sent the first message MSG1 and the transaction network has sent back the second message MSG2), may allow the user to manually transmit (i.e., by touching on the display 102 an icon identified by a text string) to the transaction network 4 at any time one (or more) messages MSG1′ (MSG1″, MSG1′″, . . . ); the mobile electronic device 2 receives in response from the transaction network 4 one (or more) corresponding messages MSG2′ (MSG2″, MSG2′″, . . . ) carrying the same value of the authorization data field AUT_D included in the previous second message MSG2 and carrying and an available balance field AV_BL indicating the amount of funds available on the electronic money at the updated current time and date, so that the amount of available funds and the time and date of reference are automatically updated at defined time instants.

Preferably—and in particular in case the second message MSG2 includes both the amount of available funds and the time and date of reference for that amount of available funds—the purchase transaction application running on the mobile electronic device 2, once the verification phase has been completed at least one time since the user 10 has run the purchase application (i.e., the mobile electronic device 2 has sent the first message MSG1 and the transaction network has sent back the second message MSG2), may be prompted either by the Point-of-Sale device 6 (in case it detects, during the payment phase according to the first embodiment, that the current time and date and the time and date of reference for the amount of available funds differ by more than a pre-set timing), or by the mobile electronic device 2 (in case it detects, during the payment phase according to the second embodiment, that the current time and date and the time and date of reference for the amount of available funds differ by more than a pre-set timing) to automatically transmit to the transaction network 4 a message MSG1′; the mobile electronic device 2 automatically receives from the transaction network 4 a message MSG2′ carrying the same value of the authorization data field AUT_D included in the previous second message MSG2 and an available balance field AV_BL indicating the amount of funds available on the electronic money at the updated current time and date, so that the amount of available funds and the time and date of reference are updated, should it be necessary, during the verification phase.

Preferably—and in particular in case the second message MSG2 includes both the amount of available funds and the time and date of reference for that amount of available funds—the purchase transaction application running on the mobile electronic device 2 may update, according to the procedures indicated above (i.e., “automatically at defined time instants”, “manually at any time” and “automatically when prompted”), also the value of the authorization data field AUT_D, as well as the values of other data fields if included (for example, the random number field RDN_NB) in the first message MSG1 and in the second message MSG2.

Preferably, the purchase transaction application may include a number of useful utility features, such as for example:
the possibility for the user 10 to set-up a security password required to run the purchase transaction application;
the possibility to automatically add a tip and/or a service charge (a fixed dollar amount and/or a specific percentage of the transaction value, etc.) to the value of the bill amount;
the possibility to recognize, by means of GPS or RFID tags/Bluetooth communication at store entrance, that the user 10 has entered a store and thus to automatically run the purchase transaction application (i.e. without the user 10 touching the icon shown on display 102);
the possibility to provide for alternative means (to a virtual keyboard shown on display 102) for inputting data (for example, login password), such as on screen fingerprint recognition and/or voice recognition, etc.

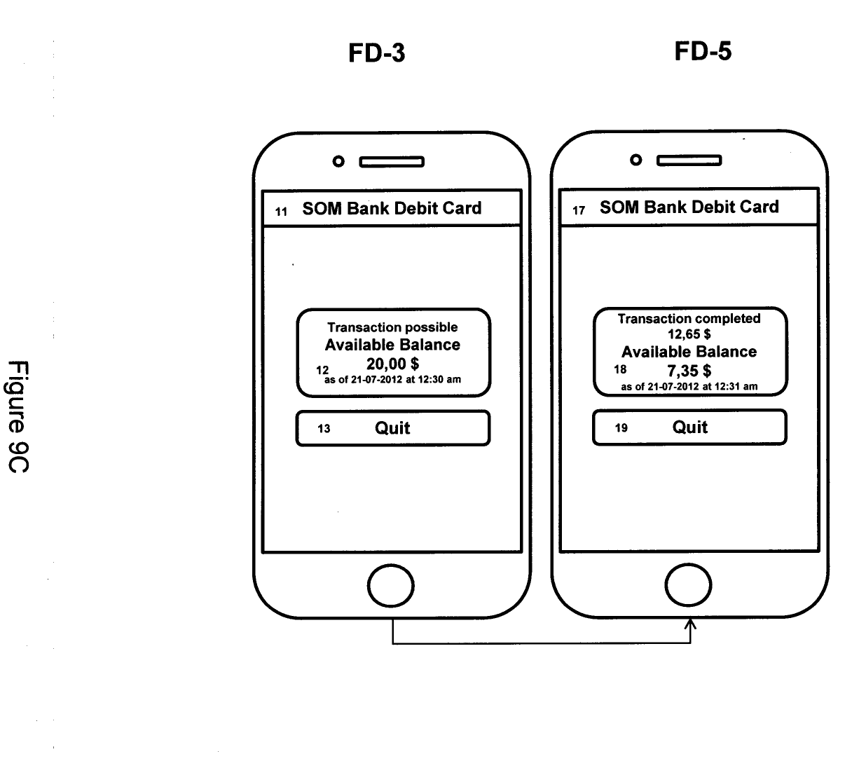

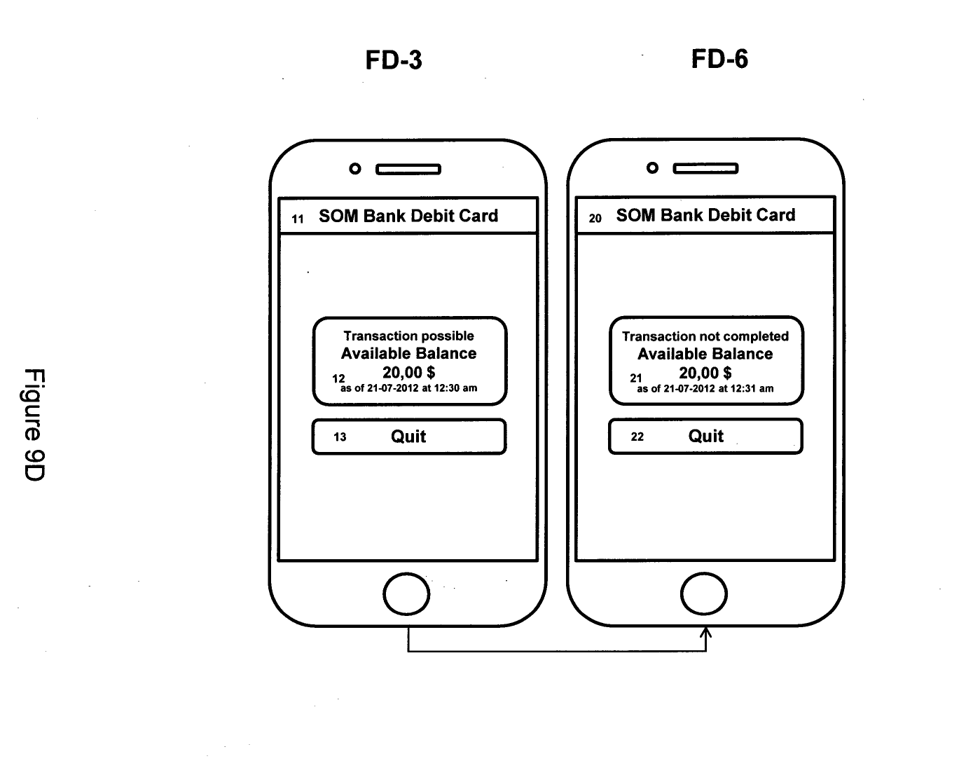

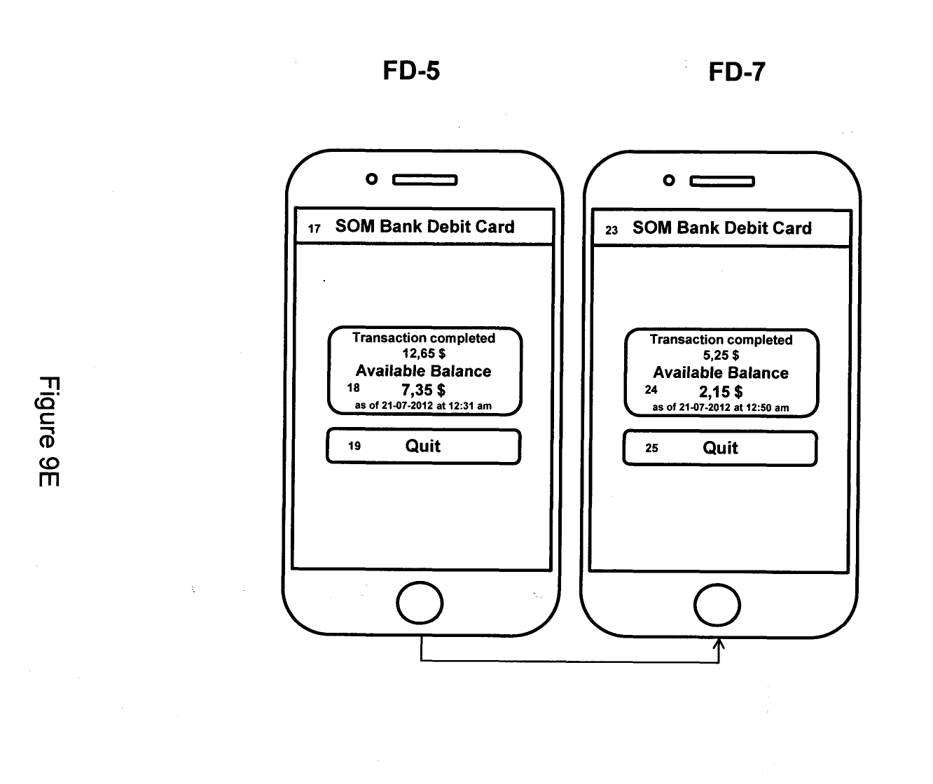

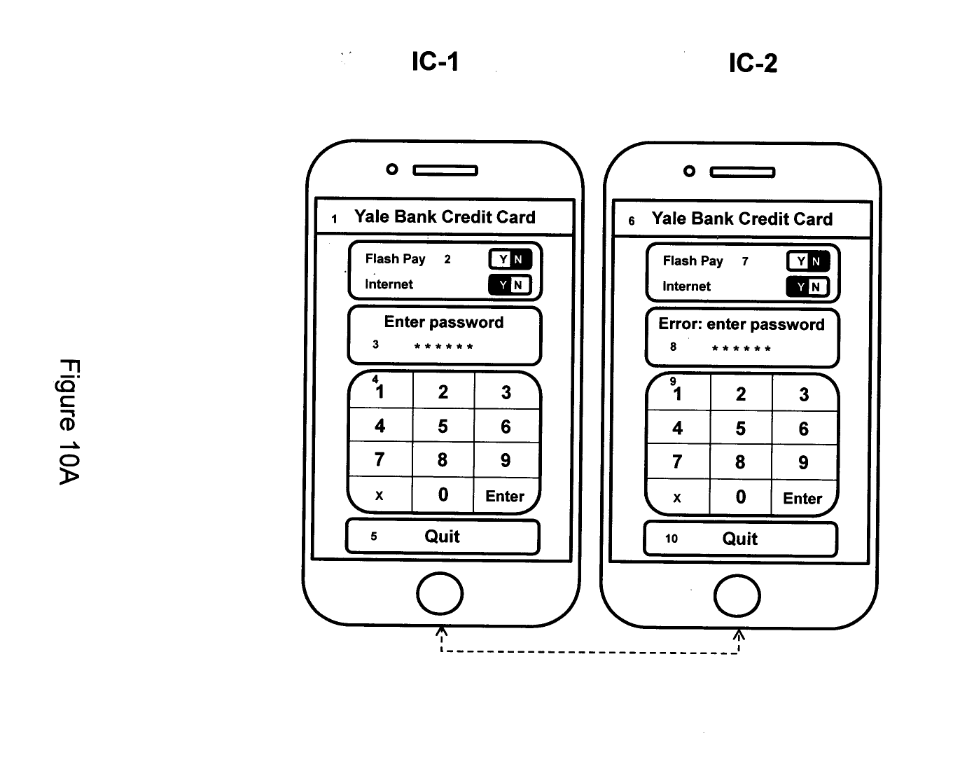

Advantageously, the purchase transaction application may include a “Flash Pay” feature for performing a purchase transaction below a small threshold value per day and/or per purchase transaction (for example, 30,00 USD), that activates a procedure “lighter” than the “standard” one described above (see FIGS. 9A-9E).

For example, in case the Flash Pay feature is enabled by the user 10, the purchase transaction application foregoes the verification phase, meaning that the mobile electronic device 2 does not transmit the first message MSG1 to the transaction network 4 and, in turn, the transaction network does not transmit to the mobile electronic device 2 the second message MSG2. In this case the contents of the authorization data field AUT_D and of the available balance field AV_BL carried by the third message MSG3 (for example, in the first embodiment) indicate a valid authorization for the electronic money and a value of the amount of the available funds equal to the threshold value respectively (for example, 30,00 USD, or the residual available amount, calculated by the mobile electronic device 2, in case the threshold value is set to comprise one or more daily transactions and the user 10 has already performed other purchase transaction during the day using the Flash Pay features). The payment phase and the settlement phase continue as indicated for the “standard” procedure.

The Flash Pay feature of the purchase transaction application embeds the risk that the electronic money used to perform the purchase transaction does not have sufficient available funds to pay for the purchase transaction approved by the Point-of-Sale device 6; such risk is not borne by the merchant but by the transaction network 4 (i.e., the issuing bank) that is willing to take the risk given that the dollar amount of the purchase transaction is small and that the card may be quickly blocked as soon as the transaction network 4 realizes that the electronic money does not have enough available funds (for example, during the settlement phase).

The Flash Pay feature of the purchase transaction application may also include some utility features and/or require some procedures to be followed by the user 10 to detect/avoid a deceitful use (for example, such as a jailbreak) of the purchase transaction application. For example, the purchase transaction application may require the user 10 to run at least once a day the purchase transaction application according to the “standard” procedure (described above) so that the verification phase may take place, thus updating, based on the data carried on the message(s) transmitted by the transaction network 4, the authorization data field AUT_D and the available data field AV_BL that, if negative or below the threshold value, prevents (also) the Flash Pay features from being used by the user 10.

Advantageously, the user 10 may have one or more available payment modes, for example, debit card, credit card with a limited spending ceiling, credit card with an unlimited spending ceiling, pre-paid card and bank transfer; in addition, the user 10 may have one or more cards available for any one of the available payment modes.

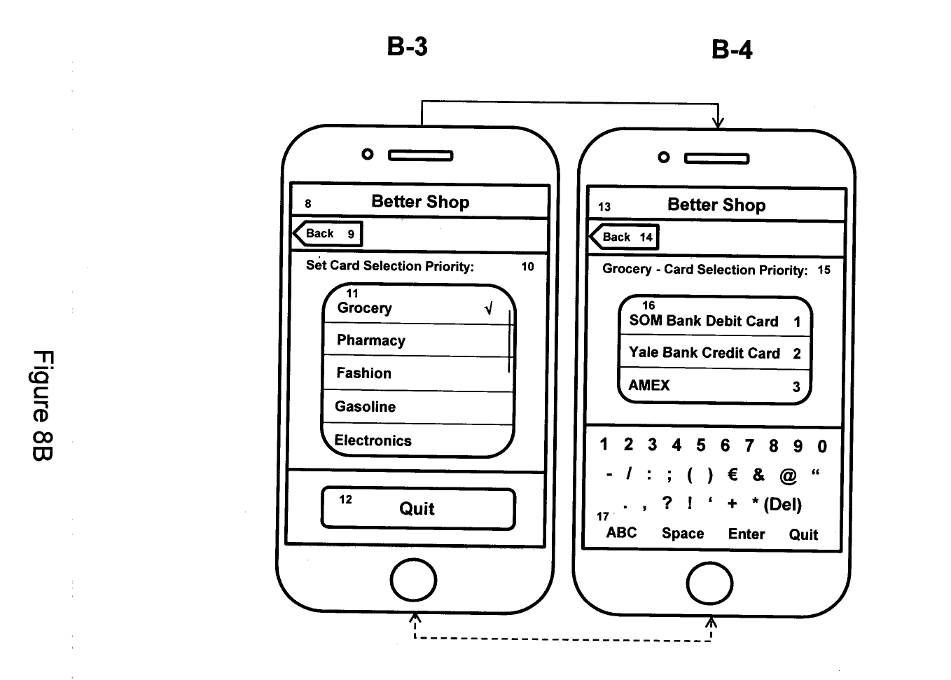

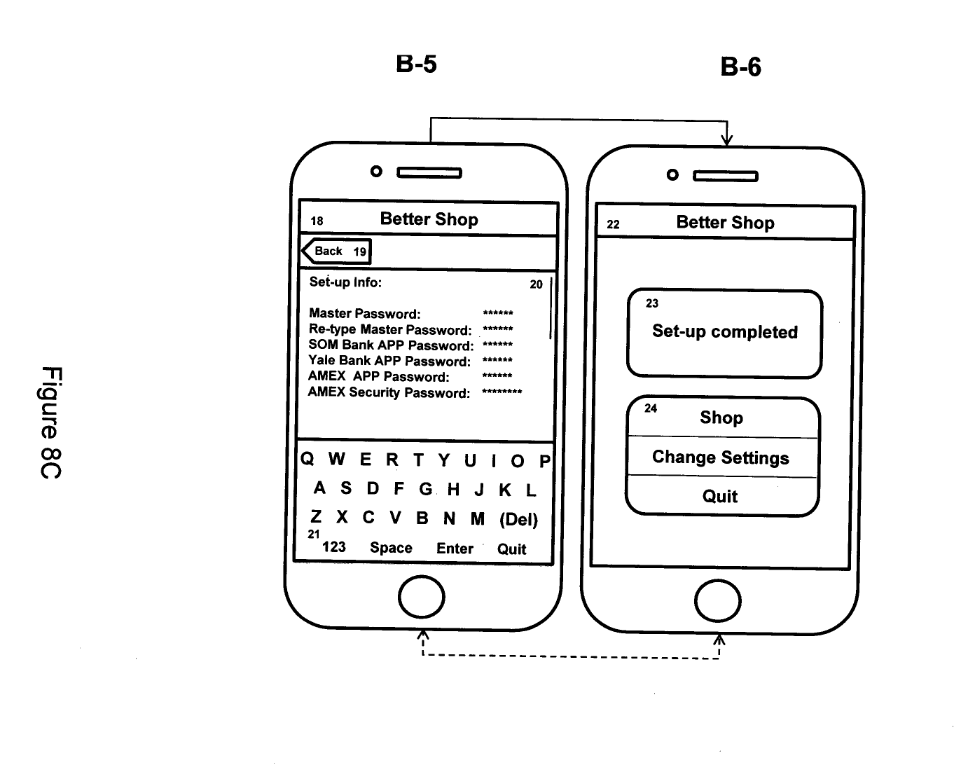

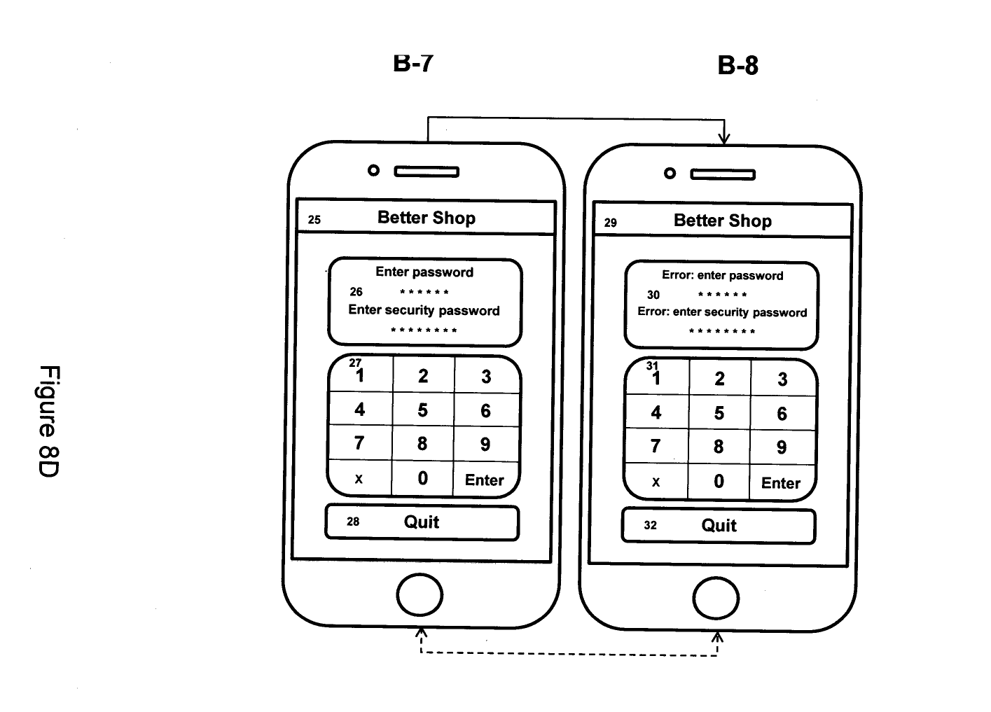

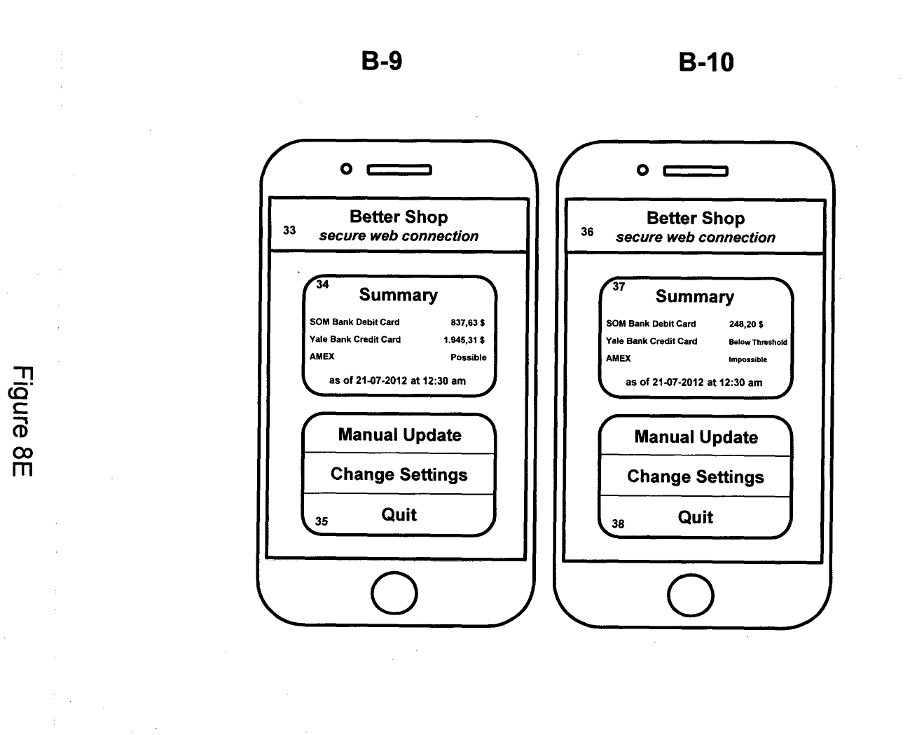

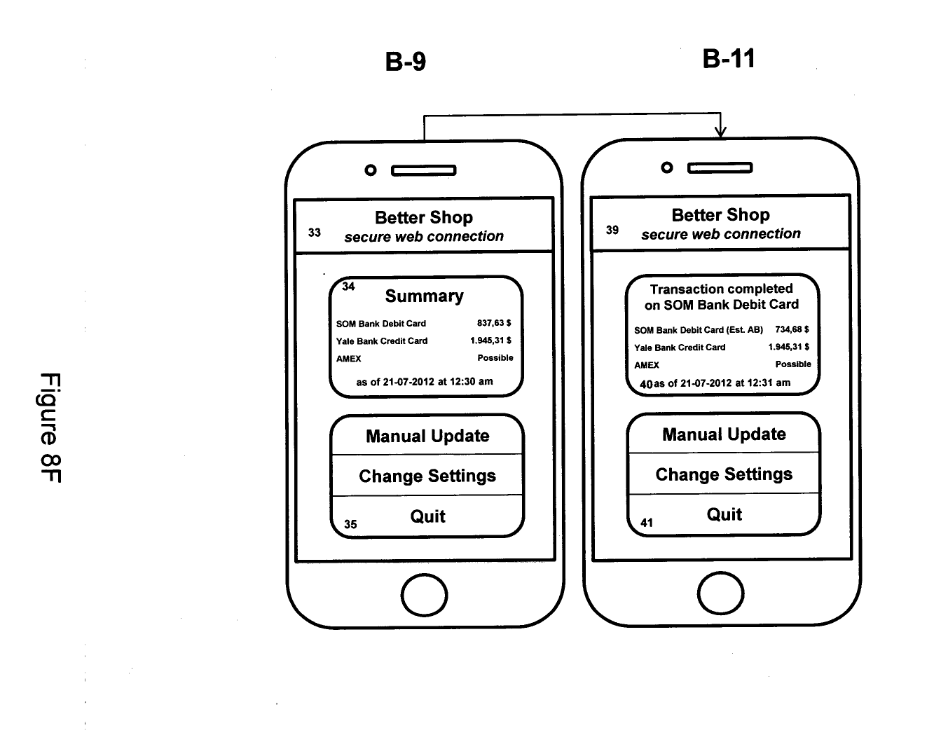

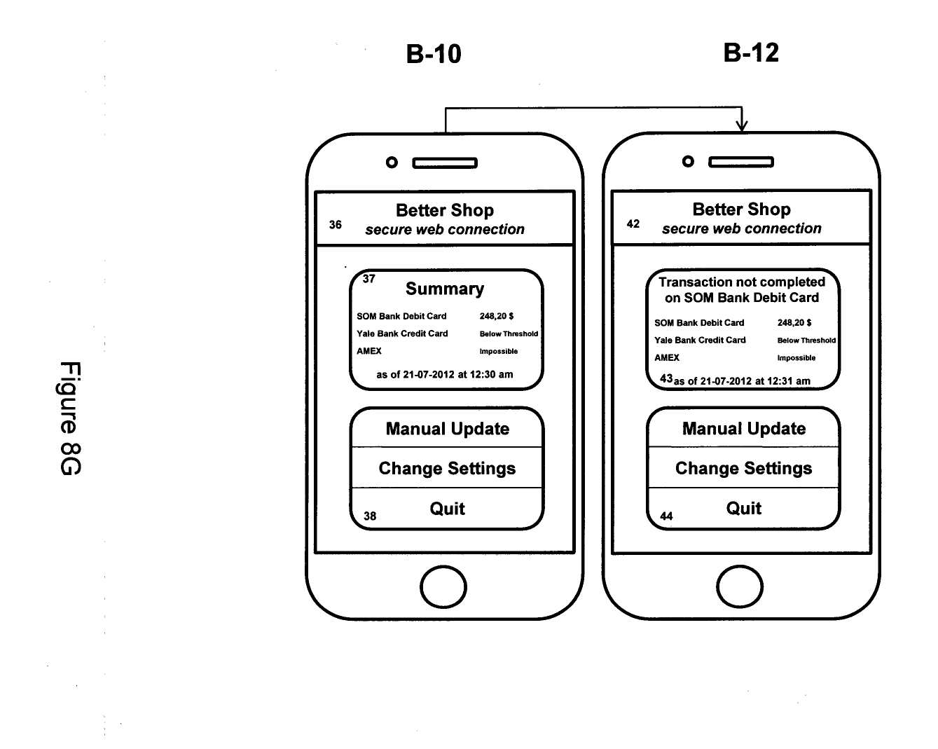

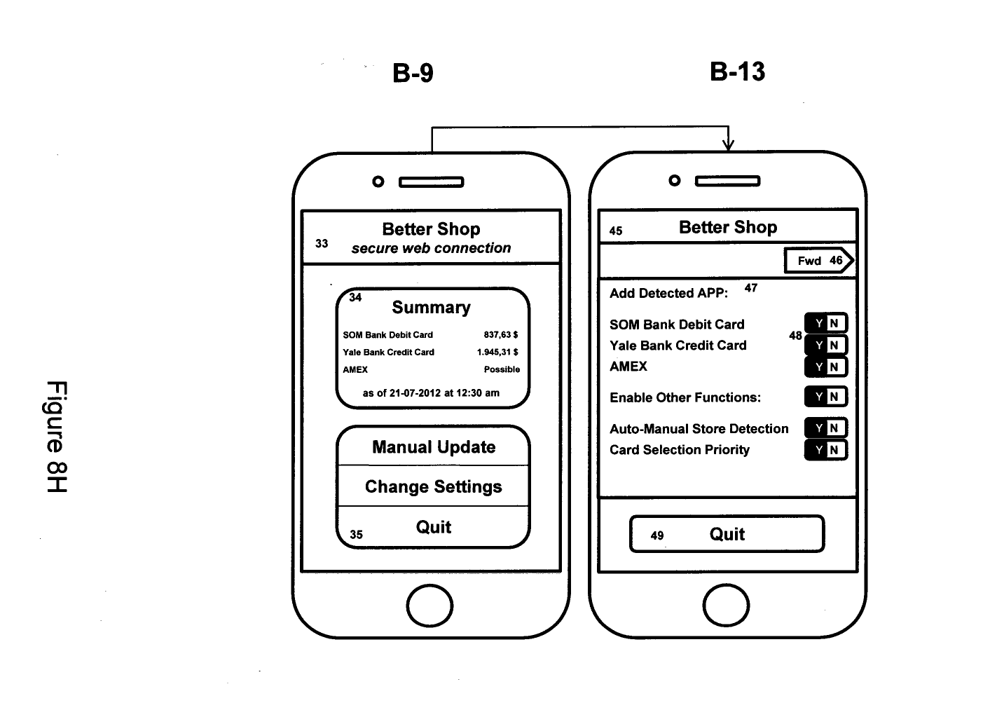

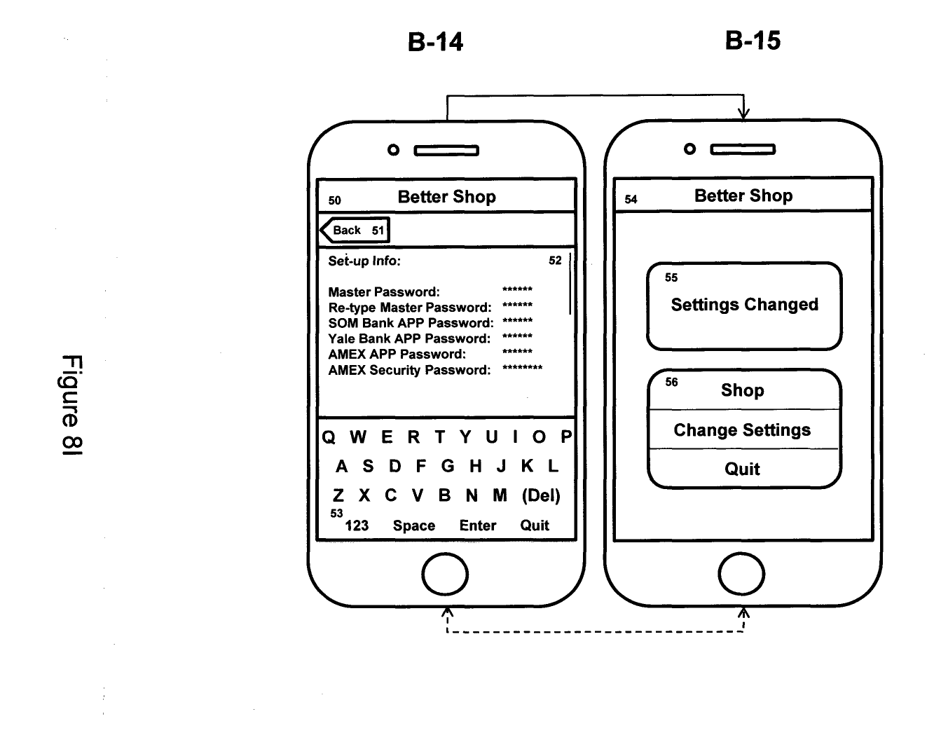

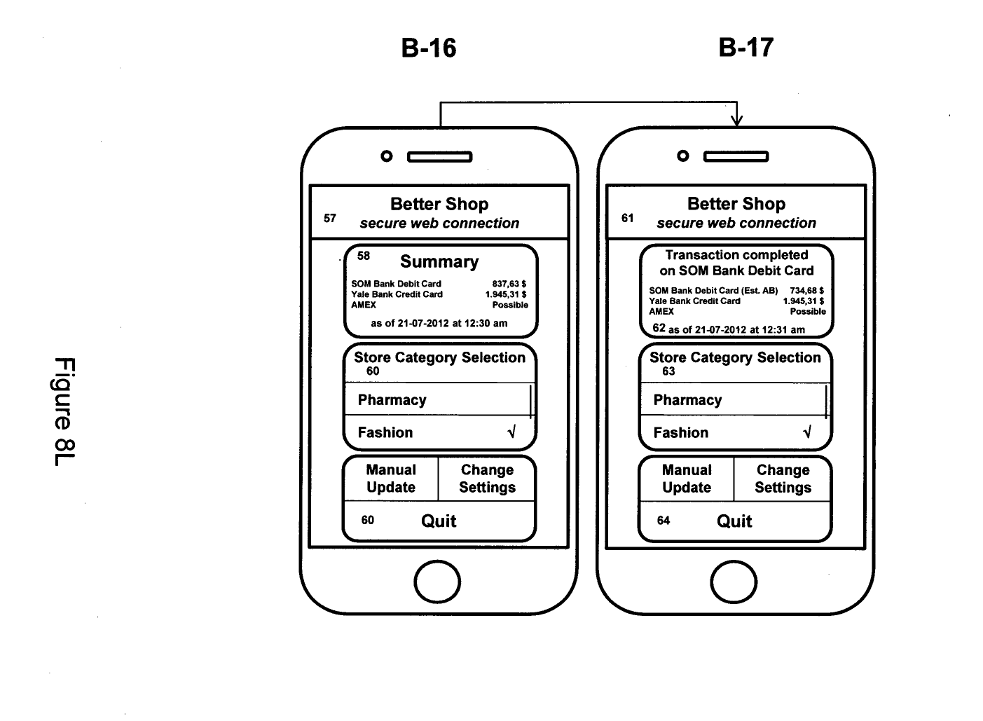

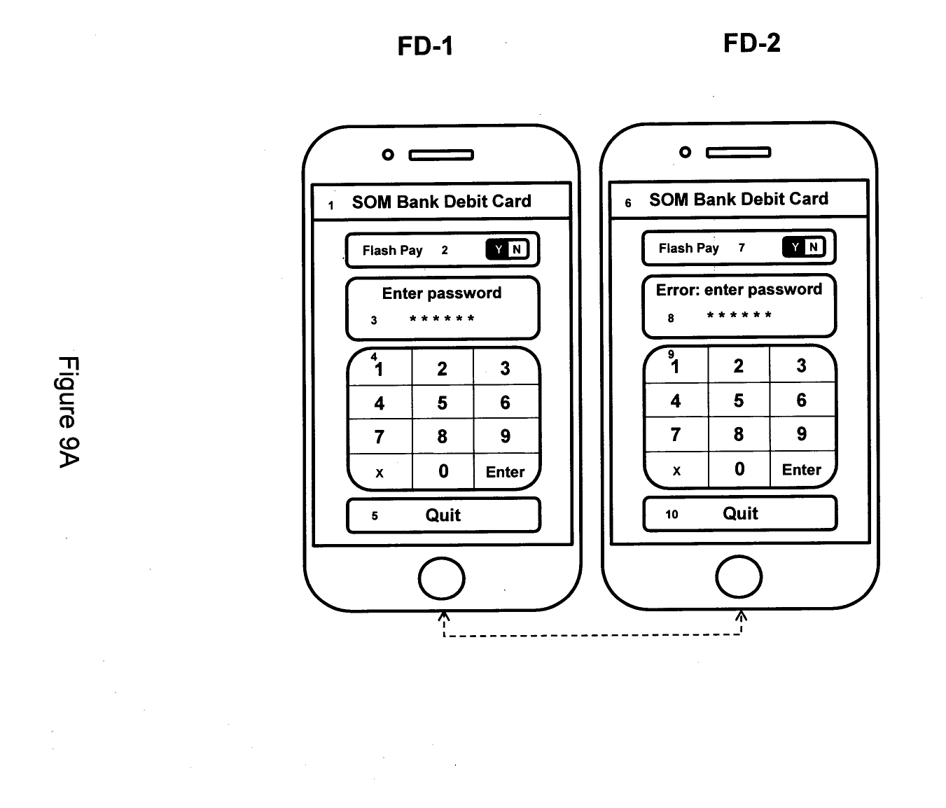

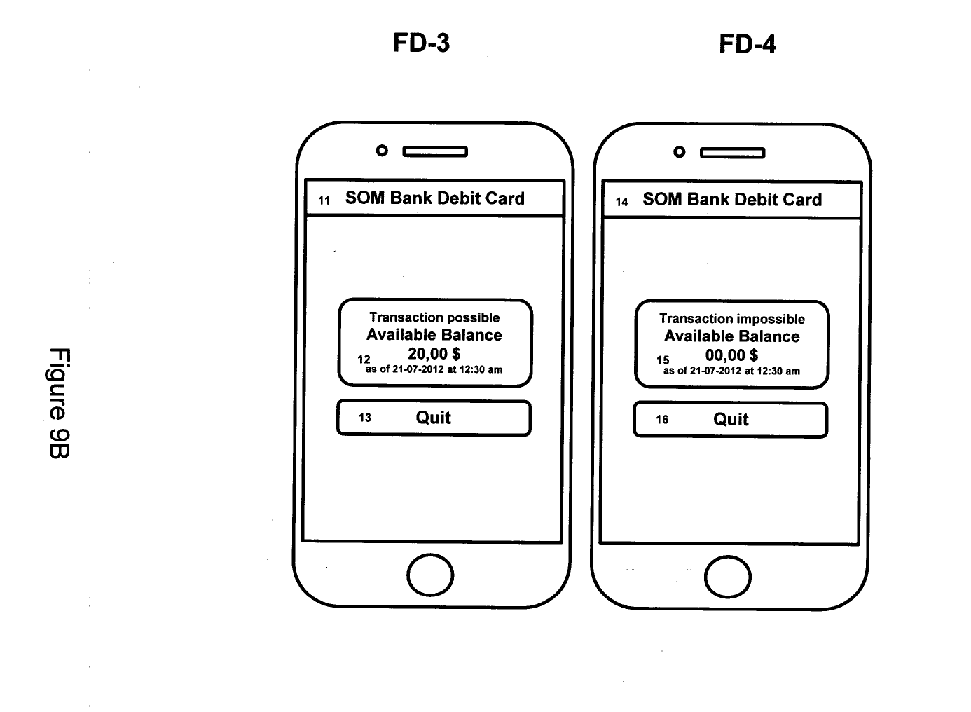

Therefore the mobile electronic device 2 may include a plurality of purchase transaction applications, each one associated with one (and only one) card (or payment mode, in case only one card is available for that payment mode) available to the user 10. The display 102 of the mobile electronic device 2 shows a plurality of icons identified by text strings that are associated with the plurality of purchase transaction applications, as it is shown in area 5 of FIG. 8A, B-2 or in area 16 of FIG. 8B, B-4.

Advantageously, the payment mode (debit card, credit card with a limited spending ceiling, credit card with an unlimited spending ceiling, pre-paid card and bank transfer) and/or the specific debit or credit card in case one or more cards are available for any available payment mode, used to actually perform a purchase transaction may be manually selected by the user 10 (by running the purchase transaction application associated with the chosen card/payment mode) or may be automatically selected by a “Better Shop” application that simultaneously runs on (the processor 163 of) the mobile electronic device 2 all the associated (i.e., associated to the Better Shop application) purchase applications and then prioritizes their selection according to different criteria, such as, for example:
the debit/credit card (or payment mode, in case only one card is available for the corresponding payment mode) having the greatest amount of funds available;
the one or more debit/credit cards (or payment modes, in case only one card is available for the corresponding payment mode) having the available balance greater than or equal to the bill amount;
one or more parameters defined by the user 10, such as, for example, the category of the purchased goods or services, the bill amount, etc., each one being associated with one or more debit/credit cards (or payment modes, in case only one card is available for the corresponding payment mode) according to a priority order.

Preferably—in case of a plurality of the purchase applications included in the mobile electronic device 2—the purchase transactions applications may be integrated into a single purchase transaction application, which, in turn, is associated with all the debit/credit cards (or payment modes, in case only one card is available for the corresponding payment mode) available to the user 10.

Therefore the user 10 runs the (single) purchase transaction application and manually selects the debit/credit card (or payment mode, in case only one card is available for the corresponding payment mode) elected to perform the purchase transaction according to procedure described above with respect to the first and second embodiments (and/or their variants).

Preferably—in case there is a plurality of the purchase transactions applications included in the mobile electronic device 2 and in case such purchase transaction applications are also integrated into a single purchase transaction application—the Better Shop application may be integrated as well into that purchase transaction application, thus becoming an embedded feature that can be enabled or disabled by the user 10.

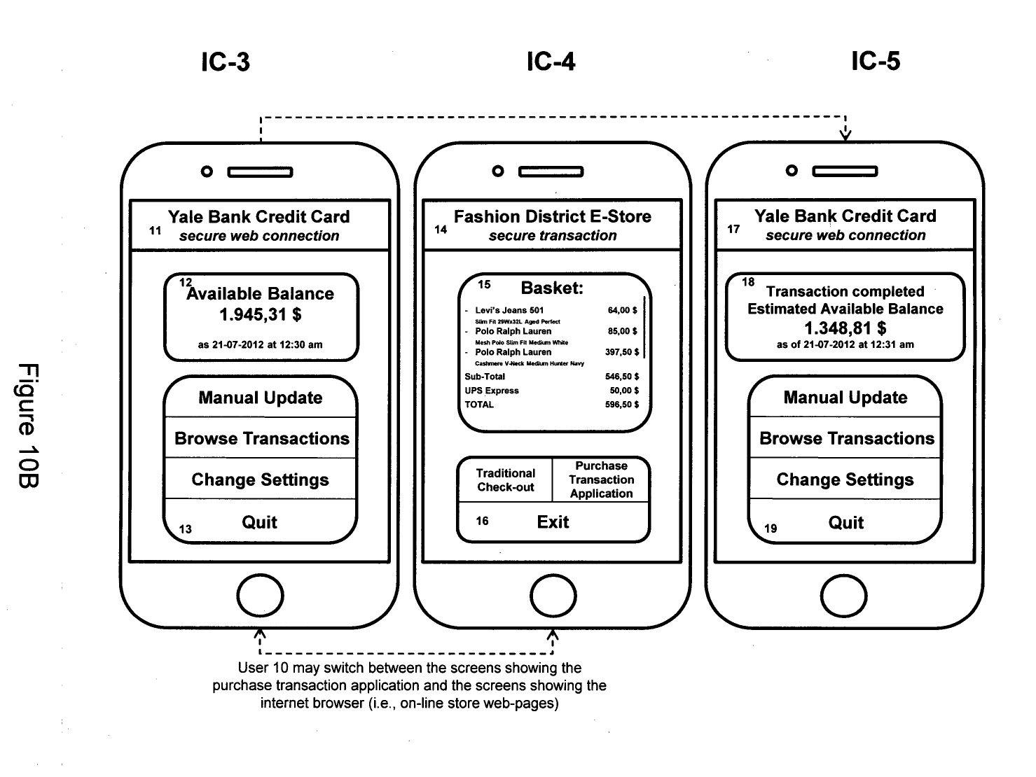

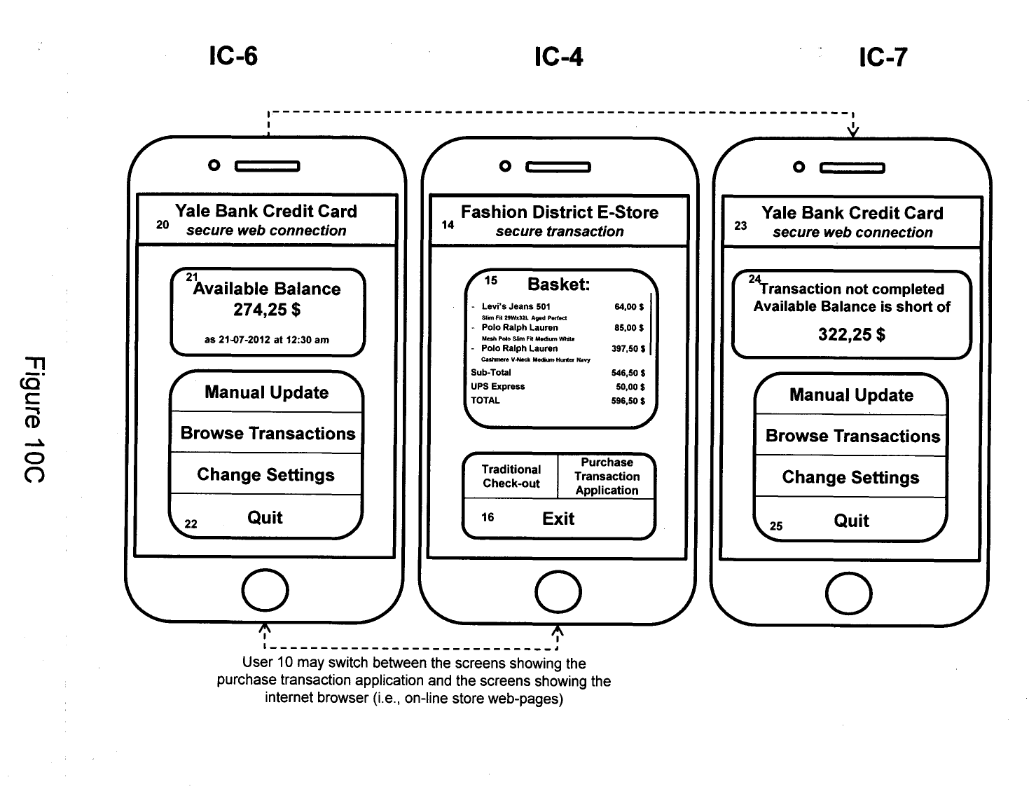

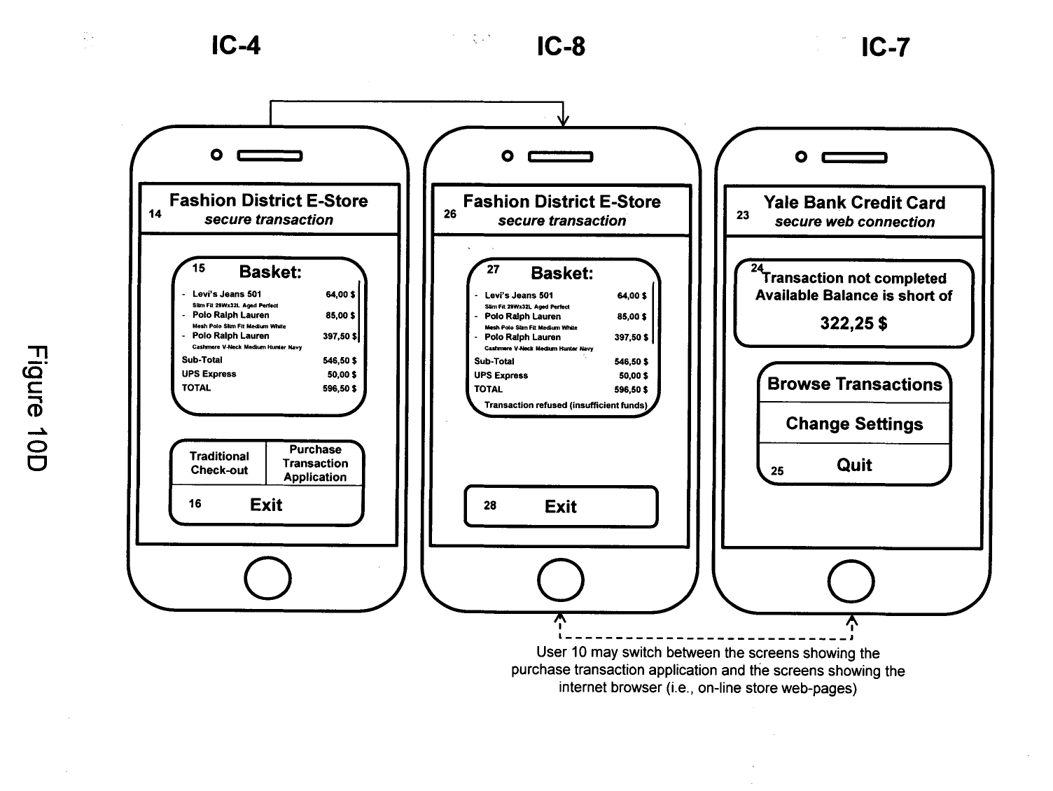

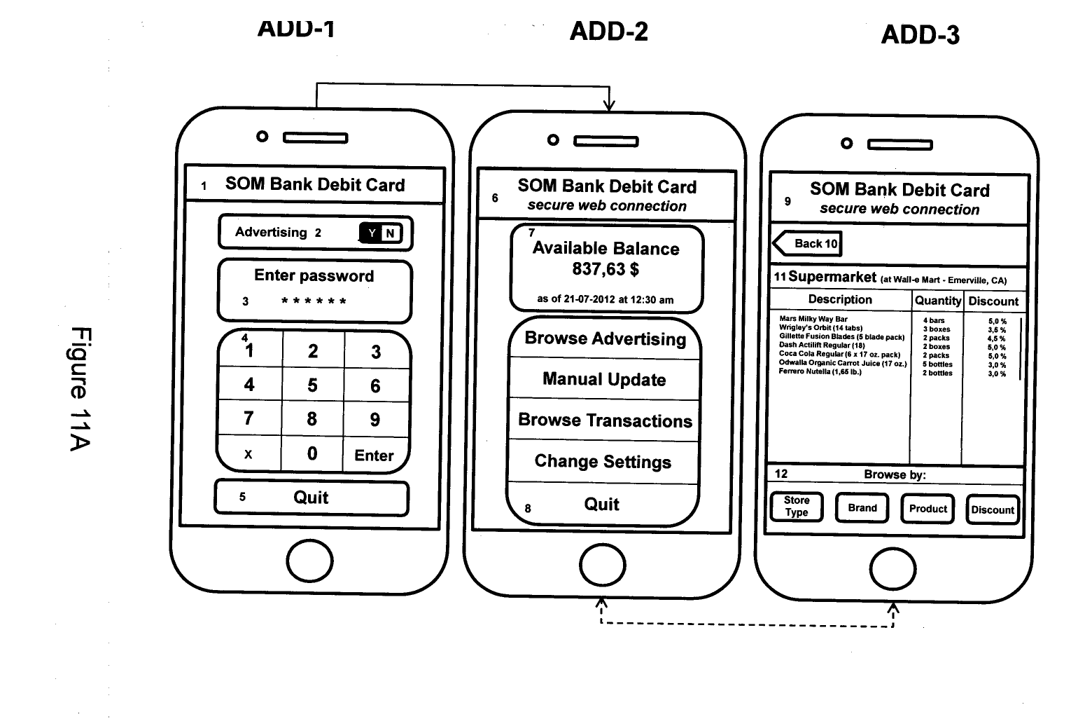

Advantageously, the purchase transaction application may include an “Internet” feature for performing a purchase transaction from an on-line store, as it is shown in FIG. 10A-10D. For example, the contents of the fields carried by the third message MSG3 (i.e. the authorization data field AUT_D, the available balance field AV_BL and the electronic money identification data field EM_ID) are stored into the non-volatile memory 160 of the mobile electronic device 2 and may be temporarily shared—in addition to the identification data (name and surname, permanent and shipping address, telephone and e-mail) of the user 10, previously stored into the non-volatile memory 160 of the mobile electronic device 2 (for example, during the set-up procedure of the purchase transaction application)—with the virtual check-out web-page of the on-line store by means, for example, of a database storing data in/retrieving data from the non-volatile memory 160 of the mobile electronic device 2, that thus represents the means of interaction (i.e., data exchange) between the check-out web-page and the purchase transaction application.

Advantageously—in case the mobile electronic device 2 includes a plurality of purchase transaction applications having also an “Internet” feature (enabled by the user 10)—the payment mode (debit card, credit card with a limited spending ceiling, credit card with an unlimited spending ceiling, pre-paid card and bank transfer) or the specific debit/credit card in case one or more cards are available for any available payment mode, used to actually perform a purchase transaction from an on-line store may be manually selected by the user 10 (i.e., by running the purchase transaction application associated with the chosen card/payment method) or may be automatically selected by a “Better Internet” application that simultaneously runs on (the processor 163 of) the mobile electronic device 2 all the associated (i.e., associated to the Better Internet application) purchase applications and then prioritizes their selection according to different criteria, for example, similar to those indicated above for the Better Shop computer program.

Preferably—in case the mobile electronic device 2 includes a plurality of purchase transaction applications having also an “Internet” feature (enabled by the user 10) and in case such purchase transaction applications are also integrated into a single purchase transaction application—the Better Internet application may be integrated as well into that purchase transaction application, thus becoming an embedded feature that can be enabled or disabled by the user 10.

Preferably, the Better Shop application and the Better Internet application may be integrated into a single application (or, in case they are embedded features of a single purchase transaction application, they may be integrated into a single embedded feature).

The transaction network 4 may be composed of a single party (for example, (the server of) the bank wherein the user 10 owns a bank account) or, more in general, may be composed of a plurality of parties (for example, (the server(s) of) the acquiring bank, the card association and the issuing bank) that are connected by means of a telecommunications network.

In case the transaction network 4 is composed of a plurality of parties and, in particular, is composed of an acquiring bank, a card association and an issuing bank, the message (for example, MSG1) transmitted by the mobile electronic device 2 to the transaction network 4 during the verification phase is directly received by the card association (by-passing the acquiring bank, that it is not necessary during the verification phase and that has to be involved only during the settlement phase). The card association processes the content of the received message and transmits a message (or a modified version, provided that it includes the same data fields) to the issuing bank. The message (or a modified version) is received by the issuing bank, that processes the content of the received message and transmits a response message (for example, MSG2) on the opposite route across the (parties of the) transaction network 4 all the way back to the mobile electronic device 2.

Therefore the value of the amount of funds available, for example, on a debit card of the user 10 is stored into the local (or remote) non-volatile memory of the issuing bank and is transmitted upon request (for example, by means of MSG1) to the mobile electronic device 2 (according to the above procedure).

In case the transaction network 4 is composed of a plurality of parties and, in particular, of an acquiring bank, a card association and an issuing bank, the message (for example, MSG5) transmitted by the Point-of-Sale device 6 to the transaction network 4 during the settlement phase is received by the acquiring bank, that processes the content of the message and transmits a message (or a modified version, provided that it includes at least the same data fields) to the card association. The card association processes the content of the received message and transmits a message (or a modified version, provided that it includes at least the same data fields) to the issuing bank. The issuing bank receives the message (or a modified version), processes the content of the received message and transmits a response message (for example, MSG6) on the opposite route across the (parties of the) transaction network 4 all the way back to the Point-of-Sale device 6.

Therefore the merchant identification data field ME_ID carried by the fifth message MSG5 may either be added, and transmitted, by the Point-of-Sale device 6, or by the acquiring bank (according to the procedure above).

According to a variant of the transaction network scheme and according to a related alternative business model, it is possible that a financial service provider may take part to the transaction network 4 in addition to the acquiring bank, the card association and the issuing bank. Such a financial service provider could extend to the user 10 a line of credit, guaranteed by one or more debit/credit cards available to the user 10, that the user 10 may use to perform purchase transactions (according to the present invention) by means of the mobile electronic device 2 and the purchase transaction application. In this case, during the verification phase the messages (for example, MSG1 and MSG2) are exchanged between the mobile electronic device 2 and the financial service provider, whereas during the settlement phase the messages (for example, MSG5 and MSG6) are exchanged between the Point-of-Sale device 6 and the acquiring bank, that, in turn, exchanges messages with the financial service provider. The card association and the issuing bank will be dealt with (directly) by the financial service provider in a separate (contemporary or subsequent) verification/settlement procedure referred to the specific debit/credit card (among the one or more cards that guarantee the extended line of credit) of the user 10, that is actually used by the financial service provider as guarantee to authorize the purchase transaction (during the verification phase of the purchase transaction) and that eventually is debited the bill amount of the purchase transaction (during the settlement phase between the financial service provider and the issuing bank of that card).

Advantageously, the issuing bank can transmit “push” (i.e., unsolicited) messages to the (corresponding) card association (or to a financial service provider or, alternatively, to a service provider, positioned between the mobile electronic device 2 and the card association in the data exchange flow scheme according to the present invention) whenever it occurs an event that changes the amount of funds available on a specific debit/credit card. This feature shortens the “distance” (in terms of number of parties (and devices)) that the messages (for example, MSG1 and MSG2) have to complete and makes the data available as close as possible to the mobile electronic device 2 (in its interaction with the transaction network 4, as if it were composed of a single party), thus shortening even more the time necessary to transmit/receive the messages MSG1/MSG2 respectively.

Preferably, in an even more optimized solution, the transaction network 4 transmits to the electronic mobile device 2, by means of the telecommunications network 3, “push” messages (for example, carrying an authorization data field AUT_D and an available balance field AV_BL) according to a “push” system, thus making the purchase transaction application associated with such electronic money (running on the mobile electronic device 2) exchange messages with the transaction network 4 in a way similar to a “push” e-mail management computer program. The mobile electronic device 2 automatically receives from the transaction network 4 periodical (for example, daily) update messages, as well as additional (for example, infra-day) update messages in case, due to any relevant event (for example, a purchase transaction, a cash withdrawal, etc.), the amount of funds available on the electronic money (associated with the purchase transaction application) has changed since the last daily/infra-day update message. This allows the mobile electronic device 2, provided that the purchase transaction application has been properly set-up, to be always on-line and updated, and thus ready to (try to) perform a purchase transaction.

Therefore the purchase transaction application running on (the processor 163 of) the mobile electronic device 2 automatically updates (i.e., overwrites) the content of the authorization data field AUT_D and the content of the available balance field AV_BL (previously) stored into the non-volatile memory 160 every time a new “push” message is received from the transaction network 4.

The Point-of-Sale device 6 and the mobile electronic device 2 perform the payment phase as described above (according to the first or the second embodiment and their variants) based on the last content of the authorization field AUT_D and the last content of the available balance AV_BL stored into the non-volatile memory 160; subsequently, the Point-of-Sale device 6 and the transaction network 4 perform the settlement phase as described above.

This solution is an optimized alternative to the other manual/automatic update features (i.e., “automatically at defined time instants”, “manually at any time” and “automatically when prompted”) described above; in fact, it makes the transaction network 4 pro-active (and always on-line) rather than merely reactive (and on-line/off-line) to the mobile electronic device 2 (for example, by means of a manual and/or an automatic request, for example, the message MSG1).

Preferably—in case “push” messages are sent directly to the mobile electronic device 2—the purchase transaction application may provide the user 10 with a manual update feature (for example, activated by the user 10 by touching an icon identified by a text string on the display 102), which makes the mobile electronic device 2 transmit to the transaction networks 4, by means of the telecommunications network 3, a message carrying, for example, an electronic money identification data field EM_ID indicating a request to “receive” new messages (if any) for the electronic money identified by the content of the electronic money identification data field EM_ID; in case the transaction network 4 does not send any new message and thus the mobile electronic device 2 does not receive any new message, it means that there are no new messages to be transmitted to the mobile electronic device 2 and that the last received message (i.e., the last content of the authorization field AUT_D and the last content of the available balance AV_BL stored into the non-volatile memory 160) is the most updated one.

Preferably—in case of “push” messages, as described above—the available balance field AV_BL includes, in addition to an amount of available funds, a time and date of reference for that amount of available funds.

In this case each message sent from the transaction network 4 to the mobile electronic device 2, by means of the telecommunications network 3, carries, for example, an authorization data field AUT_D and an available balance field AV_BL including the amount of available funds for the electronic money and the time and date of reference for that amount of available funds. The purchase transaction application running on (the processor 163 of) the mobile electronic device 2 automatically updates (i.e., overwrites) the content of the authorization data field AUT_D and the content of the available balance field AV_BL (including also the time and date of reference) (previously) stored into the non-volatile memory 160 every time a new “push” message is received from the transaction network 4.

The Point-of-Sale device 6 may use this additional data, for example, for security purposes; in fact, the Point-of-Sale device 6 may be allowed to perform the payment phase (as described above) only in case the current time (and date) does not differ from the time (and date) of reference for that amount of available funds by more than a pre-set timing (for example, 24 hours, according to, for example, a market practice, thus double-checking that the mobile electronic device 2 has at least received from the transaction network 4 the (mandatory) daily update message).

Advantageously, the number of (data) fields carried by the messages exchanged between the mobile electronic device 2 and the transaction network 4 (for example, MSG1 and MSG2), carried by the messages exchanged between the mobile electronic device 2 and the Point-of-Sale device 6 (for example, MSG3 and MSG4) and carried by the messages exchanged between the Point-of-Sale device 6 and the transaction network 4 (for example, MSG5 and MSG6) may be increased in order to add additional data.

This feature may become particularly interesting for providing additional value added services to the user 10 such as, for example, direct advertising/marketing information, as described below.

The first message MSG1 incorporates an implicit message, that is, the user 10 is likely to be located in a store shopping for goods and may be interested in receiving direct advertising/marketing information. The user 10 may allow the purchase transaction application running on the mobile electronic device 2 to incorporate in the first message MSG1 also data related to the profile of the user 10 (previously stored into the non-volatile memory 160), such as, for example, gender, age, status, occupation, children (if applicable), and/or to the current location, such as, for example, store category, address, etc., that make the direct advertising/marketing information as targeted as possible. For example, the mobile electronic device 2 may have installed a GPS positioning computer program (i.e., application) that allows the mobile electronic device 2 to capture the store category data (or the store business name and address data) and incorporate it into a store category field ST_CA (or in a store details field ST_DT) that is carried (among the other fields, as described above) by the first message MSG1.

The transaction network 4 may have, among its parties, also a marketing entity (or, alternatively, one of the parties may take on also this role) that deals with goods (or services) producers that intend to provide customers with direct advertising/marketing information (for example, a manufacturer of candies and chocolates could provide for a certain discount in case the customer buys two boxes, instead of one box, of a certain product). Therefore, as soon as the first message MSG1 (or a modified message) is received, the marketing entity (i.e., the transaction network 4) selects the appropriate direct advertising/marketing information—stored into a local (or remote) non-volatile memory—according to some previously defined criteria related to, for example, the store category/location, the profile of the user 10, etc., and incorporates it into a promotion list field PR_LST carried (among the other fields, as previously described) by the second message MSG2 on its way back to the mobile electronic device 2.

The mobile electronic device 2 receives from the mobile network 3 the second message MSG2 (or a modified message), extracts therefrom (among the others, as previously described) the content of the promotion list field PR_LST and stores the content of the promotion list field PR_LST into the non-volatile memory 160; moreover, such content is also shown on the display 102 of the mobile electronic device 2.

The user 10 may decide to take advantage of the direct advertising/marketing information and to purchase the goods accordingly (for example, by picking up from a shelf two boxes, instead of one box, of a certain chocolate product and putting them in the trolley 11).

The user 10 reaches the Point-of-Sale 5 and starts the payment phase that follows the procedure described above (for example, with reference to the first embodiment) according to the following two variants.

According to the first variant, the mobile electronic device 2 reads from the non-volatile memory 160 (among the others, as previously described) the content of promotion list field PR_LST indicating, for example, the bar codes of the goods on promotion and, respectively, the corresponding minimum required quantities and the applicable discount percentages, and transmits to the Point-of-Sale device 6 the third message MSG3 according to a near field communication protocol (such as Bluetooth®), wherein the third message MSG3 carries also the promotion list field PR_LST.

According to the second variant, the counter 7 transmits to the Point-of-Sale device 6 (in addition to the value of the bill amount) some details on each purchased good included in the bill amount (for example, bar code, quantity and price per unit) that are stored into the non-volatile memory 60.

As soon as the payment phase has been successfully completed, the Point-of-Sale device 6—that has received (from the counter 7) and then stored into the non-volatile memory 60 the details on each purchased good included in the bill amount, and that has received (from the NFC interface 64) the third MSG3, extracted therefrom (among the others, as previously described) the content of promotion list field PR_LST, and then stored into the non-volatile memory 60 the content of the promotion list field PR_LST—activates the settlement phase.

The settlement phase follows the procedure described above (for example, with reference to the first embodiment) with one variant, according to which the Point-of-Sale device 6 transmits to the transaction network 4, by means of the mobile network 3, the fifth message MSG5 carrying also the promotion list field PR_LST indicating the direct advertising/marketing information and carrying also a goods details field GDS_DTLS indicating the details on each purchased good included in the bill amount, read (among the others) from the non-volatile memory 60.

The marketing entity (i.e., the transaction network 4) receives from the mobile network 3 the fifth message MSG5 (or a modified message) and extracts therefrom the content of the promotion list field PR_LST and the content of the goods details field GDS_DTLS. The marketing entity stores into a local (or remote) non-volatile memory the content of the promotion list field PR_LST and the content of the goods details field GDS_DTLS, and then processes such contents; in particular, the marketing entity compares the content of the promotion list field PR_LST indicating the direct advertising/marketing information with the content of the goods details field GDS_PRC indicating the details on each purchased good included in the bill amount in order to look for any correspondence, and then calculates the amount (if any) to be credited to the user 10 by each of the goods manufacturers.

In case the marketing entity finds one or more correspondences, it starts a (dedicated) settlement procedure in order to debit the discount amounts, respectively, on the bank account of the corresponding goods manufacturers, and to credit the total amount (previously generated by the marketing entity and equal to the algebraic sum of each discount amount the user 10 is entitled to) on the debit (or credit) card of the user 10.

This settlement procedure may take place according to many alternative structures (and involving different parties, for example, respectively, the goods manufacturers and the user 10 as indicated above, or the goods manufacturers and the merchant, etc.).

According to a variant of the direct advertising/marketing information described above, the financial service provider (previously described as being a possible additional party composing the transaction network 4 according to a different business model) may also integrate the functions/role of the marketing entity.

Advantageously, the direct advertising/marketing information could be structured—depending also on the privacy legislation(s) in force in different countries and/or to the extent of the consent given by the users (for example, the user 10) to provide certain sensitive information to the marketing entity—as a learning system, that is, the marketing entity may tailor the direct advertising/marketing information not only on data regarding the store category and the profile of the user 10 (as described above), but also on the specific behavior(s) of the user 10 during the preceding purchase transaction(s) (i.e., the marketing entity may map the user 10 in terms of purchasing habits and act/re-act accordingly, and moreover it may work independently from, or consistently with, other promotions that may be active in the merchant store 30, wherefrom the user 10 is shopping).

For example, the user 10 during the preceding purchase transaction(s) (in a store category and/or in a specific store) has (consistently or occasionally) taken advantage of some promotions (for example, the user 10 has consistently bought two boxes, instead of one box, of a certain chocolate product), and has not (consistently or occasionally) taken advantage of other promotions (for example, the user 10 has never bought a specific product); in such a case, the marketing entity may, for example, provide the loyal user 10 with a premium (for example, an higher discount for the same quantity) and/or try to increase even more the purchased quantity (for example, an higher discount if the user 10 buys three boxes, instead of two boxes, of a certain chocolate product), and it may, for example, provide the reluctant user 10 with an incentive (for example, a special discount if the user 10 buys the specific product).

According to another solution, the present invention could be adopted not to perform a purchase transaction (and to provide other value added services) as described above, but only to provide the user 10 with some value added services such as, for example, the direct advertising/marketing information.

In this case a number of variants—related to the tasks performed by the purchase transaction application running on the mobile electronic device 2 and to the electronic devices to be used in addition to the mobile electronic device 2—are necessary to adapt the present invention to a restricted scope of activities, as represented thereafter in one example (among the many possible) briefly describing the various phases that, for the sake of simplicity, maintain the same name, but may present some differences in terms of performed activities and/or exchanged data.

During the verification phase—that now represents the phase during which the user 10 is shopping at the merchant store 30 and checks if any promotion is currently available—the mobile electronic device 2 transmits to the marketing entity, by means of the telecommunications network 3, a message including some identification/useful data (for example, the electronic money identification data indicating a specific electronic money on which the aggregate amount of the discounts related to the promotions will be credited, the user 10 profile indicating the personal data of the user 10 (for example, gender, age, status, occupation and children (if applicable)), and the store category indicating the product category(ies) sold in the merchant store 30), and then receives from the marketing entity, by means of the telecommunications network 3, a message including the direct advertising/marketing information.

During the payment phase—that now represents the phase during which the user 10 is standing at the Point-of-Sale as the selected goods are scanned and the bill amount is generated by the counter 7—the mobile electronic device 2 transmits to the Point-of-Sale device 6 using a near field communication protocol (or alternatively, for example, to the (server of the) merchant store 30 using a text message or an e-mail, based, for example, on the data (i.e., phone number and/or e-mail address) provided by the GSP positioning computer program) a message including the identification data of the electronic money of the user 10 (for example, serial number of the card, expiration date, name of the issuing bank, name of the card association, security code and name and surname of the card owner) and the (previously received) direct advertising/marketing information.

During the settlement phase—that now represents the phase in which the payment is performed and then subsequently settled according to, for example, the known method described above—the POS terminal of the merchant store 30 (or alternatively, for example, the Point-of-Sale device 6) transmits to the transaction network 4, by means of the telecommunications network 3, an authorization request message including the electronic money identification data and the bill amount for the goods purchased by the user 10, and the transaction network 4, in turn, transmits to the POS terminal of the merchant store 30 (or alternatively, for example, to the Point-of-Sale device 6), by means of the telecommunications network 3, an acknowledge message in order to approve the purchase transaction; in addition, the Point-of-Sale device 6 (or alternatively, for example, the (server of the) merchant store 30) transmits to the transaction network 4 (and also to the marketing entity in case it is not part of the transaction network 4) a message including the (previously received) identification data of the electronic money of the user 10 and the direct advertising/marketing information, as well as the details on each purchased good included in the bill amount (received from the counter 7), so that the transaction network 4 (and also to the marketing entity in case it is not part of the transaction network 4) compares the content of the direct advertising/marketing information with the details on each purchased good included in the bill amount in order to look for any correspondence and then calculates the amount (if any) to be credited to the electronic money of the user 10 according to a dedicated settlement procedure.

Advantageously, the purchase transaction application as above described in the other solution (i.e., providing the user 10 only with some value added services, such as, for example, direct advertising/marketing information) may be integrated into and/or coupled with one or more third party computer program(s) that provide the user 10 with a computerized automation of the known method described above and/or alternative methods and systems to perform purchase transactions of goods or services with a mobile electronic device 2.

FIGS. 5A-5B shows the set-up procedure performed by the user 10 to configure in the smartphone 2 the data identifying an electronic money and its owner (in the example, a specific debit card).

The set-up procedure has to be performed the first time the user 10 runs the purchase transaction application associated with the debit card or in case (according to the text string “Change Settings”) a change of one or more data identifying the debit card (and/or its owner) and/or of one or more optional features is subsequently necessary and/or requested by the user 10.

The user 10 is brought to Set-up screen the first time the user 10 runs the purchase transaction application associated with the debit card by touching the icon identified by the text string “SOM Bank Debit Card” in Home screen (FIG. 5M, H-0).

The user 10 may decide to either continue with the set-up procedure by touching the icon identified by the text string “Set-up” or quit (i.e., close) the set-up procedure and resume it later on, by touching the icon identified by the text string “Quit”.

The user 10 that has touched the icon identified by the text string “Set-up” (see area 2 in FIG. 5A, D-1) is shown on the display 102 an area (see area 4 in FIG. 5A, D-2) wherein the user 10 (using the keyboard 5) has to fill in the required data fields identifying the debit card, including, for example, the name and surname of the debit card owner, the card number, the security PIN and, preferably, some additional data, such as, for example, a password, an automatic update frequency and a minimum balance threshold.

The password is requested every time the user 10 runs the purchase transaction application by touching the icon identified by the text string “SOM Bank Debit Card” in Home screen (FIG. 5M, H-0) in order to increase security; this feature, being an option, may enabled or disabled by the user 10 and the password may be subsequently changed by the user 10.

The automatic update frequency is the frequency (in terms of timing, for example, every 30 seconds) of the automatic update (in addition to a manual update, in case the user 10 touches on the corresponding icon identified by a text string) of the amount of available funds and the corresponding time and date of reference; this feature, being an option, may be enabled or disabled by the user 10 and the timing of the update frequency may be subsequently changed by the user 10.

The balance threshold is the minimum value of the amount of funds available on the debit card necessary to allow the purchase transaction application to (try to) complete a purchase transaction (i.e., to exchange data with the Point-of-Sale device 6 during the payment phase); this feature, being an option, may be enabled or disabled by the user 10 and the value of the balance threshold may be subsequently changed by the user 10.

As soon as all the fields have been duly filled in, the user 10 touches “Send” on the keyboard 5 and the data identifying the debit card (and its owner) are stored into the non-volatile memory 160 of the smartphone 2. Afterwards, the smartphone 2 transmits to the transaction network 4, by means of the telecommunication network 3, the data identifying the debit card (and its owner) (serial number of the debit card, expiration date, name of the issuing bank, name of the card association, security code and name and surname of the debit card owner). The (server of the) transaction network 4 compares the debit card identification data received from the smartphone 2 with the debit card identification data stored into the local (or remote) non-volatile memory.

In case of a positive comparison, the smartphone 2 receives from the transaction network 4 a set-up confirmation message and, in addition to the authorization to use the debit card, the value of the amount of funds available on the debit card at the current time and date; moreover, the display 102 shows a message (see area 7 in FIG. 5A, D-3) indicating the successful completion of the set-up procedure and the amount of funds available (1.000,00 USD) at the current time and date (12:00 AM, 1 Sep. 2012).

In case of a negative comparison, the smartphone 2 receives from the transaction network 4 a set-up denial message; moreover, the display 102 shows a message (see area 11 in FIG. 5B, D-4) indicating the unsuccessful completion of the set-up procedure. The user 10 may then either touch an icon identified by the text string “Quit” (see area 12) to quit the set-up procedure or touch an icon identified by the text string “Back” (see area 10) to go back to the previous screen (see FIG. 5B, D-2) to fill in again the required data fields.

In case of a set-number of negative comparisons (due to several wrong trials), the smartphone 2 receives from the transaction network 4 a blockage message for the debit card (i.e., denied authorization to use the debit card); moreover, the display 102 shows a message (see area 14 in FIG. 5B, D-5) indicating that the debit card has been blocked.

FIGS. 5C-5D show the screens generated on the display 102 of the smartphone 2 during the verification phase (assuming, for example, that a specific debit card is used as electronic money and that the set-up procedure of the purchase transaction application associated with that debit card has been successfully completed).

The user 10 is brought to Password screen (FIG. 5C, D-6) (assuming that this feature has been enabled by the user 10) every time the user 10 runs the purchase transaction application associated with the debit card by touching the icon identified by the text string “SOM Bank Debit Card” in Home screen (FIG. 5M, H-0).

The user 10, using the keyboard 18, types in the password (see area 17), that is checked with the same data stored into the non-volatile memory 160 of the smartphone 2 during the set-up procedure; an incorrect password brings the user 10 to another screen (FIG. 5C, D-7), wherein the user 10 may decide to either re-type in the password or touch an icon identified by the text string “Quit” (area 23) to quit the purchase transaction application.

Once the user 10 has logged in (i.e., by typing in the correct password), the smartphone 2 establishes a secure web connection to (the server(s) of) the transaction network 4, that compares the debit card identification data stored into the non-volatile memory 160 of the smartphone 2 and sent to the transaction network 4, with the same data, stored into the local (or remote) memory of the transaction network 4 and checks for, in addition to the authorization to use the debit card, the amount of funds available at the current time and date based on all data stored into the local (or remote) non-volatile memory of the transaction network 4 (for example, amount of funds available in the bank account of the debit card owner, amount of funds available according to daily/monthly cumulated values of the purchase transactions with respect to daily/monthly allowed spending ceiling, etc.).

The user 10 is then brought either to Operation screen 1 (see FIG. 5D, D-8) or to Operation screen 2 (see FIG. 5D, D-9), depending on both the authorization to use the debit card (assumed to be positive) and the amount of funds available at the current time and date, that the transaction network 4 has communicated to the smartphone 2 (see area 25 or 28, respectively).

In Operation screen 1 the user 10 may (try to) complete a purchase transaction at Point-of-Sale 5 or decide to make other actions by touching the corresponding icons identified by text strings (see area 26 in FIG. 5D, D-8).

In Operation screen 2 the user 10 may not (try to) complete a purchase transaction because the amount of funds available at the current time and date is below the balance threshold set by the user 10 (assuming that this feature has been enabled by the user 10), but the user 10 may decide to make other actions by touching the corresponding icons identified by text strings (see area 29 in FIG. 5D, D-9).

In Operation screen 1 the purchase transaction application (assuming that this feature has been enabled by the user 10) automatically updates (i.e., refreshes) the amount of available funds and the corresponding time and date of reference every set amount of time (according to the frequency set by the user 10, that may be based on his preferences or, more likely, on a market practice) to make sure, for security purposes, that the amount of available funds is updated to a recent time (and date) preceding the purchase transaction; as an alternative, and/or in combination to the automatic update frequency, the user 10 may at any time manually update the amount of available funds and corresponding the time and date of reference by touching the icon identified by the text string “Manual Update” (see area 26 in FIG. 5D, D-8).

FIGS. 5E-5H shows the screen generated on the display 102 of the smartphone 2 during the payment phase according to the first embodiment (assuming, for example, that a specific debit card is used as electronic money and that the set-up procedure of the purchase transaction application associated with that debit card has been successfully completed).

The user 10 elects to purchase the selected goods and reaches the Point-of-Sale 5, wherein a cashier scans the goods and a counter 7 generates the bill.

The user 10 then leans the smartphone 2—that is running the purchase transaction application on Operation screen 1 (see FIG. 5E, D-8)—on the pad of the Point-of-Sale device 6 that establishes, according to a near field communication protocol, a connection to the smartphone 2 to exchange data.

The Point-of-Sale device 6 receives from the smartphone 2 the data stored into the non-volatile memory 160 of the smartphone 2, including the debit card identification data (serial number of the debit card, expiration date, name of the issuing bank, name of the card association, security code and name and surname of the debit card owner) and, among the others (for example, the authorization to use the debit card and, if applicable, the random generated number/alphanumeric code), the amount of available funds (837,63 USD) at a specific time and date (12:30 AM, 21 Jul. 2012).

The Point-of-Sale device 6 compares the amount of available funds with the bill amount (previously) received from the counter 7 and compares the current time and date (12:31 AM, 21 Jul. 2012) with the time and date of reference for the amount of available funds (12:30 AM, 21 Jul. 2012).

In case the amount of available funds is enough to complete the purchase transaction and the current time and date does not differ from the time and date of reference for the amount of available funds by more than a pre-set timing (for example, 2 minutes), the Point-of-Sale device 6 immediately confirms the purchase transaction (for example, a “green light” on the Point-of-Sale device 6) and sends to the smartphone 2 a confirmation message (along with the bill amount); the user 10 is then brought to Purchase screen 1, wherein a transaction confirmation message and an estimated and (temporarily) updated available funds balance are shown (see area 31 in FIG. 5E, D-10).

In case either the amount of available funds is not enough to complete the purchase transaction or the current time and date differs from the time and date of reference for the amount of available funds by more than the pre-set timing, the Point-of-Sale device 6 immediately denies the purchase transaction (for example, a “red light” on the Point-of-Sale device 6) and sends to the smartphone 2 a denial message (along with the bill amount); the user 10 is then brought to Purchase screen 2, where a transaction denial message (and additional info) is shown (see area 37 in FIG. 5F, D-12).

As the user 10 is packing and/or reaching the store exit, the Point-of-Sale device 6 connects, by means of the telecommunications network 3, to the transaction network 4 to activate the settlement phase.

FIGS. 5I-5L show the screens generated by some, among the many, additional and useful utility features of the purchase transaction application running (on the processor 163 of) the smartphone 2.

A first useful feature is the possibility for the user 10 to browse past purchase transactions (as it is shown, for example, on Operation screen 1 and Operation screen 2 and on Purchase screen 1 and Purchase screen 2).

The user 10, for example, touches the icon identified by the text string “Browse Transactions” in Purchase screen 1 (see area 32 in FIG. 5I, D-10) and is brought to Browse screen (see FIG. 5I, D-15).

In Browse screen the smartphone 2 (communicating with the transaction network 4 by means of the telecommunications network 3) checks for a detailed list of past purchase transactions (including details such as, for example, the bill amount, the time and date of the purchase transaction, the merchant's business name and the store address) according to different time spans selected by the user 10 by touching the corresponding icons identified by text strings (see area 49 in FIG. 5I, D-15); the user 10 may then go back to Operation screen 1 by touching the icon identified by the text string “Back” (see area 47 in FIG. 5I, D-15).

Such a feature may, to some extent, also be set-up to work off-line as the bill amount (and more likely other relevant data, such as, for example, the time and date of the purchase transaction, etc.) have been sent (during the payment phase) from the Point-of-Sale device 6 to the smartphone 2 and stored into the non-volatile memory 160 of the smartphone 2.

A second useful feature is the possibility for the user 10 to change one or more customizable settings/features such as, for example, the password, the automatic update frequency and the balance threshold (as it is shown, for example, on Operation screen 1 and Operation screen 2 and on Purchase screen 1 and Purchase screen 2).

The user 10, for example, touches an icon identified by the text string “Change Settings” in Operation screen 2 (see area 29 in FIG. 5L, D-9) and is brought to Set-up screen (see FIG. 5L, D-16).

In Set-up screen the user 10 may change one or more customizable settings/features, that are stored into the non-volatile memory 160 of the smartphone 2 and, if necessary, are communicated to the transaction network 4 by means of the telecommunications network 3; once the new settings/features have been set-up and stored, the user 10 is brought to another screen, wherein a confirmation message is shown (see 54 in FIG. 5L, D-17).

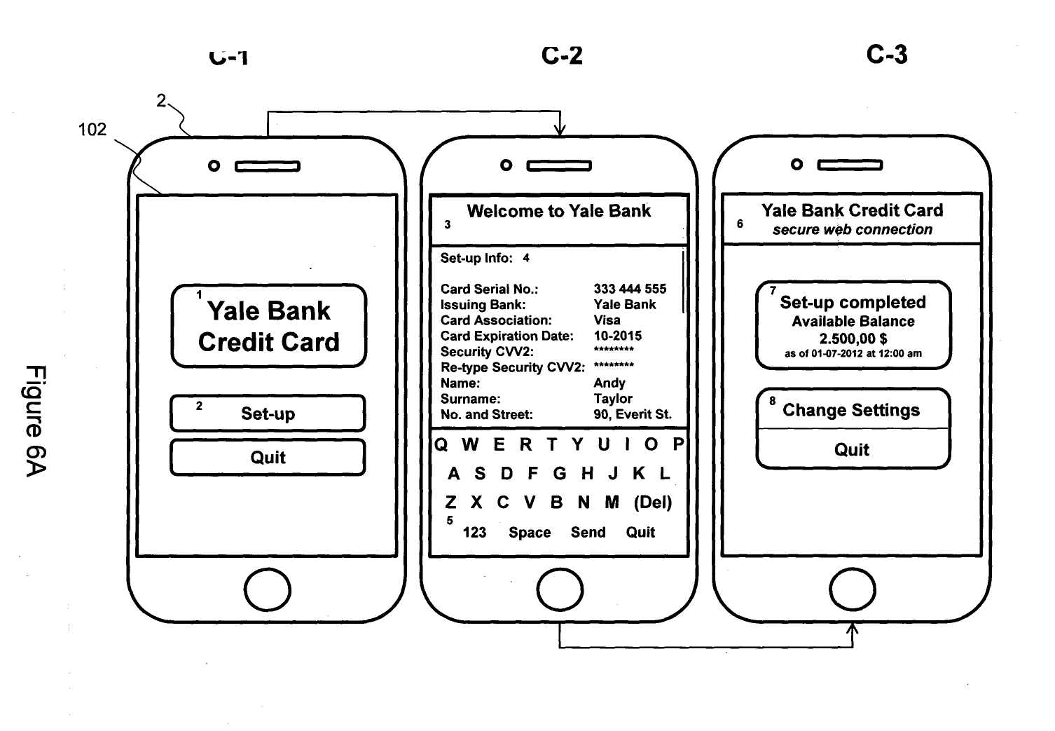

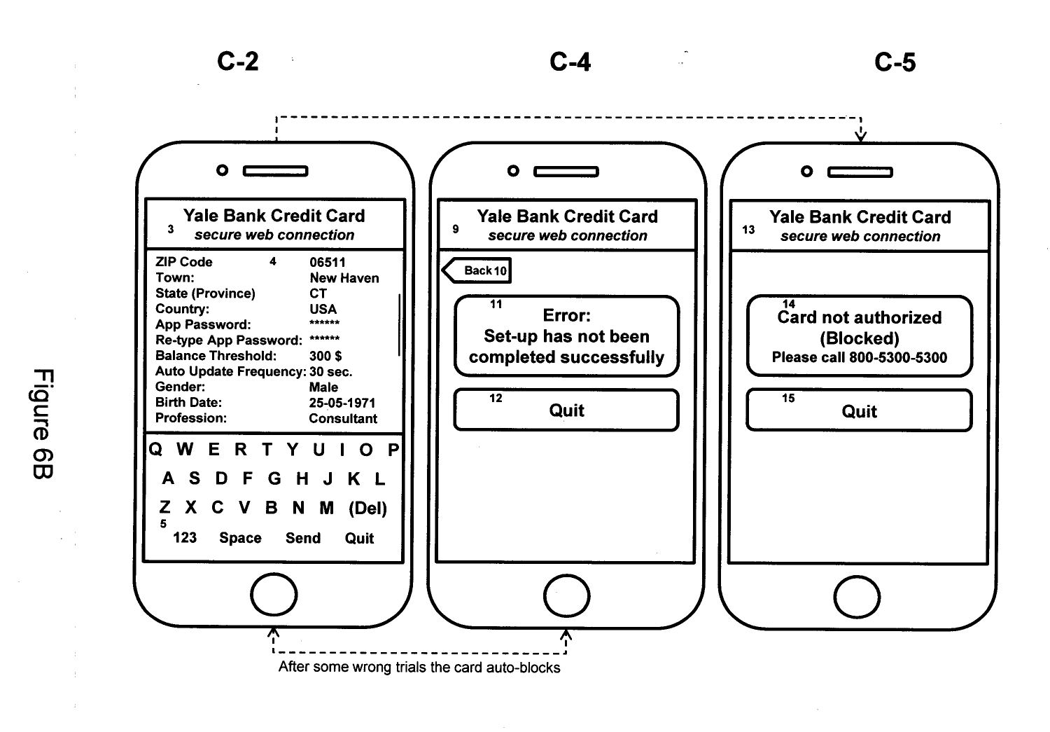

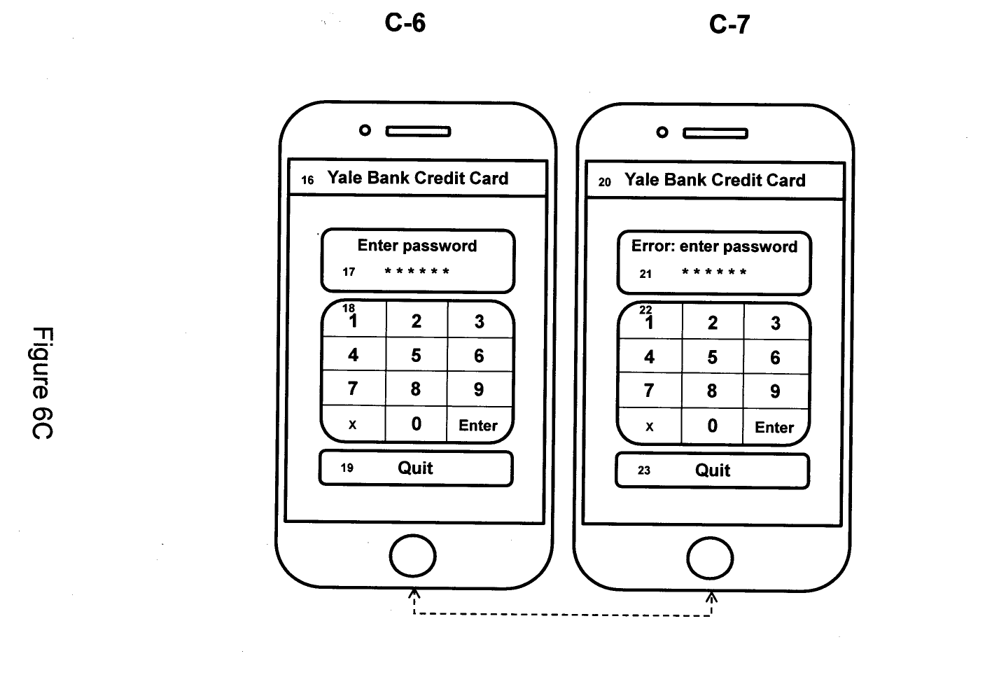

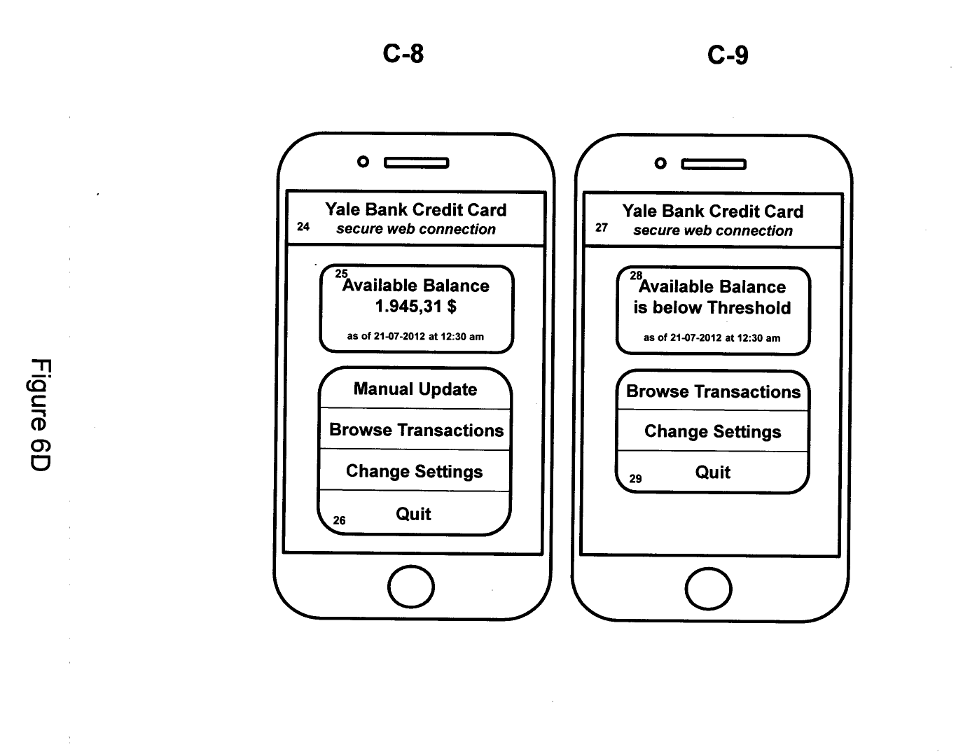

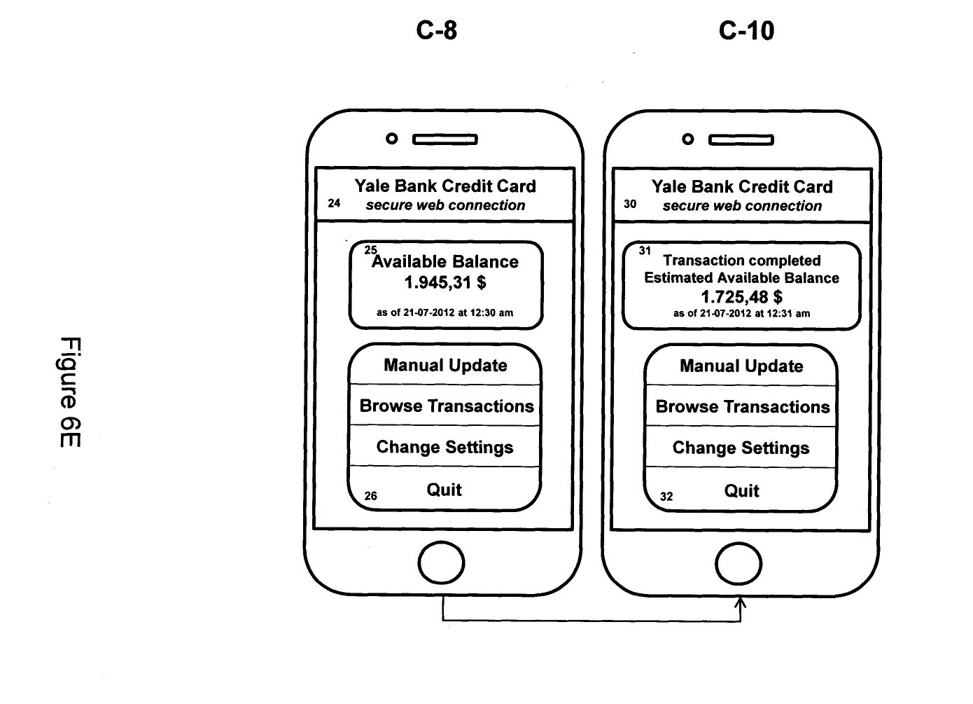

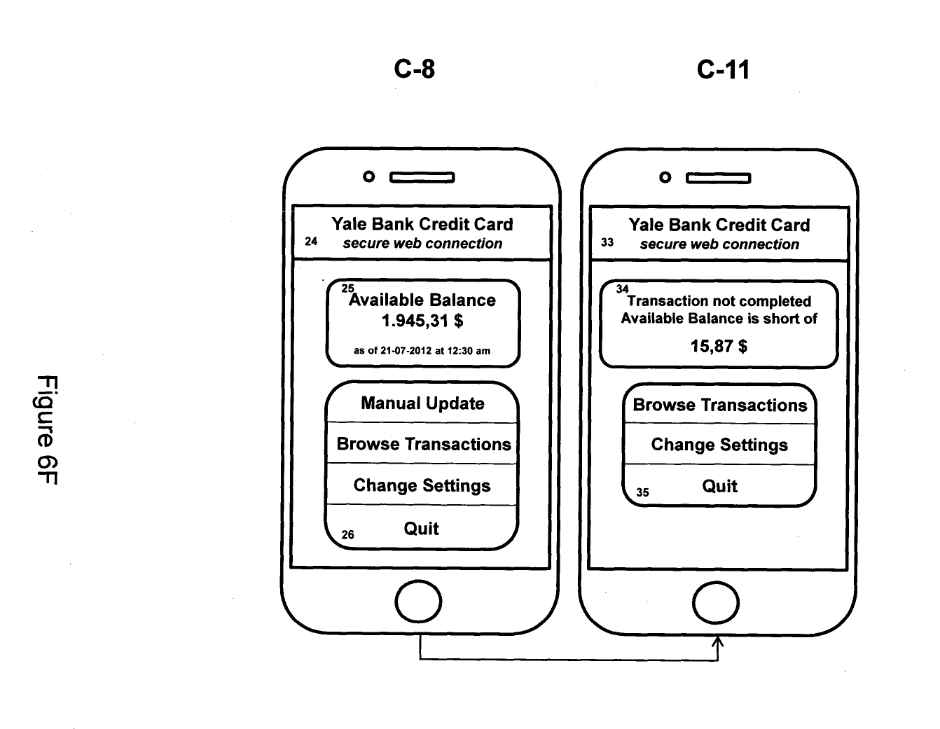

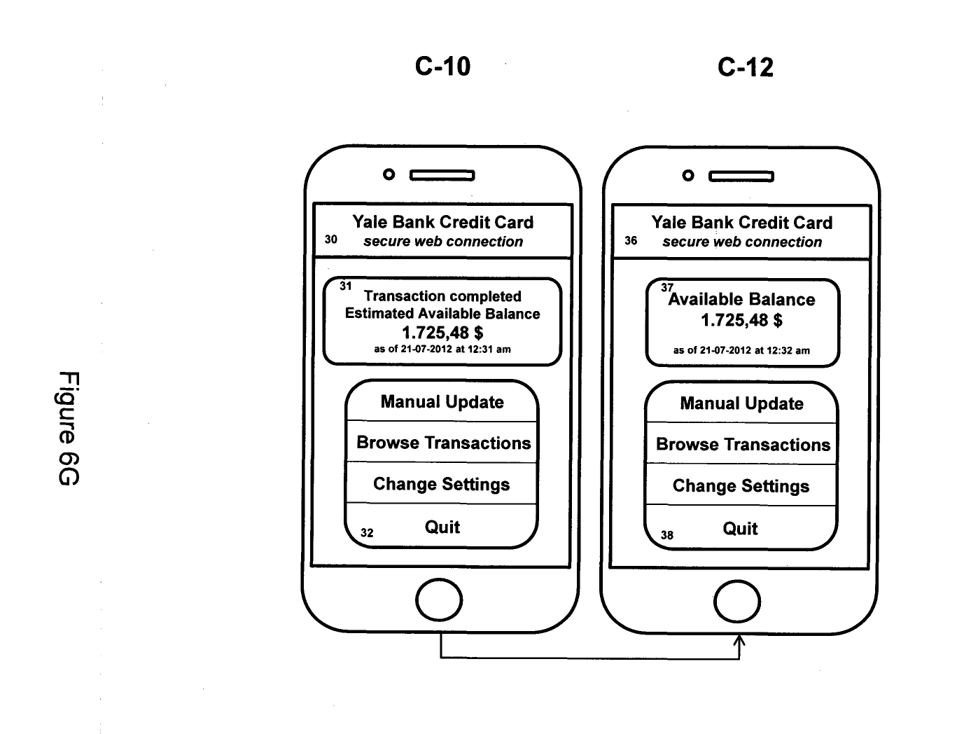

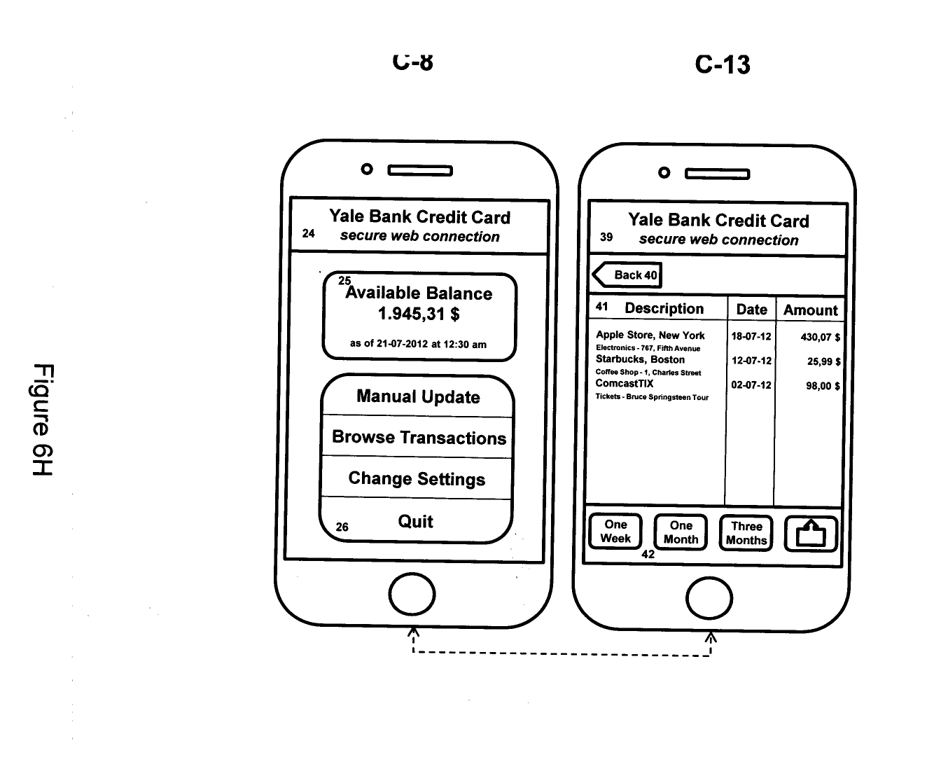

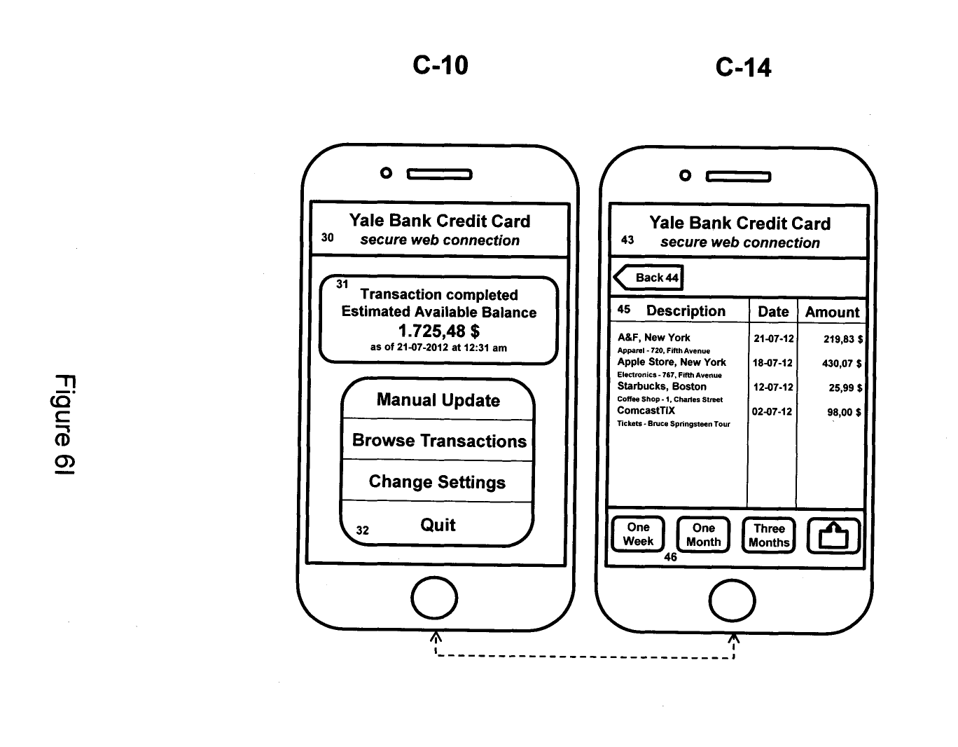

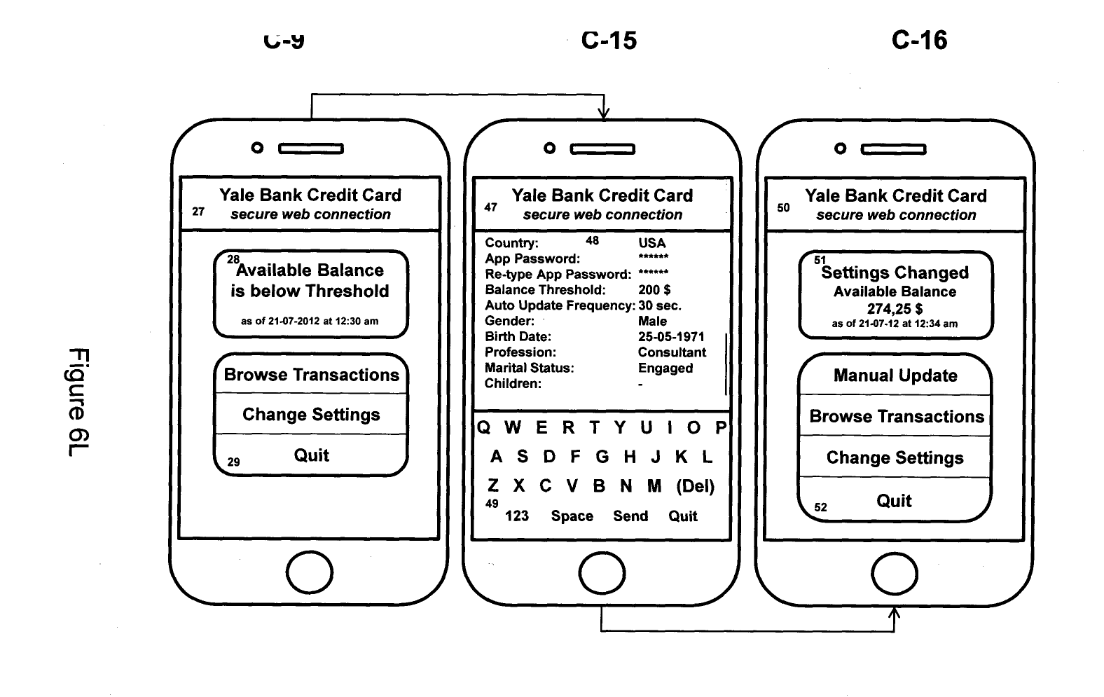

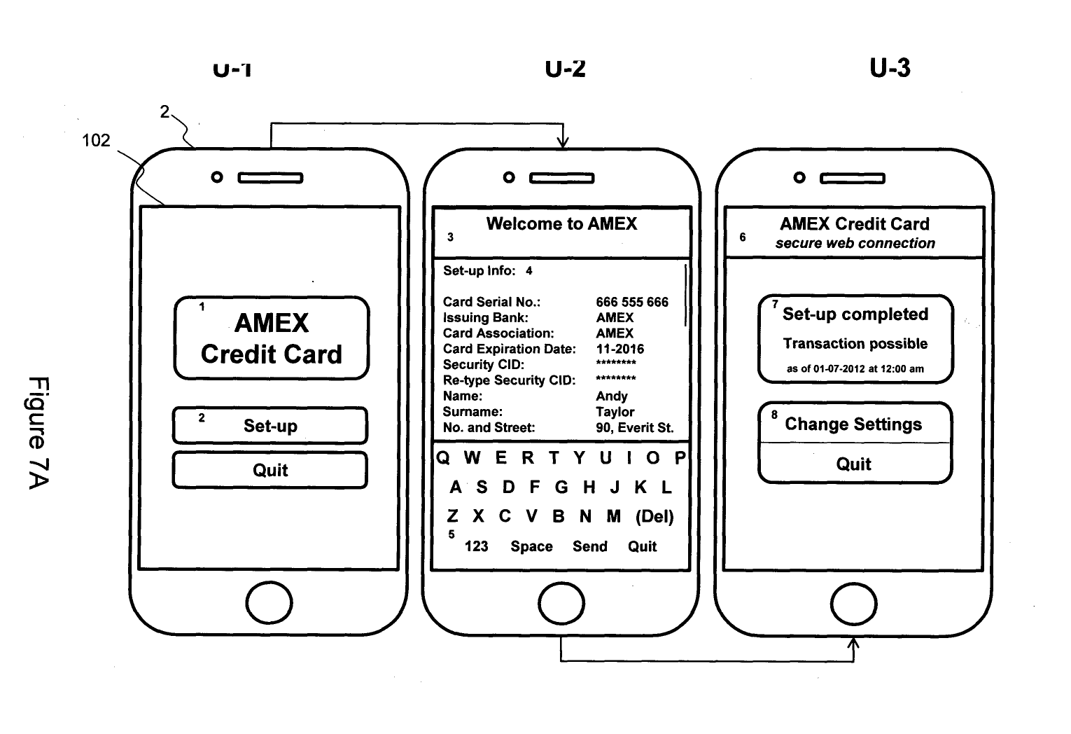

FIGS. 6A-6L show the screens generated on the display 102 of the smartphone 2 when the purchase transaction application performs the verification phase and the payment phase (according to the first embodiment) assuming, for example, that a specific credit card with a limited spending ceiling is used as electronic money.

The above considerations regarding the debit card as electronic money can be applied pari-passu (with only minor due changes, such as, for example, “Yale Bank Credit Card” instead of “SOM Bank Debit Card” and credit card identification data instead of debit card identification data) to the credit card with a limited spending ceiling as electronic money by replacing FIGS. 5A-5L with FIGS. 6A-6L respectively.

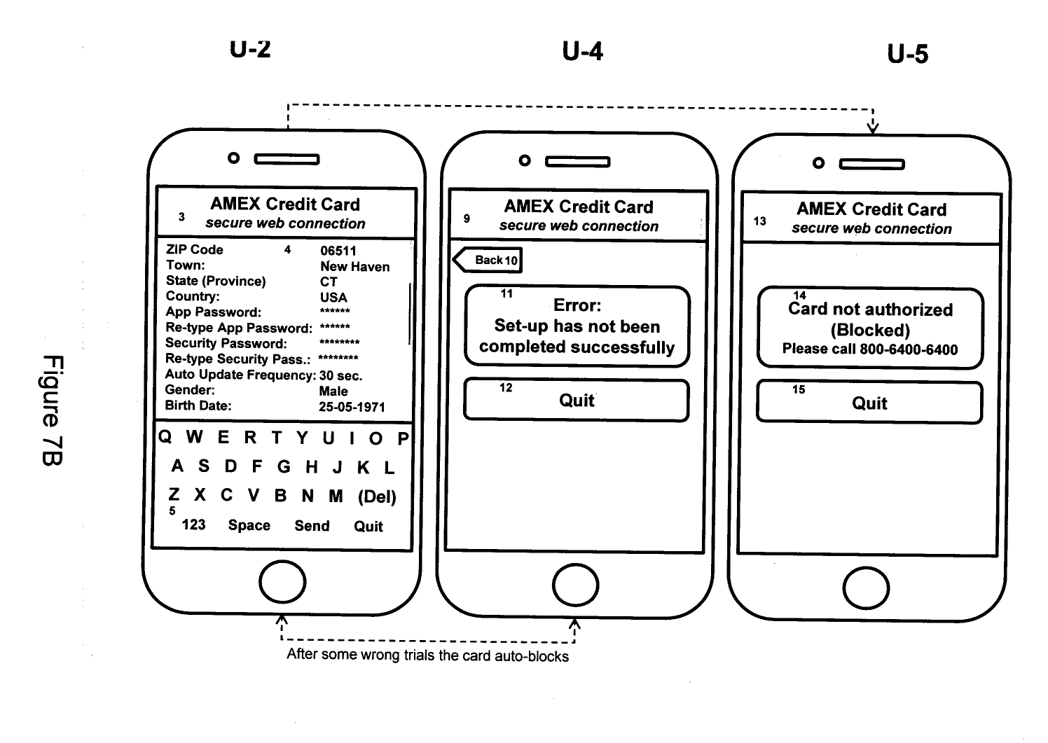

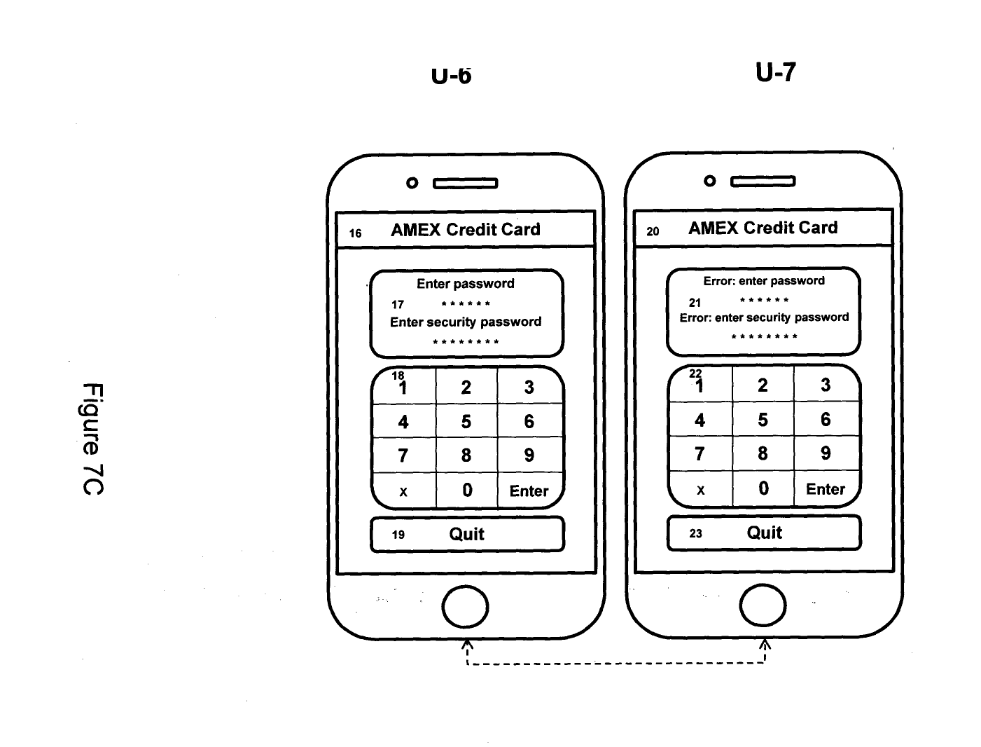

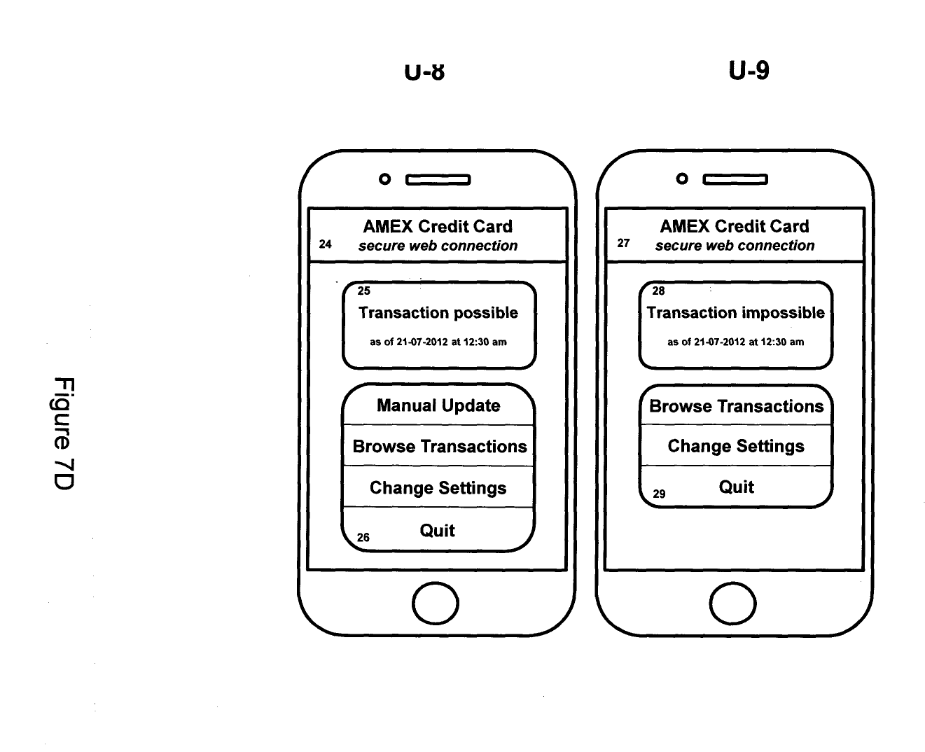

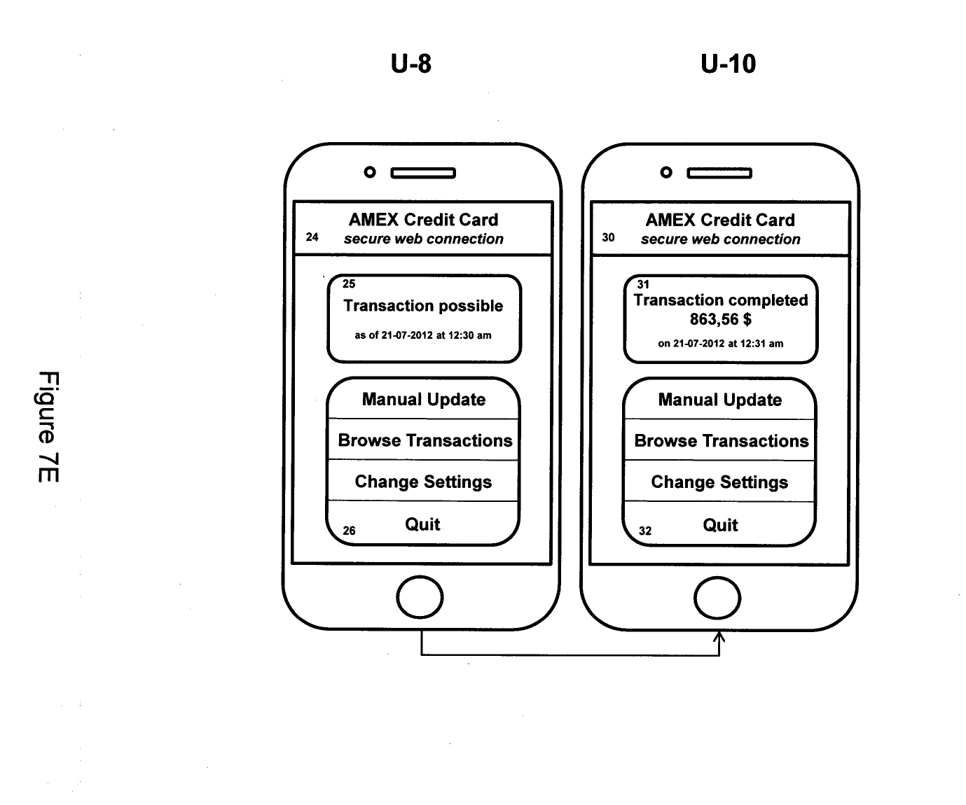

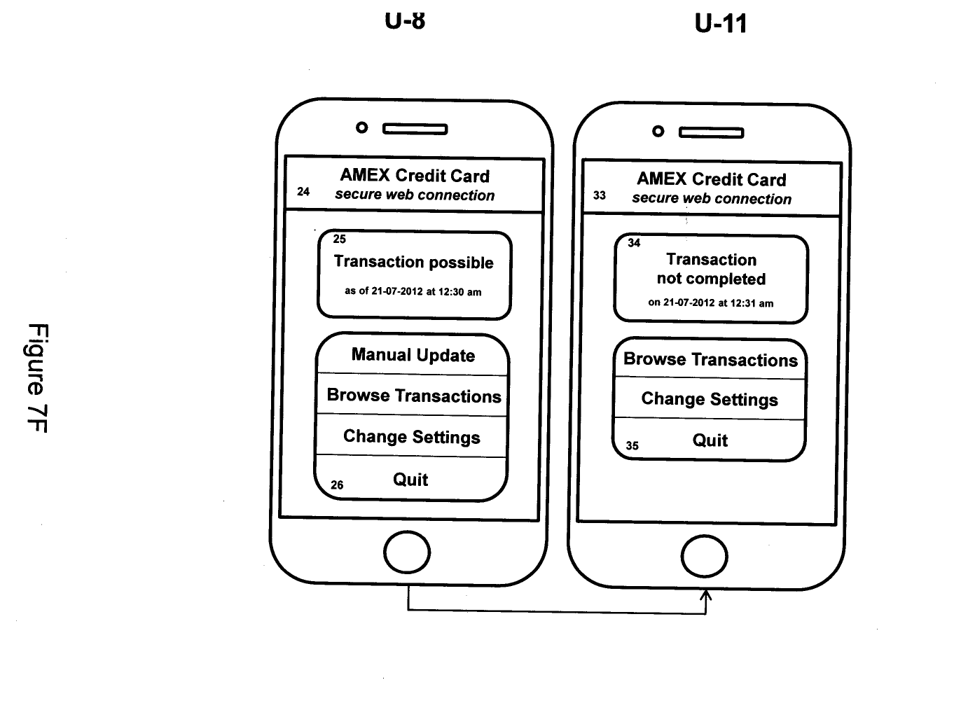

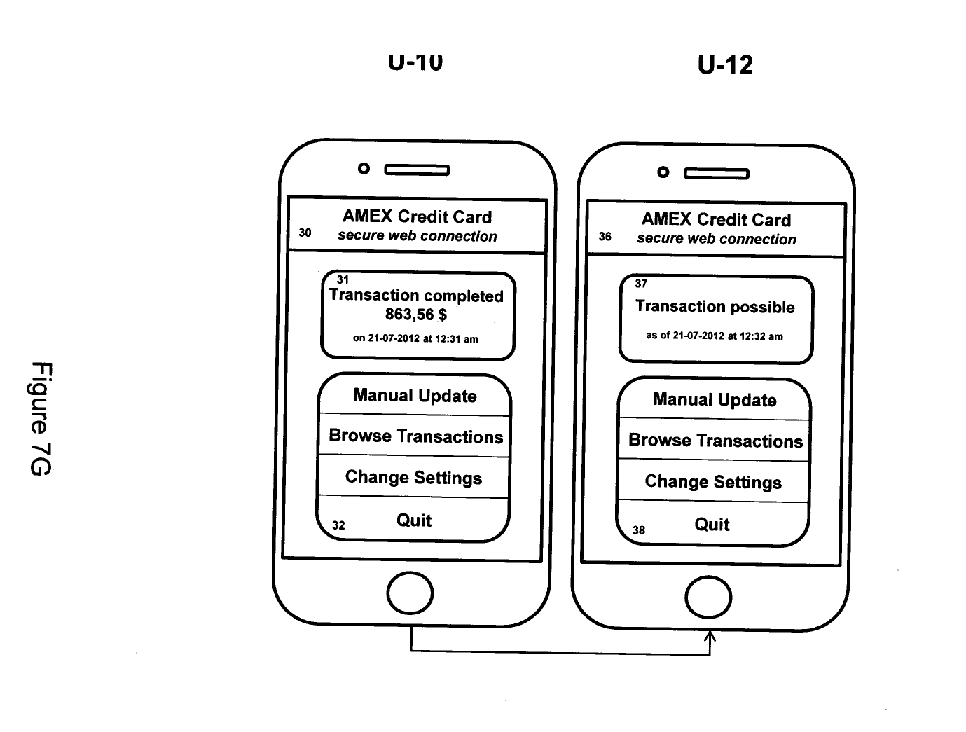

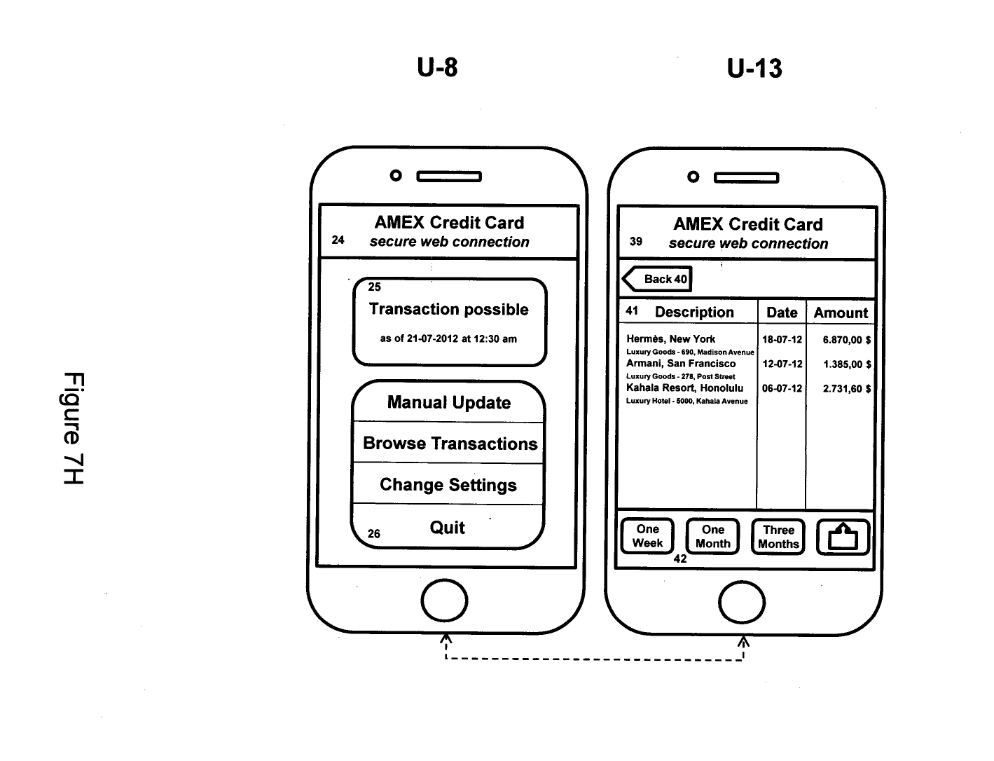

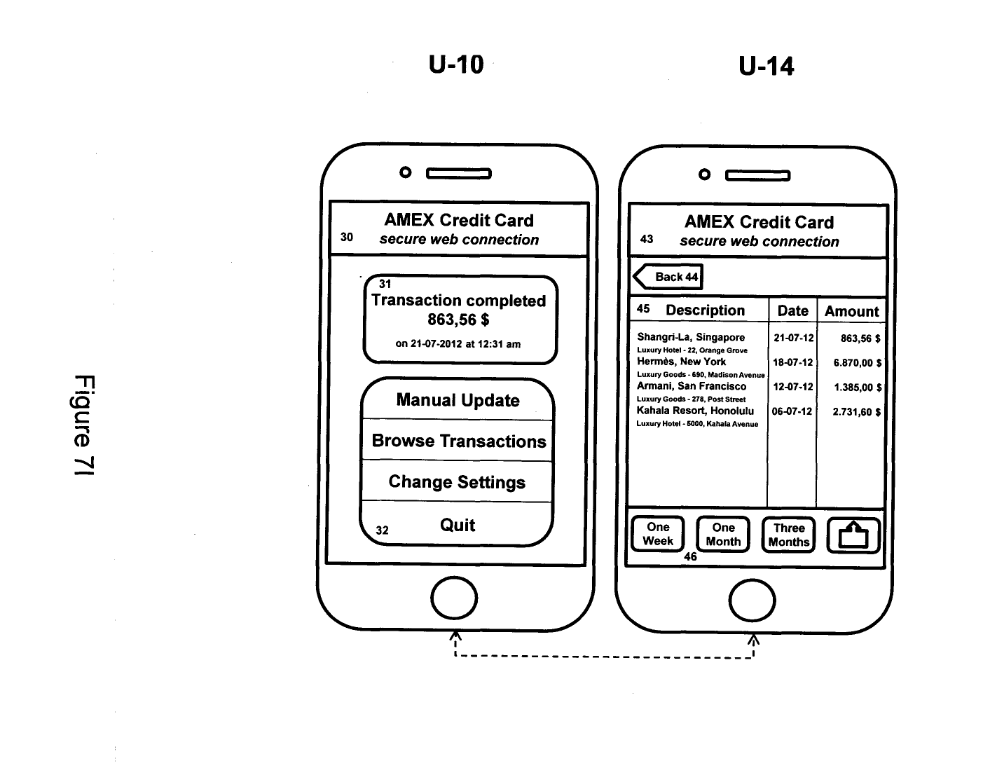

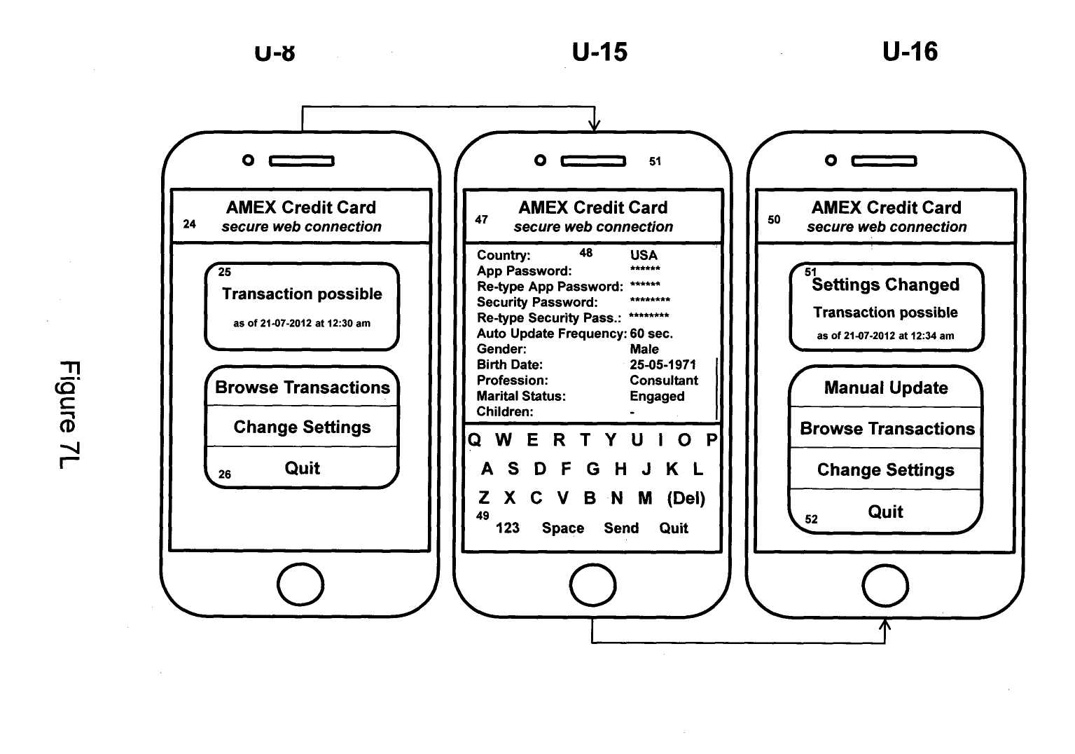

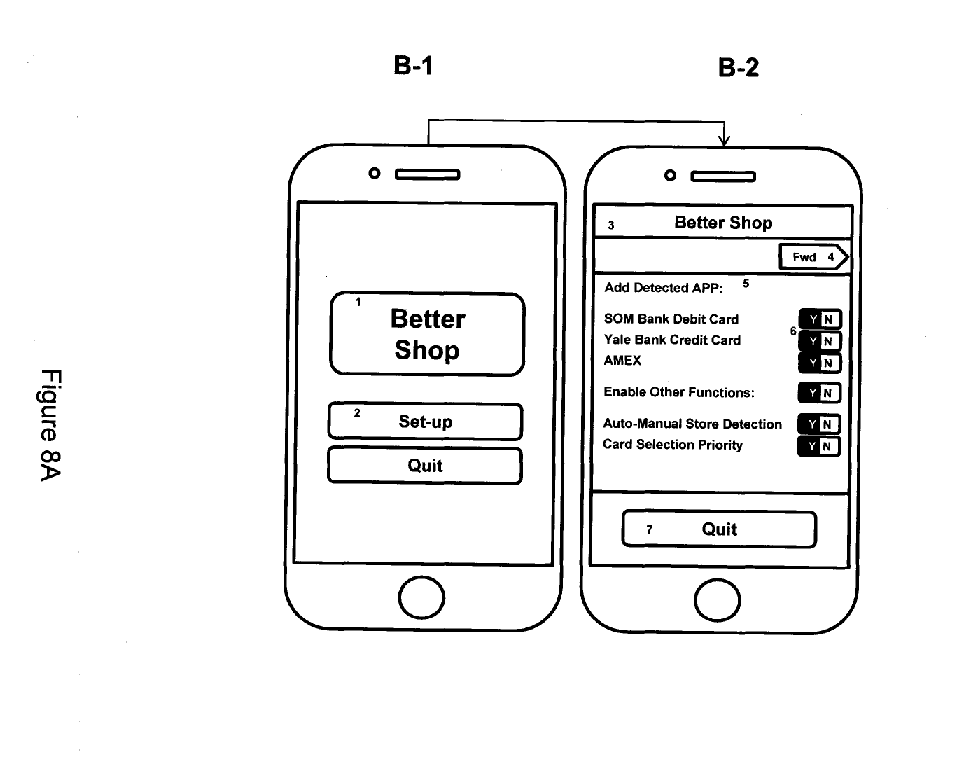

FIGS. 7A-7L show the screens generated on the display 102 of the smartphone 2 when the purchase transaction application performs the verification phase and the payment phase (according to the first embodiment) assuming, for example, that a specific credit card with an unlimited spending ceiling is used as electronic money.

The above considerations regarding the debit card as electronic money can be applied pari-passu to the credit card with an unlimited spending ceiling as electronic money by replacing FIGS. 5A-5F with FIGS. 7A-7F respectively, replacing FIGS. 5H-5L with FIGS. 7G-7I respectively and with only minor due changes, such as “AMEX Credit Card” (wherein AMEX means American Express) instead of “SOM Bank Debit Card”, credit card identification data instead of debit card identification data and “operation status” (for example, “transaction possible” or “transaction impossible”; alternatively to “transaction possible”, an high value (for example, 50.000,00 USD) or a security spending ceiling (for example, 10.000,00 USD)) instead of “amount of funds available on the debit card”.

FIGS. 9A-9E show the screens generated on the display 102 of the smartphone 2 when the purchase transaction application is executing a Flash Pay feature (assuming, for example, that a specific debit card is used as electronic money and that the set-up procedure of the purchase transaction application associated with that debit card has been successfully completed).

The Flash Pay feature of the purchase transaction application may be used by the user 10 only when the user 10 is performing a purchase transaction up to a small threshold value (for example, 30,00 USD per day/transaction, being the threshold value set, for example, on an individual basis or, preferably, according to a market practice), such as the ones the user 10 may perform, for example, at coffee shops.

As the user 10 is logging in the purchase transaction application (i.e., by typing in the correct password) in Password screen, the user 10 enables the Flash Pay feature (by correspondently selecting the icon identified by the text string “Y/N”) that makes the purchase transaction application work according to a “lighter” procedure (as compared to the “standard” one described above), that is, the purchase transaction application foregoes the verification phase with the transaction network 4 (although a “light” verification phase is performed, as described below) and is ready to perform the payment phase (FIG. 9B, FD-3).

The user 10 is then brought either to Operation screen 1 (see FIG. 9B, FD-3) or to Operation screen 2 (see FIG. 9B, FD-4), depending on the possibility or the impossibility at the current time and date to use the Flash Pay feature to (try to) perform a purchase transaction (see area 12 or 15, respectively).

In Operation screen 1 the user 10 may (try to) complete a purchase transaction at Point-of-Sale 5 using the Flash Pay feature or decide to quit the purchase transaction application by touching the icon identified by the text string “Quit” (see area 13 in FIG. 9B, DF-3).

In Operation screen 2 the user 10 may not complete a purchase transaction using the Flash pay feature (because, for example, the Flash Pay feature has already been used during the last 24 hours, or the cumulated Flash Pay expenditures over the last 24 hours have already used up the threshold amount) and the user 10 may only quit the purchase transaction application by touching the icon identified by the text string “Quit” (see area 15 in FIG. 9B, DF-4).

The user 10 elects to purchase the selected goods and reaches the Point-of-Sale 5, wherein a cashier scans the goods and a counter 7 generates the bill.

The user 10 then leans the smartphone 2—that is running the purchase transaction application (being the Flash Pay feature enabled) on Operation screen 1 (see FIG. 9C, FD-3)—on the pad of the Point-of-Sale device 6, that establishes, according to a near field communication protocol, a connection to the smartphone 2 to exchange data (assuming that the payment phase follows the procedure described above with reference to the first embodiment).

The Point-of-Sale device 6 receives from the smartphone 2 the data stored into the non-volatile memory 160 of the smartphone 2, including the debit card identification data (serial number of the debit card, expiration date, name of the issuing bank, name of the card association, security code and name and surname of the debit card owner) and the amount of funds still available for the Flash Pay feature at a specific time and date (that may differ from the current time (and date)).

The Point-of-Sale device 6 compares the amount of funds available for the Flash Pay feature (20,00 USD) with the bill amount (previously) received from the counter 7 (17,30 USD) and compares the current time and date (12:31 AM, 21 Jul. 2012) with time and date of reference for the amount of funds available for the Flash Pay feature (12:30 AM, 21 Jul. 2012).

In case the amount of funds available for the Flash Pay feature is enough to complete the purchase transaction and the current time and date does not differ from the time and date of reference for the amount of funds available for the Flash Pay feature by more than the pre-set timing, the Point-of-Sale device 6 immediately confirms the purchase transaction (for example, a “green light” displayed on the Point-of-Sale device 6) and sends to the smartphone 2 a confirmation message (along with the bill amount); the user 10 is then brought to Purchase screen 1, wherein a transaction confirmation message and an updated available funds balance is shown (see area 18 in FIG. 9C, FD-5).

In case either the amount of available funds for the Flash Pay feature is not enough to complete the purchase transaction, or the current time and date differs from the time and date of reference for the amount of funds available for the Flash Pay feature by more than the pre-set timing, the Point-of-Sale device 6 immediately denies the purchase transaction (for example, a “red light” on the Point-of-Sale device 6) and sends to the smartphone 2 a denial message; the user 10 is then brought to Purchase screen 2, wherein a transaction denial message is shown (see area 21 in FIG. 9D, FD-6).

As the user 10 is packing and/or reaching the store exit, the Point-of-Sale device 6 connects, by means of the telecommunications network 3, to the transaction network 4 to activate the settlement phase.

FIGS. 10A-10D show the screens generated on the display 102 of the smartphone 2 when the purchase transaction application is executing an Internet feature (assuming, for example, that a specific credit card with a limited spending ceiling is used as electronic money and that the set-up procedure of the purchase transaction application associated with that credit card has been successfully completed).

The Internet feature of the purchase transaction application may be used by the user 10 when the user 10 is performing a purchase transaction at a Virtual Point-of-Sale (VPOS) (i.e., virtual check-out web-page), that is, the user 10 is performing a purchase transaction from an on-line store using the smartphone 2 (or, alternatively, a tablet, a tablet PC and even a personal computer).

The user 10 is brought to Password screen (FIG. 10A, IC-1) (assuming that this feature has been enabled by the user 10) every time the user 10 runs the purchase transaction application associated with the credit card by touching the icon identified by the text string “Yale Bank Credit Card” in Home screen (FIG. 5M, H-0).

The user 10 enables the Internet feature (by correspondently selecting the icon identified by the text string “Y/N”) that allows the purchase transaction application to perform a purchase transaction with a Virtual Point-of-Sale (as described below) and, using the keyboard 4, types in the password (see area 3), that is checked with the same data stored into the non-volatile memory 160 of the smartphone 2 during the set-up procedure; an incorrect password brings the user 10 to another screen (FIG. 10A, IC-2), wherein the user 10 may decide to either re-type in the password or touch an icon identified by the text string “Quit” (area 23) to quit the purchase transaction application.

Once the user 10 has logged in (i.e., by typing in the correct password), the smartphone 2 establishes a secure web connection to (the server(s) of) the transaction network 4, that checks the credit card identification data stored into the non-volatile memory 160 of the smartphone 2 and sent to the transaction network 4 with the same data stored into the local (or remote) non-volatile memory of the transaction network 4, and checks for, in addition to the authorization to use the debit card, the amount of funds available at the current time and date based on all data stored into the local (or remote) non-volatile memory of the transaction network 4.

The user 10 is then brought either to Operation screen 1 (see FIG. 10B, IC-3) or to Operation screen 2 (see FIG. 10C, IC-6), depending on both the authorization to use the debit card (assumed to be positive) and the amount of funds available at the current time and date, that the transaction network 4 has communicated to the smartphone 2 (see area 12 or 21, respectively).

In Operation screen 1 the user 10 may (try to) complete a purchase transaction at the Virtual Point-of-Sale or decide to make other actions by touching the corresponding icons identified by text strings (see area 13 in FIG. 10B, IC-3).

In Operation screen 2 the user 10 may not complete a purchase transaction because the amount of available funds is below the balance threshold set by the user 10 (assuming that this feature has been enabled by the user 10), but the user 10 may decide to make other actions by touching the corresponding icons identified by text strings (see area 22 in FIG. 10C, IC-6).

In Operation screen 1 the purchase transaction application (assuming that this feature has been enabled by the user 10) automatically updates (i.e., refreshes) the amount of available funds and the corresponding time and date of reference every set amount of time (according to the frequency set by the user 10, that may be based on his preferences or, more likely, on a market practice) to make sure, for security purposes, that the amount of available funds is updated to a recent time (and date) preceding the purchase transaction; as an alternative, and/or in combination to the automatic update frequency, the user 10 may at any time manually update the amount of available funds and the corresponding time and date of reference by touching the icon identified by the text string “Manual Update” (see area 13 in FIG. 10B, IC-3).

The user 10 then switches to a web-browser application running on the smartphone 2 and opens an on-line store web-page(s) to shop for products and puts the chosen goods in a virtual basket.

The user 10 elects to purchase the selected goods, touches the icon identified by the text string “Check-out” on the display 102 of the smartphone 2 (running the web-browser computer program on the on-line store web-page(s)) and is brought to a virtual check-out web-page (i.e., a Virtual Point-of-Sale), wherein an automated counter generates the bill.

The Virtual Point-of-Sale establishes a connection to the purchase transaction application (that is also currently running on the smartphone 2) to exchange data; in particular, the smartphone 2—by means of a database located in the smartphone 2 storing data in/retrieving data from the non-volatile memory 160 of the smartphone 2—may make the data—including the credit card identification data (serial number of the debit card, expiration date, name of the issuing bank, name of the card association, security code and name and surname of the credit card owner), and among the others (for example, the authorization to use the credit card, the customer identification data (i.e., name and surname, permanent and shipping address, telephone and e-mail), and, if applicable, the random generated number/alphanumeric code), the amount of the funds available on that credit card at a specific time and date—temporarily available to the Virtual Point-of-Sale (for example, the Virtual Point-of-Sale may query the database to read shared data; and the process of data exchange by means of the database may work both ways, for example, in case the Virtual Point-of-Sale sends data to the purchase transaction application).

The Virtual Point-of-Sale—provided that the user 10 enables an option in the check-out web-page—may be allowed to store (in a virtual registration form) some data, such as, for example, the card identification data and the customer identification data to be used for subsequent purchases.

The Virtual Point-of-Sale (assuming that the payment phase follows the procedure described above with reference to the first embodiment) compares the amount of available funds (1.945,31 USD) with the bill amount generated by the automated counter (1.500 USD) and compares the current time and date (12:31 AM, 21 Jul. 2012) with the time and date of reference for the amount of available funds (12:30 AM, 21 Jul. 2012).

In case the amount of available funds is enough to complete the purchase transaction and the current time and date does not differ from the time and date of reference for the amount of available funds by more than a pre-set timing (for example, 2 minutes), the Virtual Point-of-Sale immediately confirms the purchase transaction (as shown on the virtual check-out web-page) and sends a confirmation message (along with the bill amount) to the database located in the smartphone 2; the user 10 may switch to the running purchase transaction application and is then brought to Purchase screen 1, wherein a transaction confirmation message and an estimated and (temporarily) updated available funds balance are shown (see area 18 in FIG. 10B, IC-5).

In case either the amount of available funds is not enough to complete the purchase transaction or the current time and date differs from the time and date of reference for the amount of available funds by more than the pre-set timing, the Virtual Point-of-Sale immediately denies the purchase transaction and sends a denial message (along with the bill amount) to the database located in the smartphone 2; the user 10 may switch to the running purchase transaction application and is then brought to Purchase screen 2, wherein a transaction denial message (and additional info) is shown (see area 24 in FIG. 10C, IC-7).

FIGS. 8A-8L show the screens generated on the display 102 of the smartphone 2 when it runs a Better Shop application.

Better Shop—being associated with one or more purchase transaction applications, that are, in turn, each associated with a specific debit/credit card (i.e., payment mode)—is an application that provides the user 10 with a comprehensive and instant view on each associated card and that fully and/or partially automatically selects and/or prioritizes the most adequate associated debit/credit card for a specific purchase transaction.

The user 10 is brought to Set-up screen the first time the user 10 runs Better Shop by touching the icon identified by the text string “Better Shop” in Home screen (FIG. 5M, H-0).

The set-up procedure has to be performed the first time the user 10 runs Better Shop, or in case (according to the text string “Change Settings”) a change of one or more associated debit/credit cards and/or of one or more optional features is subsequently necessary and/or requested by the user 10.

The user 10 may decide to either continue with the set-up procedure by touching the icon identified by the text string “Set-up” or quit the set-up procedure and resume it later on, by touching the icon identified by the text string “Quit”.

The user 10 that has touched the icon identified by the text string “Set-up” (see area 2 in FIG. 8A, B-1) is brought to a number of subsequent screens (see FIGS. 8A, B-2, 8B, B-3 and B-4, 8C, B-5), wherein the user 10—by touching the icons in areas 6-11-16 and/or using the keyboards 17-21—has to fill in all the required fields (see areas 5-10-15-20) with data regarding, for example, the purchase transaction applications to be associated with Better Shop, the passwords (if applicable) of each associated purchase transaction application and the selection and prioritization of the available debit/credit cards (each associated with a purchase transaction) according to the parameters (for example, type of purchased goods, bill amount, etc.) previously selected by the user 10 and, preferably, also some additional fields with data regarding, for example, the master password for Better Shop, the automatic update frequency and the automatic/manual store detection.

As soon as all the required fields (see areas 5-10-15-20) have been duly filled in, the user 10 touches “Save” on the keyboard 21 and the data are stored into the non-volatile memory 160 of the smartphone 2; the completion of the set-up procedure is confirmed in a subsequent screen (FIG. 8C, B-6), wherein a confirmation message 23 is shown in addition to another area (see area 24), wherein the user 10 may decide to make other actions by touching the corresponding icons identified by text strings, such as “Shop, “Change Settings” and “Quit”.

The user 10 is brought to Password screen (FIG. 8D, B-7) (provided that the set-up procedure has been successfully completed) every time the user 10 runs Better Shop by touching the icon identified by the text string “Better Shop” in Home screen (see area 5 in FIG. 5M, H-0).

The user 10, using the keyboard 26, types in the master password of Better Shop in an area (see area 26), that is checked with the same data stored into the non-volatile memory 160 of the smartphone 2 during the set-up procedure; an incorrect Better Shop master password brings the user 10 to another screen (FIG. 8D, B-8) wherein the user 10, using the keyboard 30, may decide to re-type in again the master password of Better Shop in an area (see area 29) or quit Better Shop by touching the icon identified by the text string “Quit” (see area 32).

Once the user 10 has logged in (i.e., by typing in the correct password), Better Shop simultaneously runs all the associated purchase transaction applications that, in turn, establish secure web connection(s) (by means of the telecommunications network 3) to (the server(s) of) the transaction network 4, that checks the debit/credit cards identification data stored into the non-volatile memory 160 of the smartphone 2 and sent to the transaction network 4 with the same data stored in the local (or remote) non-volatile memory of the transaction network 4, and checks for, in addition to the authorization to use each debit/credit card, the amount of funds available at the current time and date on each debit/credit card—and/or the operation status at the current time and date on each credit card with an unlimited spending ceiling—based on all relevant data stored in the transaction network 4.

The user 10 is then brought either to Operation screen 1 (see FIG. 8E, B-9) or to Operation screen 2 (see FIG. 8E, B-10), depending on both the authorization to use each debit/credit card (assumed to be positive) and the amount of funds available at the current time and date on each debit/credit card and/or on the operation status at the current time and date on each credit card with an unlimited spending ceiling, that the transaction network 4 has communicated to the smartphone 2 (i.e., to the corresponding purchase transaction applications and thus to Better Shop) (see areas 33 or 36, respectively).

In Operation screen 1 the user 10 may (try to) complete a purchase transaction at Point-of-Sale 5 or decide to make other actions by touching the corresponding icons identified by text strings (see area 34 in FIG. 8E, B-9).

In Operation screen 2—in case no card is available (for example, there is no funds availability and/or funds availability is below the balance threshold and/or operation status does not allow to perform a purchase transaction)—the user 10 may not try to complete a purchase transaction at Point-of-Sale 5, but the user 10 may make other actions by touching the corresponding icons identified by text strings (see area 37 in FIG. 8E, B-10).

In Operation screen 2—in case at least one card is available—the user 10 may (try to) complete a purchase transaction at Point-of-Sale 5 or decide to make other actions by touching the corresponding icons identified by text strings (see area 37 in FIG. 8E, B-10).

The user 10 elects to purchase the selected goods and reaches the Point-of-Sale 5, wherein a cashier scans the goods and a counter 7 generates the bill.

The user 10 leans the smartphone 2—that is running Better Shop in Operation screen 1 (FIG. 8F, B-9) or in Operation screen 2 (FIG. 8G, B-10) assuming that at least one debit/credit card (i.e., payment mode) is available—on the Point-of-Sale device 6, that establishes, according to a near field communication protocol, a connection to the smartphone 2 to exchange data (assuming that the payment phase follows the procedure described above with reference to the first embodiment, with a variant related to the communication of the store category to the smartphone 2, as described below).

The Point-of-Sale device 6 communicates (provided that it has been properly set-up) the store category (e.g., grocery, electronics, pharmacy, etc.) to the smartphone 2 and receives from the smartphone 2, according to the selection and priority indicated by Better Shop, the data stored into the non-volatile memory 160 of the smartphone 2, including the identification data of the associated debit/credit cards stored (serial number of the card(s), expiration date(s), name of the issuing bank(s), name of the card association(s), security code(s) and name and surname of the cards' owner) and, among the others (for example, the authorization to use each debit/credit card and, if applicable, the random generated number(s)/alphanumeric code(s)), the amount of funds available on each debit/credit card and/or the operation status of each credit card with an unlimited spending ceiling at a specific time and date.

The Point-of-Sale device 6 compares, according to the priority indicated by Better Shop, the amount(s) of available funds (837,63 USD, 1.945,31 USD,“possible”) with the bill amount (previously) received from the counter 7 (1.500 USD) and compares the current time and date (12:31 AM, 21 Jul. 2012) with the time(s) and date(s) of reference for the amount(s) of available funds (or the operation status) on each debit/credit card (12:30 AM, 21 Jul. 2012).

In case at least one card is available, the amount of funds available on that card is enough to complete the purchase transaction (or the operation status, in case of a credit card with an unlimited spending ceiling, allows to perform the purchase transaction) and the current time and date does not differ from the time and date of reference for the amount of available funds (or the operation status) by more than a pre-set timing (for example, 2 minutes), the Point-of-Sale device 6 immediately confirms the purchase transaction (e.g., a “green light” on the Point-of-Sale device 6) and sends to the smartphone 2 a confirmation message (along with the bill amount), providing also evidence of the debit/credit card actually used to complete the purchase transaction (according to the cards availability, the amount of funds available on each debit/credit card and/or the operation status of each credit card with an unlimited spending ceiling and the selection and priority indicated by Better Shop); the user 10 is then brought to Purchase screen 1, wherein a transaction confirmation message is shown (see area 39 in FIG. 8F, B-11).

In case no payment method is available and/or the amount of available funds is lower than the bill amount and/or the operation status, in case of a credit card with an unlimited spending ceiling does not allow to perform a purchase transaction and/or the current time and date differs from the time and date of reference for the amount of available funds (or the operation status) by more than the pre-set timing, the Point-of-Sale device 6 immediately denies the purchase transaction (e.g., a “red light” on the Point-of-Sale device 6) and sends to the smartphone 2 a denial message; the user 10 is then brought to Purchase screen 2, wherein a transaction denial message is shown (see area 42 in FIG. 8G, B-12).

As the user 10 is packing and/or reaching the store exit, the Point-of-Sale device 6 connects, by means of the telecommunications network 3, to the transaction network 4 to activate the settlement phase.

FIGS. 8H-8L show the screens generated by some, among the many, additional and useful utility features of Better Shop running, along with all the associated purchase transaction applications, (on the processor 163 of) the smartphone 2.

A first useful feature is the possibility for the user 10 to change one or more customizable settings/features such as, for example, the master password, the automatic/manual store category detection and the selection and prioritization of available payments methods (as it is shown in Operation screen 1 and 2 and on Purchase screen 1 and 2).

The user 10, for example, touches an icon identified by the text string “Change Settings” in Operation screen 1 (see area 34 in FIG. 8H, B-9) and is brought to Set-up screen (see FIG. 8H, B-13).

In Set-up screen the user 10 may change one or more customizable settings/features, that are stored into the non-volatile memory 160 of the smartphone 2; once the new settings/features have been set-up and stored, the user 10 is brought to another screen, wherein a confirmation message is shown (see 54 in FIG. 8I, B-15).

A second useful feature is the possibility to automatically detect the store category, for example, as described above, through the data exchanged with the Point-of-Sale device 6.

Even though the store category may be automatically detected according to alternative means such as, for example, a GPS positioning computer program and a RFID tag reader, Better Shop has a manual store category selection option that may enabled/disable by the user 10.

In case the user 10 elects to use the manual store detection option, the Operation screen 1 (FIG. 8L, B-16) may display a scrolling menu area (see area 58) that the user 10 may touch to select the store category it is currently shopping, so that Better Shop may select and prioritize the payment methods accordingly.

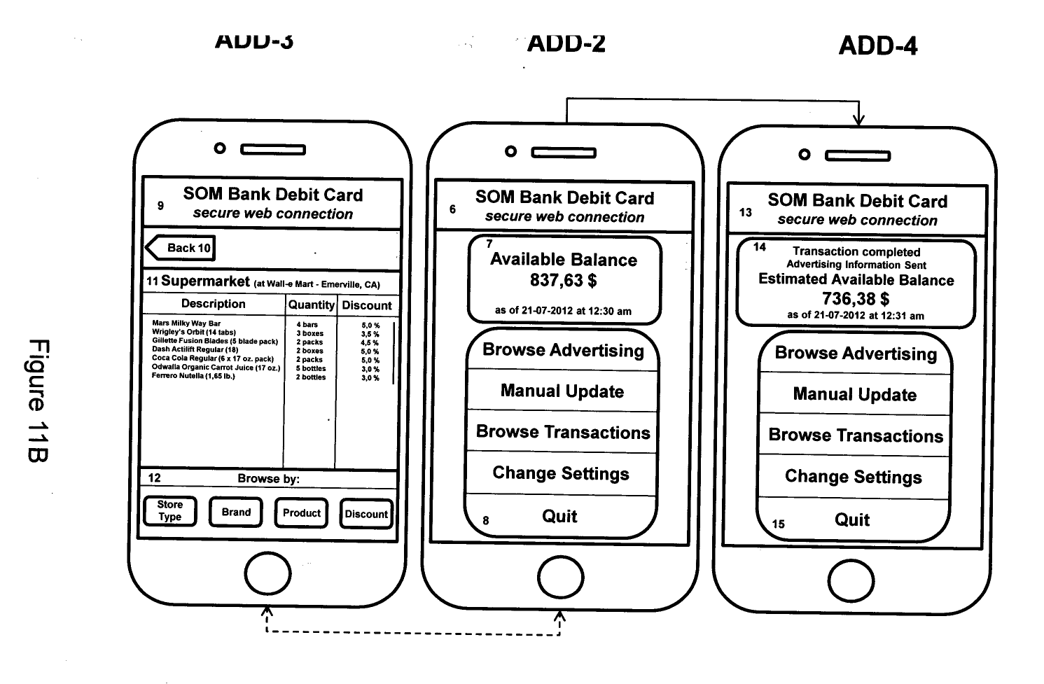

FIGS. 11A-11B show the screens generated on the display 102 of the smartphone 2 when the purchase transaction application performs the verification phase and the payment phase (according to the first embodiment) assuming, for example, that a specific debit card with a limited spending ceiling is used as electronic money and assuming also that the purchase transaction application is such to provide the user 10 with other value added services, for example, direct advertising/marketing information.

The above considerations regarding the debit card as electronic money can be applied pari-passu (with only some minor due changes) by replacing, for example, FIGS. 5C-D6, 5D-D8, 5E-D10 with FIGS. 11A-ADD1, 11A-ADD2, 11A-ADD4 respectively and by adding FIG. 11A-ADD3.

1. Electronic system (1) to perform a purchase transaction of goods or services, the system including:
a mobile electronic device (2) configured to:
receive (t₃) a second message (MSG2) carrying an authorization data field (AUT_D; AUT_D′) indicating a valid or invalid authorization to use an electronic money for performing the purchase transaction;
store the content of the authorization data field (AUT_D; AUT_D′) into a non-volatile memory (160) inside the mobile electronic device (2);
transmit (t₅; t₇′) a third message (MSG3; MSG4′) carrying an electronic money identification data field (EM_ID) for indicating data identifying the electronic money used for performing the purchase transaction and carrying the authorization data field (AUT_D; AUT_D′);
a transaction server (4) configured to:
transmit (t₂) the second message (MSG2) carrying the authorization data field (AUT_D; AUT_D′);
receive (t₁₀) a fifth message (MSG5) carrying the electronic money identification data field (EM_ID) and carrying a bill amount field (BL_AM) indicating a bill amount to be paid for the selected goods or services and transmit (t₁₁) therefrom a sixth message (MSG6) carrying a settlement result field (RES_STL) for indicating if the value of the bill amount has been debited on the electronic money;
a Point-of-Sale device (6) configured to:
receive (t₆; t₈′) from the mobile electronic device (2) the third message (MSG3; MSG4′) carrying the electronic money identification data field (EM_ID) and the authorization data field (AUT_D; AUT_D′); and
transmit (t₇) to the mobile electronic device (2) a fourth message (MSG4) carrying a payment result field (RES_PM) that indicates a successful payment in case of a positive value of the authorization data field (AUT_D; AUT_D′),
and the Point-of-Sale device (6), subsequently to transmitting the fourth message (MSG4), further configured to:
transmit (t₉) therefrom the fifth message (MSG5) carrying the electronic money identification data field (EM_ID) and the bill amount field (BL_AM), in case of a valid value of the content of the authorization data field (AUT_D; AUT_D′) and receive (t₁₂) the sixth message (MSG6).

2. Electronic system (1) according to claim 1, wherein the mobile electronic device (2) is further configured to transmit (t₀) towards the transaction server (4) a first message (MSG1) carrying the electronic money identification data field (EM_ID),
and wherein the transaction server (4) is further configured to receive (t₁) the first message (MSG1) carrying the electronic money identification data field (EM_ID) and to transmit (t₂) therefrom the second message (MSG2) carrying the authorization data field (AUT_D; AUT_D′).

3. Electronic system (1) according to claim 1, wherein the transaction server (4) is further configured to automatically transmit towards the mobile electronic device (2) the second message (MSG2) carrying an updated value of the authorization data field (AUT_D; AUT_D′),
and wherein the mobile electronic device (2) is further configured to automatically receive the second message (MSG2) carrying the updated value of the authorization data field (AUT_D; AUT_D′).

4. Electronic system (1) according to claim 1, wherein
the electronic money has a limited spending ceiling,
wherein the transaction server (4) is configured to transmit the second message (MSG2) further carrying an available balance field (AV_BL) for indicating an amount of funds available on the electronic money,
and wherein the mobile electronic device (2) is configured to:
receive the second message (MSG2) further carrying the available balance field (AV_BL);
store the content of the available balance field (AV_BL) into the non-volatile memory (160).

5. Electronic system (1) according to claim 4, wherein the mobile electronic device (2) is further configured to:
transmit (t₅) to the Point-of-Sale device (6) the third message (MSG3) further carrying the available balance field (AV_BL);
receive (t₈) the fourth message (MSG4) carrying the payment result field (RES_PM) for indicating if the value of the bill amount will be debited on the electronic money;
wherein the Point-of-Sale device (6) is further configured to:
receive (t₆) the third message (MSG3) further carrying the electronic money identification data field, the authorization data field and the available balance field (AV_BL);
store the content of the electronic money identification data field (EM_ID) into a non-volatile memory (60) inside the Point-of-Sale device (6);
compare the value of the available balance field (AV_BL) with respect to the value of the bill amount;
transmit (t₇) to the mobile electronic device (2) the fourth message (MSG4) carrying the payment result field (RES_PM) that indicates a successful payment in case of a positive comparison of the value of the available balance field (AV_BL) with respect to value of the bill amount.

6. Electronic system (1) according to claim 4, wherein the Point-of-Sale device (6) is configured to transmit (t₅′) to the mobile electronic device (2) a message (MSG3′) carrying a bill amount field (BL_AM) indicating the bill amount to be paid for the selected goods or services,
and wherein the mobile electronic device (2) is further configured to:
receive (t₆′) said message (MSG3′) carrying the bill amount field (BL_AM);
compare the value of the content of the available balance field (AV_BL) with respect to the value of the content of the bill amount field (BL_AM);
transmit (t₇′) to the Point-of-Sale device (6) a further fourth message (MSG4′) carrying the electronic money identification data field (EM_ID) and the authorization data field (AUT_D′);
and wherein the Point-of-Sale device (6) is further configured to:
receive (t₈′) the fourth message (MSG4′) carrying the electronic money identification data field (EM_ID) and the authorization data field (AUT_D′);
store the content of the electronic money identification data field (EM_ID) into the non-volatile memory (60) inside the Point-of-Sale device (6);
transmit (t₈″) to the mobile electronic device (2) a message (M5G4″) carrying a payment result field (RES_PM) for indicating if the value of the bill amount will be debited on the electronic money.

7. Electronic system (1) according to claim 5, wherein the Point-of-Sale device (6) is further configured to transmit to the mobile electronic device (2) the fourth message (MSG4) further carrying the bill amount field (BL_AM), and wherein the mobile electronic device (2) is further configured to:
receive (t₈) the fourth message (MSG4) carrying the bill amount field (BL_AM);
calculate an estimation of the available balance value by subtracting the value of the content of the bill amount field from the value of the available balance field;
store the value of the estimated available balance into the non-volatile memory (160) inside the mobile electronic device.

8. Electronic system (1) according to claim 1, wherein the Point-of-Sale device is configured to transmit the fifth message further carrying a merchant identification data field (ME_ID) for identifying the bank account of the merchant of the store of the purchase transaction,
wherein the transaction server is configured to:
receive the fifth message;
process the content of the merchant identification data field and the content of the bill amount field; and
perform the credit of the value of the content of the bill amount field on the bank account identified by the merchant identification data field.

9. Electronic system (1) according to claim 1, wherein the transaction server is further configured to:
generate a random number;
store the generated random number into a non-volatile memory of the transaction server;
transmit the second message further carrying a random number field equal to the generated random number;
and wherein the mobile electronic device is further configured to:
receive the second message further carrying the random number field and store the content of the received random number field into the non-volatile memory;
read the stored random number value from the non-volatile memory;
transmit to the Point-of-Sale device the third message further carrying a random number field equal to the stored random number;
and wherein the Point-of-Sale device is further configured to:
receive the third message carrying the random number field and store the content of the random number field into the non-volatile memory;
read the stored random number value from the non-volatile memory;
transmit the fifth message further carrying a random number field equal to the stored random number value;
wherein the transaction server is further configured to:
receive the fifth message carrying the random number field;
compare the value of the received random number field with the value of the random number stored into the non-volatile memory of the transaction server;
in case the value of the received random number field is different from the value of the stored random number, transmit the sixth message carrying the settlement result field (RES_STL) having a value indicating that the value of the bill amount has not been debited on the electronic money.

10. Electronic system (1) according to claim 4, wherein the Point-of-Sale device is further configured to:
transmit (t₉″, t₉″) towards the transaction server a first plurality of messages (MSG5′-a, MSG5′-b) carrying a corresponding plurality of electronic money identification data fields (EM_ID-a, EM_ID-b) and a corresponding plurality of reservation amount fields (RES_BL_AM-a, RES_BL_AM-b) indicating a request to reserve on a plurality of electronic money a corresponding plurality of amount of funds equal to a plurality of bill amounts to be paid;
transmit (t₉′″) towards the transaction server a message (MSG5″) carrying a plurality of electronic money identification data fields and a respective plurality of bill amounts fields;
and wherein the transaction server is further configured to:
receive (t_{ic})) the plurality of electronic money identification data fields and the plurality of reservation amount fields and transmit therefrom a second plurality of messages (MSG6′-a, MSG6′-b) carrying a plurality of reservation result fields (RES_RE) for indicating a successful or unsuccessful reservation on the plurality of electronic money;
transmit (t₁₁′) a message (MSG6″) carrying a batch settlement result field for indicating a successful or unsuccessful settlement of the purchase transaction.

11. Electronic system (1) according to claim 1, wherein the electronic mobile device is further configured to automatically select the electronic money among a plurality of possible electronic money, according to user defined parameters, in particular according to the greatest amount funds availability on the possible electronic money or the type of purchased goods or services.

12. Electronic system (1) according to claim 1, wherein the Point-of-Sale device (6) is a virtual Point-of-Sale terminal of an on-line store.

13. Method for performing a purchase transaction of goods or services using a mobile electronic device (2), including:
a verification phase that comprises the step of:
a) receiving (t₃) at the mobile electronic device (2) a second message (MSG2) carrying an authorization data field (AUT_D; AUT_D′) indicating a valid or invalid authorization to use an electronic money for performing the purchase transaction and storing the content of the authorization data field (AUT_D; AUT_D′) into a non-volatile memory (160) inside the mobile electronic device (2);
a shopping phase that comprises the step of:
b) performing the selection of the goods or services and generating a value of a bill amount (BL_AM) to be paid for the selected goods or services;
a payment phase that comprises the steps of:
c) transmitting (t₅; t₇′) from the mobile electronic device (2) to a Point-of-Sale device (6) a third message (MSG3; MSG4′) carrying an electronic money identification data field (EM_ID) for indicating data identifying the electronic money used for performing the purchase transaction and carrying the authorization data field (AUT_D; AUT_D′);
receiving (t₆; t₈′) at the Point-of-Sale device (6) the third message (MSG3; MSG4′) carrying the electronic money identification data field (EM_ID) and the authorization data field (AUT_D, AUT_D′) and, in case of a valid value of the content of the authorization data field (AUT_D, AUT_D′)
transmitting (t₇) from the Point-of-Sale device (6) to the mobile electronic device (2) a fourth message (MSG4) carrying a payment result field (RES_PM) for indicating a successful payment in case of a positive value of the authorization data field (AUT_D;AUT_D′),
a settlement phase that is performed subsequently the transmitting step (t₇) of the payment phase, the settlement phase comprising the steps of:
d) transmitting (t₉) from the Point-of-Sale device (6) towards a transaction server (4) a fifth message (MSG5) carrying the electronic money identification data field (EM_ID) and a bill amount field (BL_AM) equal to the value of the bill amount;
e) receiving (t₁₀) at the transaction server (4) the electronic money identification data field (EM_ID) and the bill amount field (BL_AM) and transmitting (t₁₁) towards the Point-of-Sale device (6) a sixth message (MSG6) carrying a settlement result field (RES_STL) for indicating if the value of the bill amount has been debited on the electronic money.

14. Method according to claim 13, wherein the verification phase further including, before the step a), the steps of:
a1) transmitting (t₀) from the mobile electronic device (2) towards transaction server (4) a first message (MSG1) carrying the electronic money identification data field (EM_ID);
a2) receiving (t₁) at the transaction server (4) the first message (MSG1) carrying the electronic money identification data field and transmitting (t₂) therefrom towards the mobile electronic device (2) the second message (MSG2) carrying the authorization data field (AUT_D; AUT_D′).

15. Method according to claim 13, wherein the verification phase further includes, before the step a), the steps of:
a1) automatically transmitting (t₂) from the transaction server (4) towards the mobile electronic device (2) the second message (MSG2) carrying an updated value of the authorization data field (AUT_D; AUT_D′);
a2) automatically receiving (t₃) at the mobile electronic device (2) the second message (MSG2) carrying the updated value of the authorization data field (AUT_D; AUT_D′).

16. Method according to claim 13, wherein the electronic money has a limited spending ceiling,
wherein step a) of the verification phase includes the reception of the second message (MSG2) further carrying an available balance field (AV_BL) indicating an amount of funds available on the electronic money and includes storing the content of the available balance field (AV_BL) into the non-volatile memory (160).

17. Method according to claim 16, wherein step c) of the payment phase further includes the steps of:
c1) transmitting (t₅) from the mobile electronic device (2) to the Point-of-Sale device (6) the third message (MSG3) further carrying the available balance field (AV_BL);
c2) receiving (t₆) at the Point-of-Sale device (6) the third message (MSG3) carrying the electronic money identification data field (EM_ID), the authorization data field (AUT_D; AUT_D′) and the available balance field (AV_BL) and storing the content of the electronic money identification data field (EM_ID) into a non-volatile memory (60) inside the Point-of-Sale device (6);
c3) comparing the value of the available balance field (AV_BL) with respect to the value of the bill amount;
c4) transmitting (t₇) from the Point-of-Sale device (6) to the mobile electronic device (2) the fourth message (MSG4) carrying a payment result field (RES_PM) for indicating if the value of the bill amount will be debited on the electronic money;
c5) receiving (t₈) at the mobile electronic device (2) the fourth message (MSG4) carrying the payment result field (RES_PM).

18. Method according to claim 16, wherein the step c) of the payment phase further includes the steps of:
c1′) transmitting (t₅′) from the Point-of-Sale device (6) to the mobile electronic device (2) a message (MSG3′) carrying a bill amount field (BL_AM) indicating the bill amount to be paid for the selected goods or services;
c2′) receiving (t₆′) at the mobile electronic device (2) the bill amount field, comparing the value of the content of the available balance field (AV_BL) with respect to the value of the content of the bill amount field and transmitting (t₇′) to the Point-of-Sale device (6) a message (MSG4′) carrying the electronic money identification data field (EM_ID) and the authorization data field (AUT_D′);
c3′) receiving (t₈′) at the Point-of-Sale device (6) said message (MSG4′) carrying the electronic money identification data field (EM_ID) and the authorization data field (AUT_{—} D′), storing the content of the electronic money identification data field into the non-volatile memory (60) inside the Point-of-Sale device (6) and transmitting (t₈″) to the mobile electronic device (2) a fourth message (M5G4″) carrying a payment result field (RES_PM) for indicating if the value of the bill amount will be debited on the electronic money.

19. Method according to claim 17, wherein steps c4) and c3′) include the transmission to the mobile electronic device (2) of the fourth message further carrying the bill amount field,
and wherein step c5) further includes receiving the fourth message carrying the bill amount field and calculating an estimation of the available balance value by subtracting the value of the content of the bill amount field from the value of the available balance field,
and wherein step d5) further includes storing the value of the estimated available balance into the non-volatile memory inside the mobile electronic device (2).

20. Mobile electronic device (2) to perform a purchase transaction of goods or services configured to co-operate with a Point-of-Sale device (6) according to claim 26 and with a Transaction network (4) according to claim 27, the mobile electronic device including:
a non-volatile memory (160) configured to store data identifying an electronic money used for performing the purchase transaction and configured to store data indicating a valid or invalid authorization to use the electronic money for performing the purchase transaction;
a transmitting/receiving network interface (162) configured to:
receive (t₃) a second message (MSG2) carrying an authorization data field (AUT_D; AUT_D′) for indicating the valid or invalid authorization to use the electronic money;
a transmitting/receiving near field communication interface (164) configured to:
transmit (t₅; t₇′) a third message (MSG3, MSG4′) carrying an electronic money identification data field (EM_ID) for indicating data identifying the electronic money used for performing the purchase transaction and carrying the authorization data field (AUT_D; AUT_D′);
receive (t₈; t₇″) a fourth message (MSG4; MSG4″) carrying a payment result field (RES_PM) for indicating if the value of a bill amount to be paid for the selected goods or services will be debited on the electronic money.

21. Mobile electronic device according to claim 20, wherein the transmitting/receiving network interface (162) is further configured to transmit (t₀) a first message (MSG1) carrying the electronic money identification data field (EM_ID) for indicating the data identifying the electronic money used for performing the purchase transaction.

22. Mobile electronic device according to claim 20, wherein the transmitting/receiving network interface (162) is further configured to automatically receive the second message carrying an updated value of the authorization data field.

23. Mobile electronic device according to claim 20, wherein the transmitting/receiving network interface (162) is configured to receive the second message further carrying an available balance field for indicating an amount of funds available on the electronic money,
wherein the non-volatile memory (160) is configured to further store the content of the available balance field,
and wherein the transmitting/receiving near field communication interface (164) is configured to transmit the third message (MSG3, MSG4′) further carrying the available balance field.

24. Mobile electronic device according to claim 23, wherein the transmitting/receiving near field communication interface (164) is configured to transmit the third message (MSG3) further carrying the available balance field (AV_BL).

25. Mobile electronic device according to claim 23, wherein the transmitting/receiving near field communication interface (164) is configured to further receive (t₆′) a bill amount field equal to the value of the bill amount,
wherein the mobile electronic device further includes a processor configured to compare the value of the content of the available balance field with respect to the value of the content of the bill amount field,
and wherein the transmitting/receiving near field communication interface (164) is configured to further transmit (t₇′) a fourth message (MSG4′) carrying the electronic money identification data field and the authorization data field and to further receive a payment result field (RES_PM) for indicating if the value of the bill amount will be debited on the electronic money.

26. Point-of-Sale device (6) to perform a purchase transaction of goods or services, the Point-of-Sale device including:
a non-volatile memory (60) configured to store data identifying an electronic money used for performing the purchase transaction and configured to store the value of a bill amount to be paid for the selected goods or services;
a transmitting/receiving near field communication interface (64) configured to receive (t₆; t₈′) a message (MSG3; MSG4′) carrying an electronic money identification data field (EM_ID) for indicating the data identifying the electronic money used for performing the purchase transaction and carrying an authorization data field (AUT_D, AUT_D′) indicating a valid or invalid authorization to use the electronic money for performing the purchase transaction, the transmitting/receiving near field communication interface (64) further configured to transmit (t₇) to the mobile electronic device (2) a fourth message (MSG4) carrying a payment result field (RES_PM) for indicating a successful payment;
a transmitting/receiving network interface (62) configured to:
transmit (t₉) a fifth message (MSG5) carrying the electronic money identification data field and a bill amount field (BL_AM) equal to the value of the bill amount, in case of a valid value of the authorization data field;
receive a sixth message (MSG6) carrying a settlement result field (RES_STL) for indicating if the value of the bill amount has been debited on the electronic money.

27. Transaction network (4) to perform a purchase transaction of goods or services, the transaction network including a transmitting/receiving network interface configured to:
transmit (t₂) a second message (MSG2) carrying an authorization data field (AUT_D) indicating a valid or invalid authorization to use the electronic money for performing the purchase transaction;
receive (t₁₀) a fifth message (MSG5) carrying an electronic money identification data field for indicating data identifying the electronic money used for performing the purchase transaction and carrying a bill amount field (BL_AM) indicating a bill amount to be paid for the selected goods or services and transmit (t₁₁) therefrom a sixth message (MSG6) carrying a settlement result field (RES_STL) for indicating if the value of the bill amount has been debited on the electronic money.

28. Transaction network (4) according to claim 27, wherein the transmitting/receiving network interface is further configured to receive (t₁) a first message (MSG1) carrying the electronic money identification data field.

29. Transaction network (4) according to claim 27, wherein the transmitting/receiving network interface is configured to transmit the second message (MSG2) further carrying an available balance field (AV_BL) for indicating an amount of funds available on the electronic money.

30. Computer program comprising computer program code means adapted to perform the steps a) and c) of the method according to claim 13, when said program is run on a computer.

31. Computer program comprising computer program code means adapted to perform the step d) of the method according to claim 13, when said program is run on a computer.

32. Computer program comprising computer program code means adapted to perform the step e) of the method according to claim 13, when said program is run on a computer.
